(19) United States
(12) Patent Application Publication
(10) Pub. No.: US 2012/0079075 A1
(43) Pub. Date: Mar. 29, 2012

(54) Data Processing Device

(76) Inventor: Rolus Borgward Glenn, München (DE)

(21) Appl. No.: 09/979,355

(22) PCT Filed: May 24, 2000
(86) PCT No.: PCT/EP00/04735

§ 371 Date: Mar. 15, 2002

(30) Foreign Application Priority Data
Mar. 31, 2000 (DE) 100 16 117.0
May 24, 1999 (DE) 199 23 370.5

(51) Int. Cl. G06F 15/16

(52) U.S. Cl. 709/218

(57) ABSTRACT

A data processing device includes a telecommunications coupler for exchanging data with a data processing system, a data coupling device, a control device, and non-volatile first and second data memory areas. The control device controls the exchange of data with the data processing system as a function of control data stored in the first memory area. Data transmitted by the data processing system is stored in the second memory area as a file by the control device. The file may be transmitted to a display via the data coupling device according to the control device. The first memory area contains a loading enabling data element, to which a file is assigned in a predetermined first relation. The control device permits the data processing system to transmit only data that belongs to a file that is assigned to the loading enabling element in accordance with the predetermined first relation.

The present invention relates to a data processing device. In particular, the invention relates to a data processing device which is networked by means of a telecommunications device.

For some time, data processing devices which are networked by means of the Internet or other telecommunications systems have been used for processing “e-commerce” (electronic trading) of all types not only by companies but also by end users.

The Internet and other telecommunications systems such as proprietary online systems, for example, are almost always used by end users by employing a personal computer, also referred to as a PC, or a comparable device, for example a workstation, a portable computer (notebook) or a mini device which can be held in the hand (palmtop).

Personal computers and such comparable devices have the advantage that the scope of the functionality which can be made available to the end user by them is not determined solely by the hardware used but rather can be varied in an extremely flexible way by loading various programs at any time. For example, it is possible to install a specific piece of software at a later date if the end user wishes to make use of additional functionalities.

The disadvantage of this universality is the vastly increasing complexity of PCs or workstations which are equipped with customary operating systems such as Windows or Unix. The end user must firstly acquire a considerable amount of background knowledge on the structure and the functionality relationships of the complex system as a whole in order to be able to make practical use of the potential universality provided in it, for the purpose of carrying out specific functions.

It has become apparent that considerable groups of end users or prospective end users do not wish to, or cannot make use of telecommunications services, in particular for the purposes of e-commerce because they are not able to cope with the complexity of PCs or comparable devices, the use of which has until now been de facto a necessary precondition for participating in or using telecommunications services.

The technical problems which occur for the end user with conventional data processing devices vary greatly. They generally start with the fact that not only is it necessary to set up the operating system but also a connection to a telecommunications system, for example to the Internet, has to be configured and finally established. The modalities of the access to the Internet vary, inter alia, on a local basis depending on the country or region and moreover from provider to provider at the same location.

Finally, once a usable, networked data processing device has been obtained, the end user is confronted, for example in the Internet, with an unstructured mass of offers relating to commercial activities. In conventional data processing devices, the end user must himself acquire and absorb an extensive amount of background information in order to be able to make use of the offers which are of interest to him via the telecommunications network.

When the end user has finally found a supplier with which he wishes to have commercial relations, it is generally necessary to comply with numerous particular features for each supplier in terms of the identification and the authentication of the customer and the delivery of the ordered goods, and when processing payment.

In view of this problem, it has hitherto been proposed to provide extremely specialized data processing devices which are capable of making available only a single functionality or at most a small number of functionalities. An example of this is the mobile phone which constitutes a data processing device which is coupled to a telecommunications network and which serves essentially just a single purpose, namely that of making telephone calls. However, a restriction to a single functionality for a particular type of device is proving an obstacle as networked data processing devices become increasingly significant because the number of different types of devices which are required for the various fields of use is increasing excessively. As the number of functionalities per device increases along conventional procedures, for example by adding text messaging in the case of mobile phones, a complexity level, in terms of operating the device, which is intimidating for wide varieties of user groups is quickly reached again.

An important field of application of e-commerce is associated with the distribution of files, which can contain data processing programs, texts, images, multimedia units or video animations, to customers by content providers. In this field of application there is a particular feature that the exchange of services and performances between the service provider and customer can take place in a completely immaterial way because both the catalogue of goods and/or services, the ordering procedure, the delivery of the ordered goods and the billing can be processed in the form of data exchanged via telecommunications devices. A disadvantage of previous approaches to the distribution of units is that the customer generally had to acquire a master copy of the unit as a purchased item even if he only used it briefly or on an exceptional basis.

The invention is therefore related to a technical infrastructure which is suitable for such purposes.

The object of the invention is therefore to provide an improved data processing device which permits telecommunications services to be used with as little system knowledge as possible, and is nevertheless extremely flexible.

The object of the invention is also to provide an improved data processing device in which the billing can be carried out in a particularly flexible way.

This object is achieved according to the invention by means of a data processing device having the features disclosed in claim 1, by means of a data processing device having the features disclosed in claim 40, by means of a data processing device having the features disclosed in claim 77 and by means of a data processing device having the features disclosed in claim 78.

The subject-matters of the independent patent claims each have an independent inventive content.

The invention is explained in more detail below by means of exemplary embodiments. In the drawing:

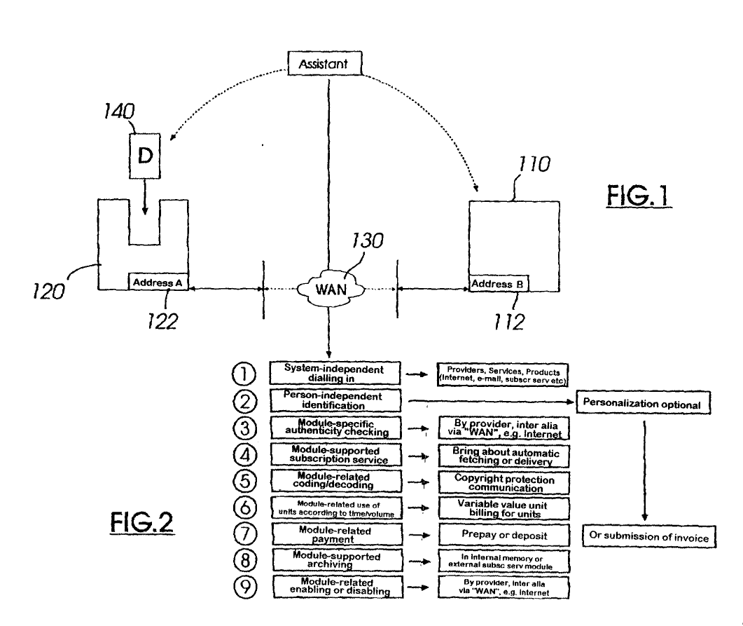

FIG. 1 shows a schematic view of a networked data processing device according to the invention with a server part and a client part,

FIG. 2 shows a schematic view of various aspects of the commercial use of a data processing device according to the invention,

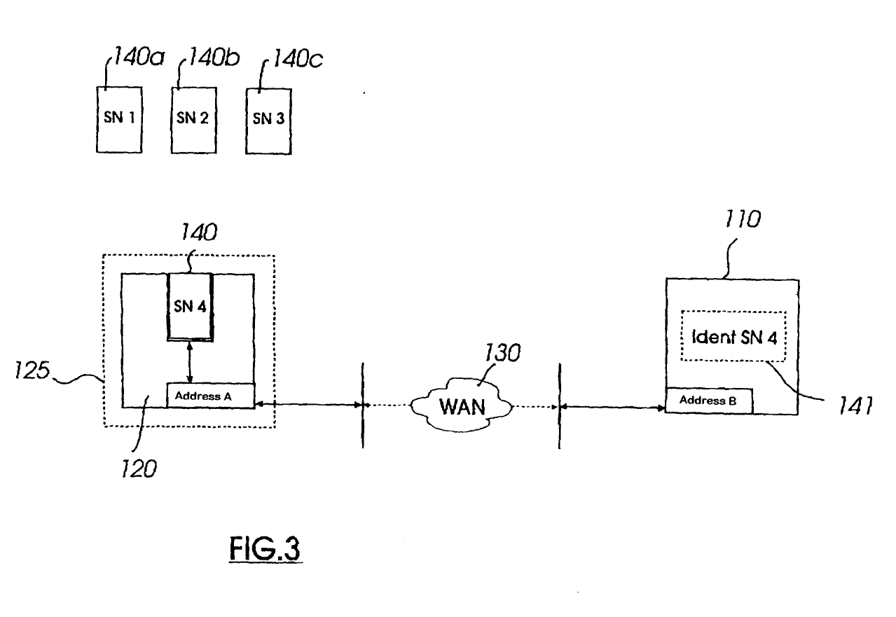

FIG. 3 shows a first application of the invention by means of a schematic view of a data processing device according to the invention,

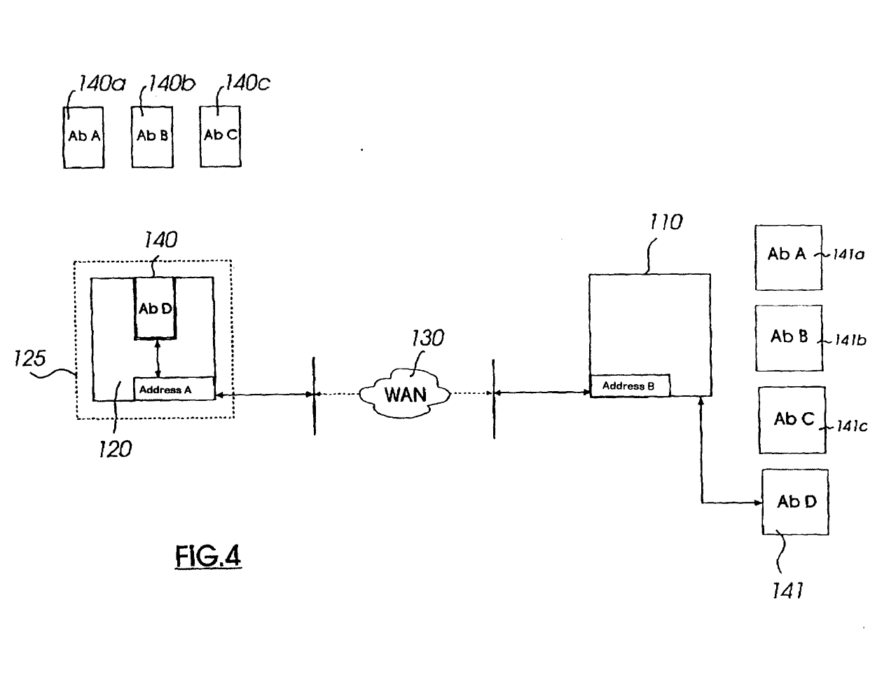

FIG. 4 shows a second application of the invention by means of a schematic view of a data processing device according to the invention,

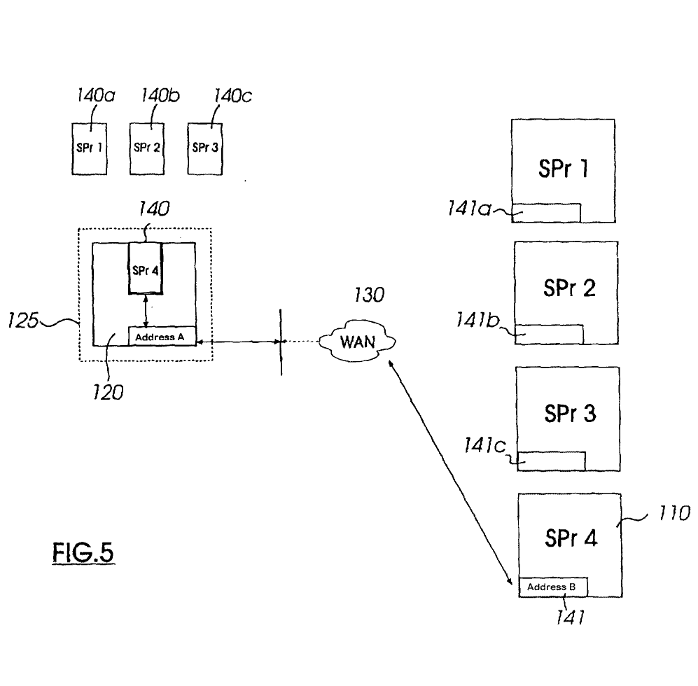

FIG. 5 shows a third application of the invention by means of a schematic view of a data processing device according to the invention,

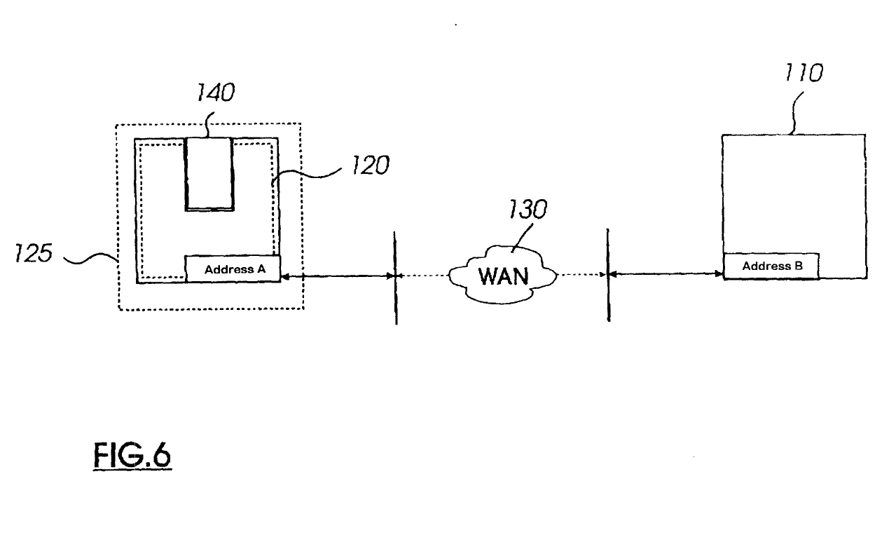

FIG. 6 shows a first variant of an embodiment of the solution according to the invention illustrated in FIG. 1,

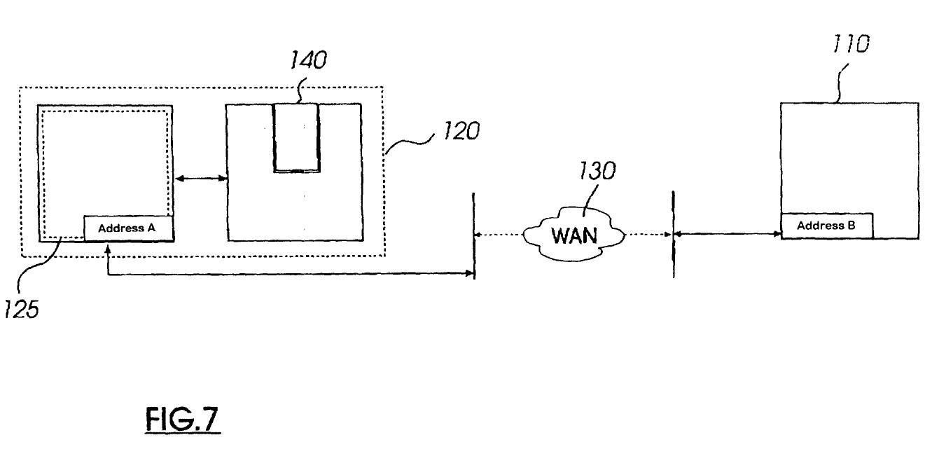

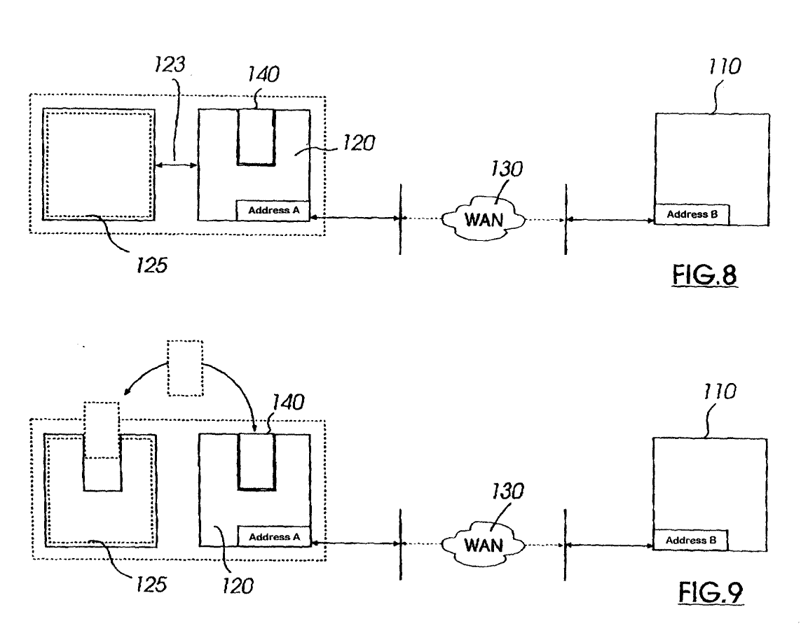

FIG. 7 shows a second variant of an embodiment of the solution according to the invention illustrated in FIG. 1,

FIG. 8 shows a third variant of an embodiment of the solution according to the invention illustrated in FIG. 1,

FIG. 9 shows a fourth variant of an embodiment of the solution according to the invention illustrated in FIG. 1,

FIG. 10 shows a fifth variant of an embodiment of the solution according to the invention illustrated in FIG. 1,

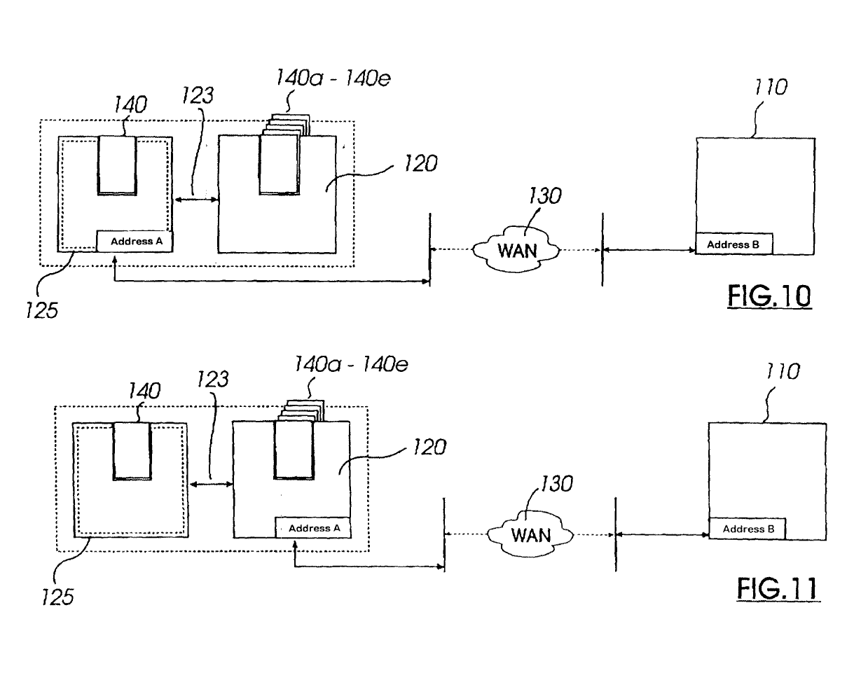

FIG. 11 shows a sixth variant of an embodiment of the solution according to the invention illustrated in FIG. 1,

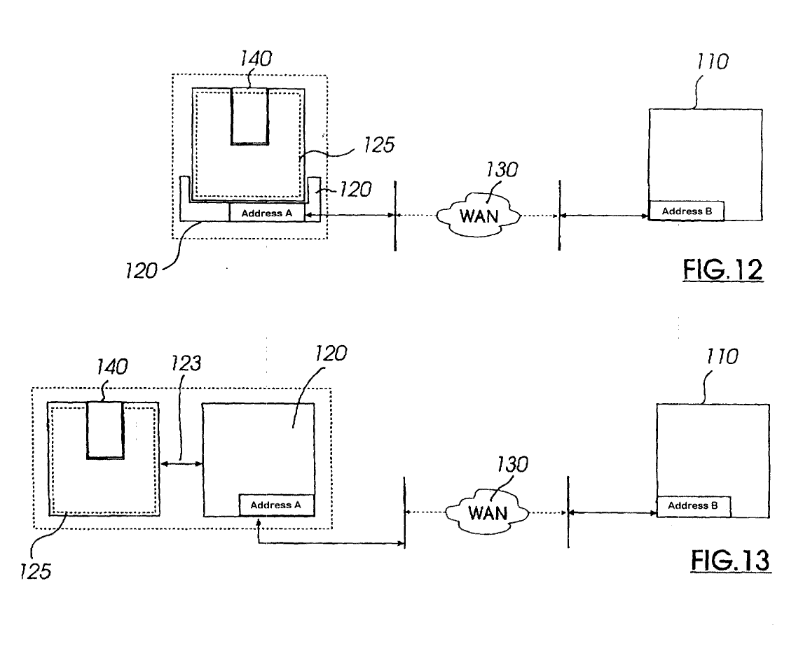

FIG. 12 shows a seventh variant of an embodiment of the solution according to the invention illustrated in FIG. 1,

FIG. 13 shows an eighth variant of an embodiment of the solution according to the invention illustrated in FIG. 1,

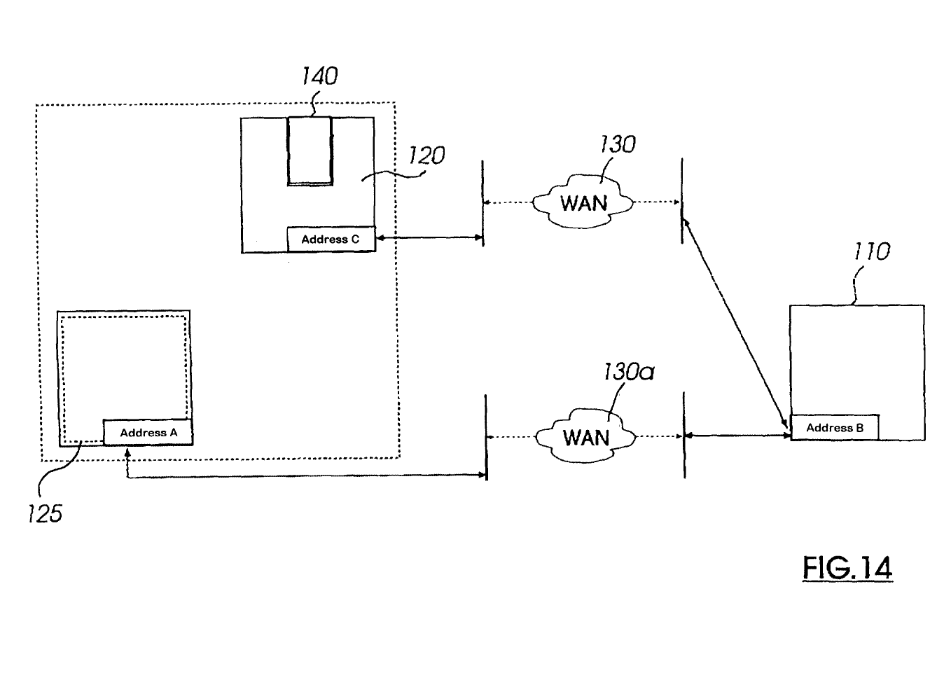

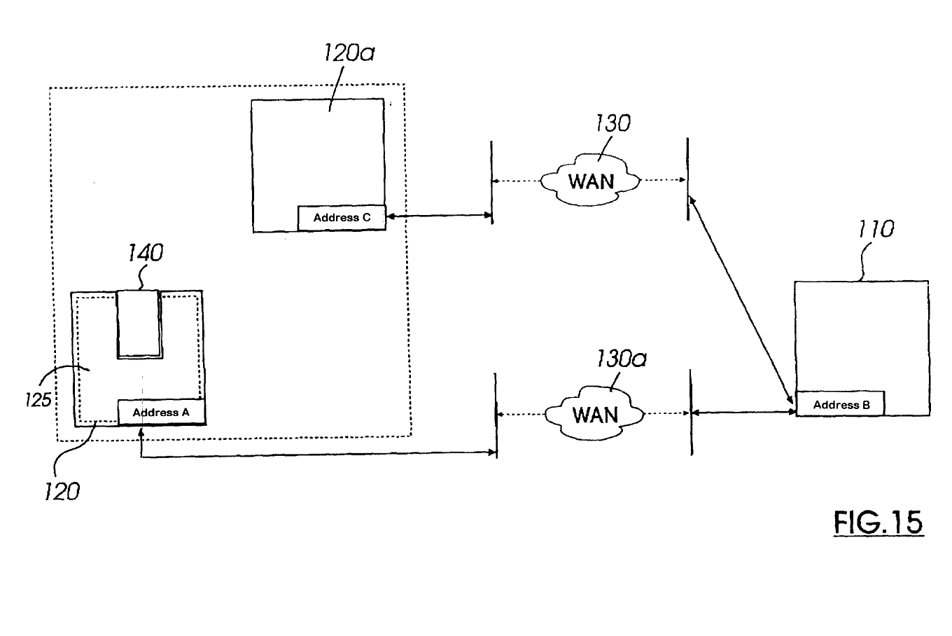

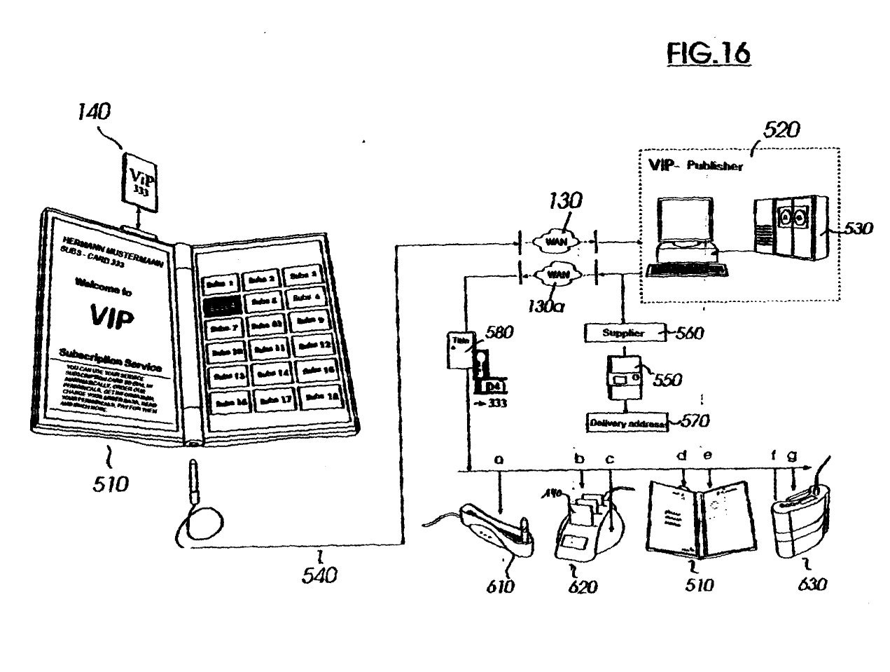

FIG. 14 shows a ninth variant of an embodiment of the solution according to the invention illustrated in FIG. 1,

FIG. 15 shows a tenth variant of an embodiment of the solution according to the invention illustrated in FIG. 1,

FIG. 16 shows a schematic view of a first embodiment of the solution according to the invention,

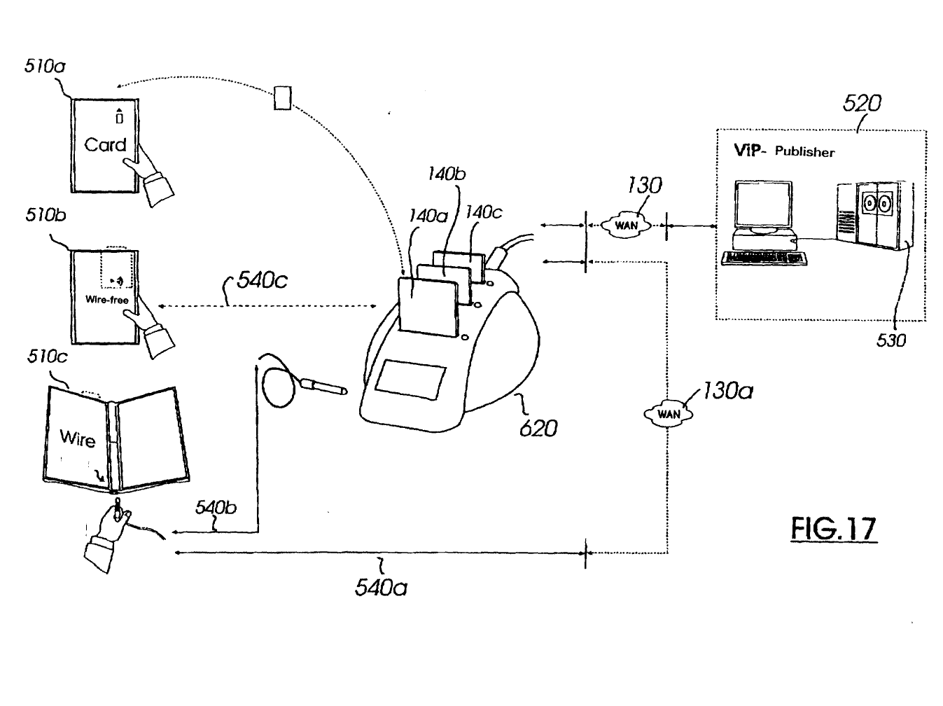

FIG. 17 shows a schematic view of a second embodiment of the solution according to the invention,

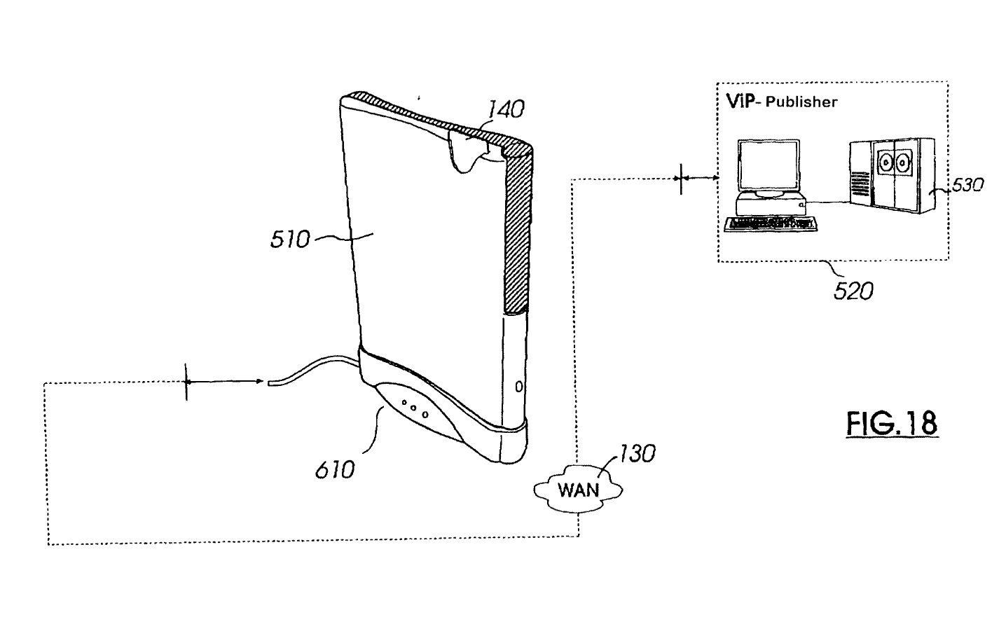

FIG. 18 shows a schematic view of a third embodiment of the solution according to the invention,

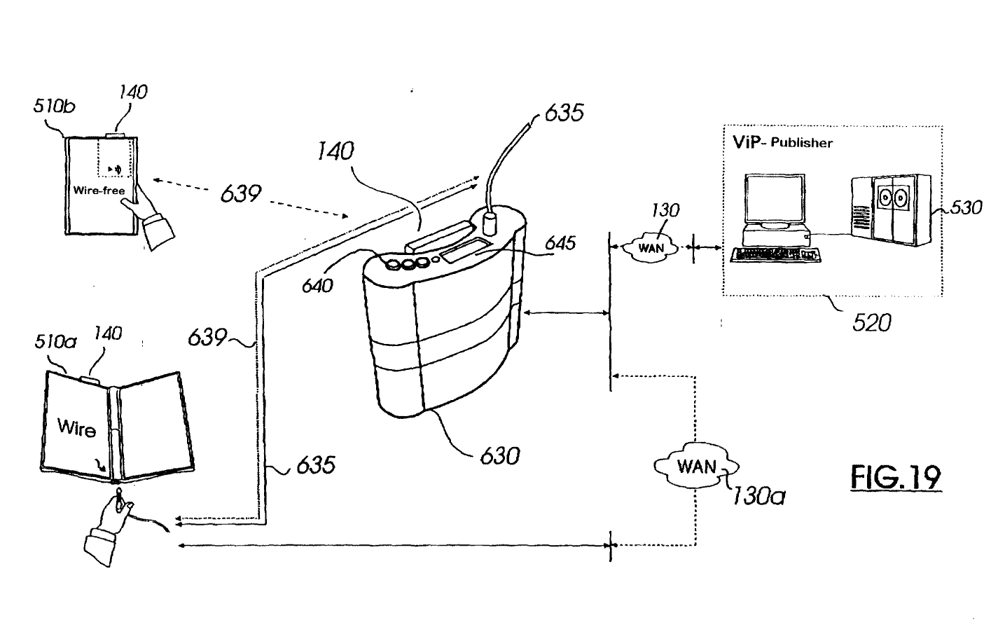

FIG. 19 shows a schematic view of a fourth embodiment of the solution according to the invention,

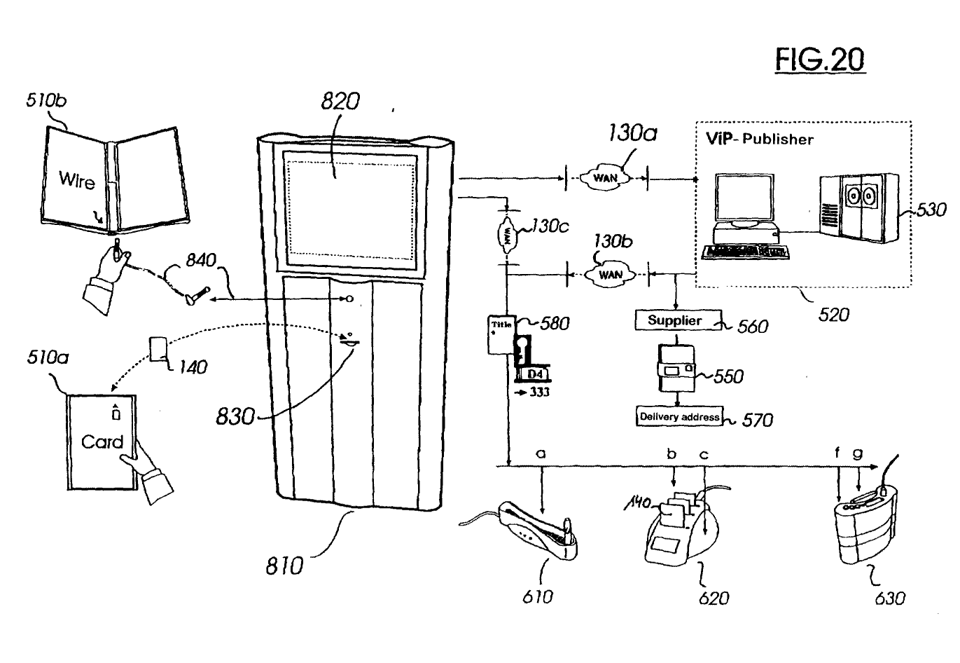

FIG. 20 shows a schematic view of a fifth embodiment of the solution according to the invention,

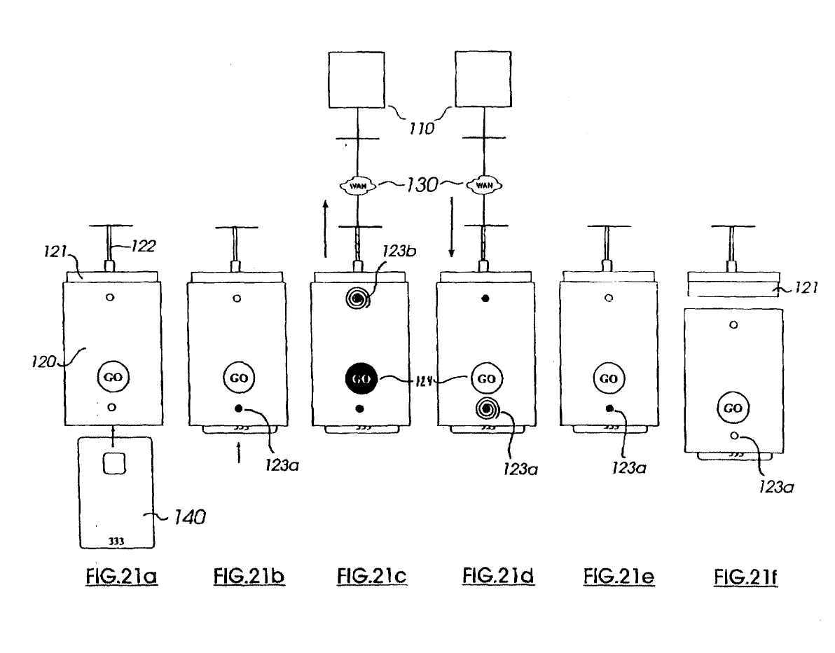

FIG. 21 shows a schematic view of a sixth embodiment of the solution according to the invention,

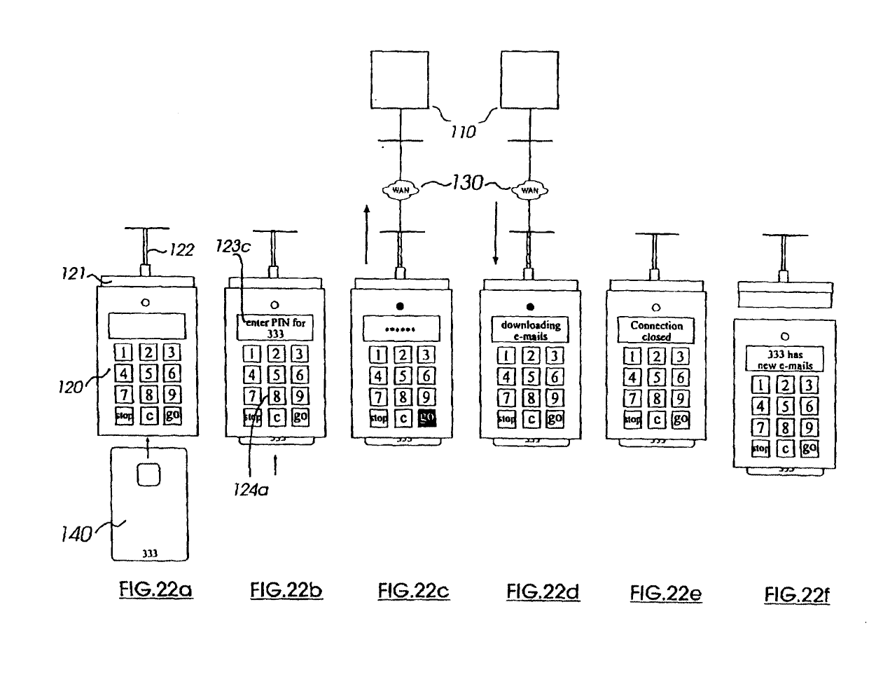

FIG. 22 shows a schematic view of another variant of the sixth embodiment of the solution according to the invention in FIG. 21,

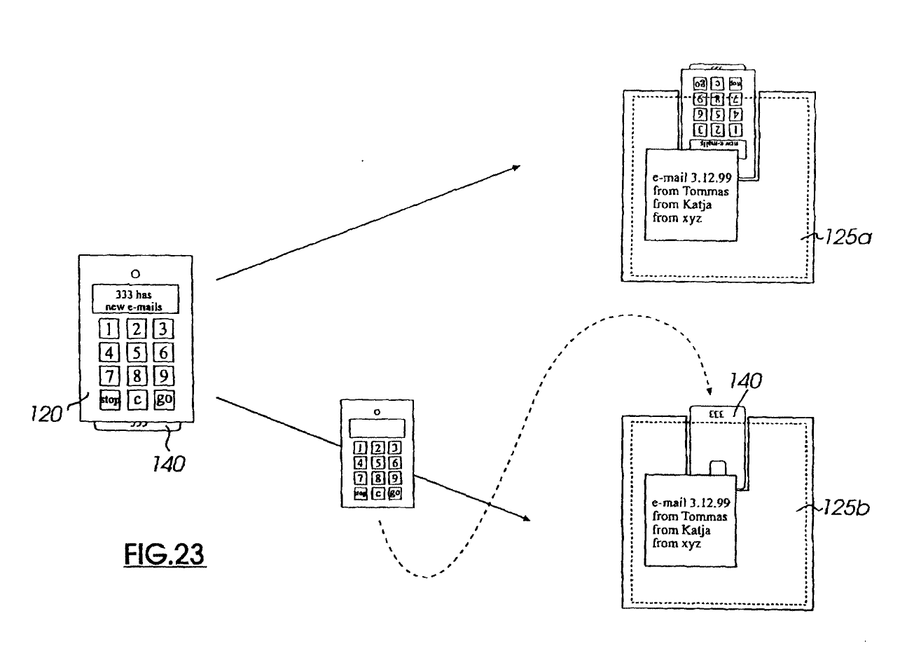

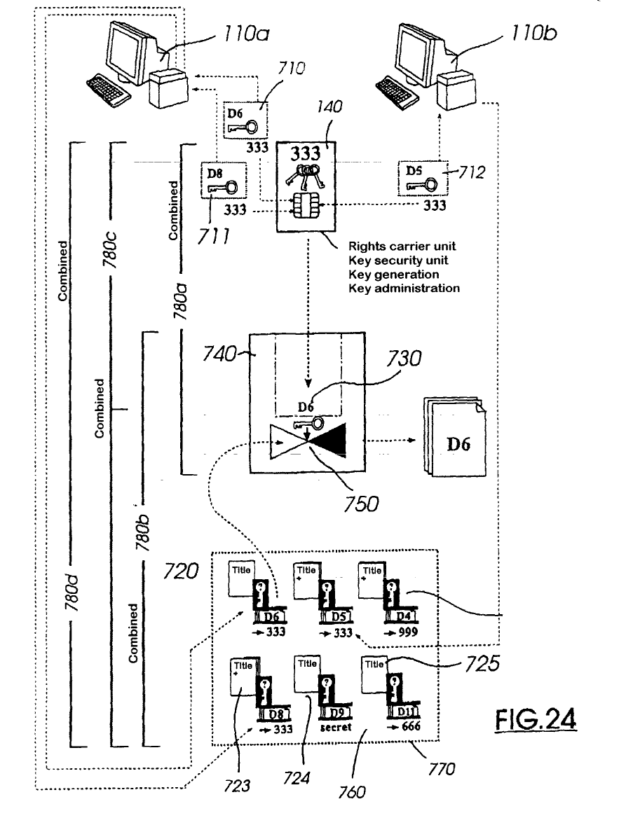

FIG. 23 shows a schematic view of another variant of the sixth embodiment of the solution according to the invention in FIG. 22,

FIG. 24 shows a schematic view of devices for encrypting and decrypting copyright-protected (multimedia) units representing files including the card module,

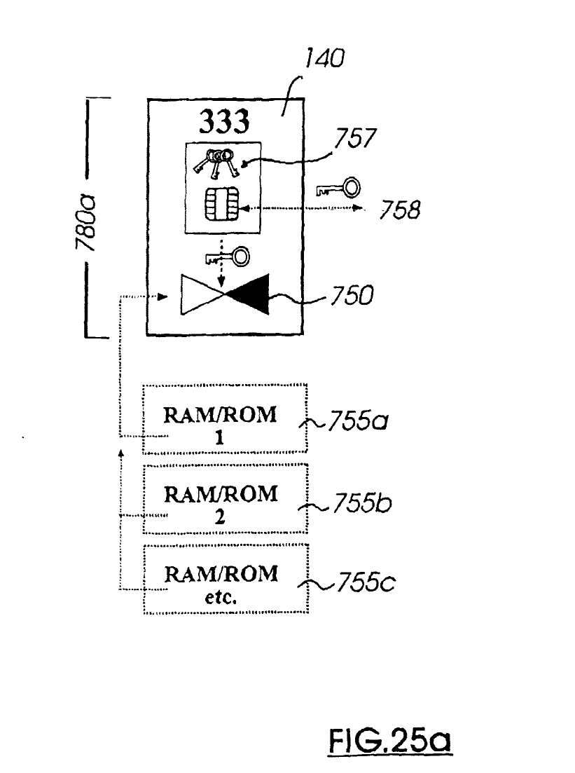

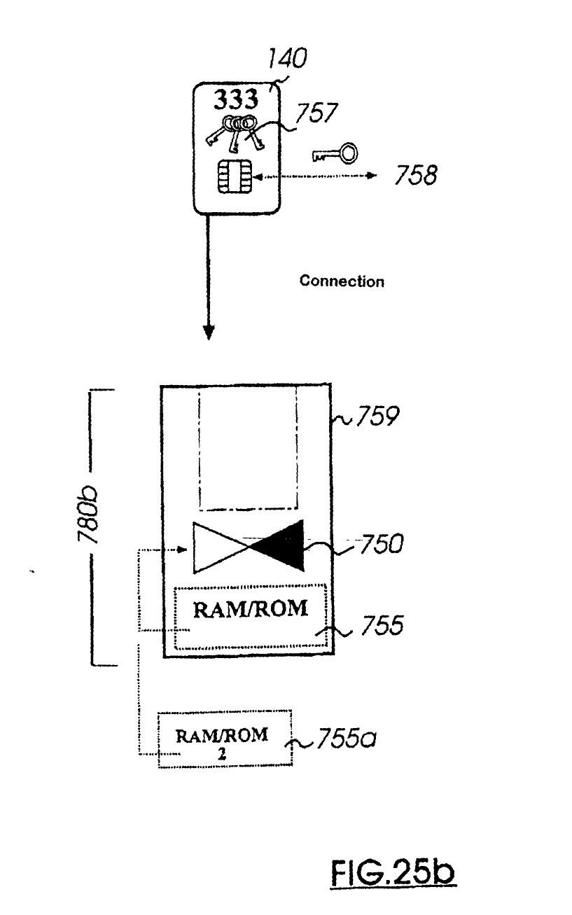

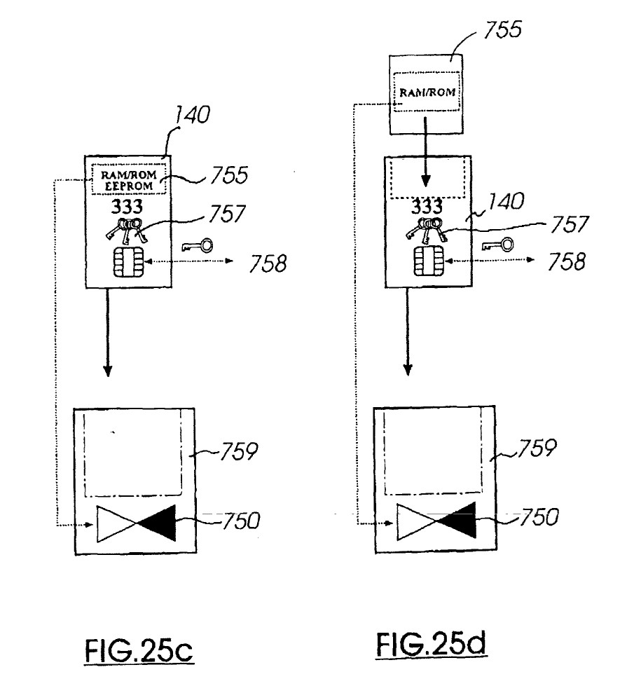

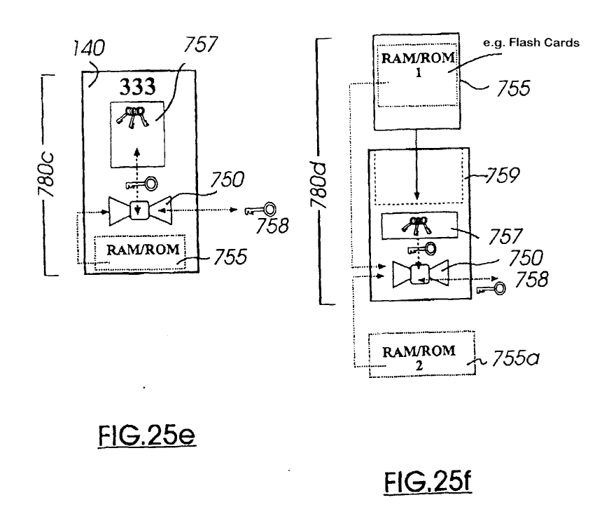

FIG. 25 shows, in the partial FIGS. 25a to 25f, different refinements of FIG. 24,

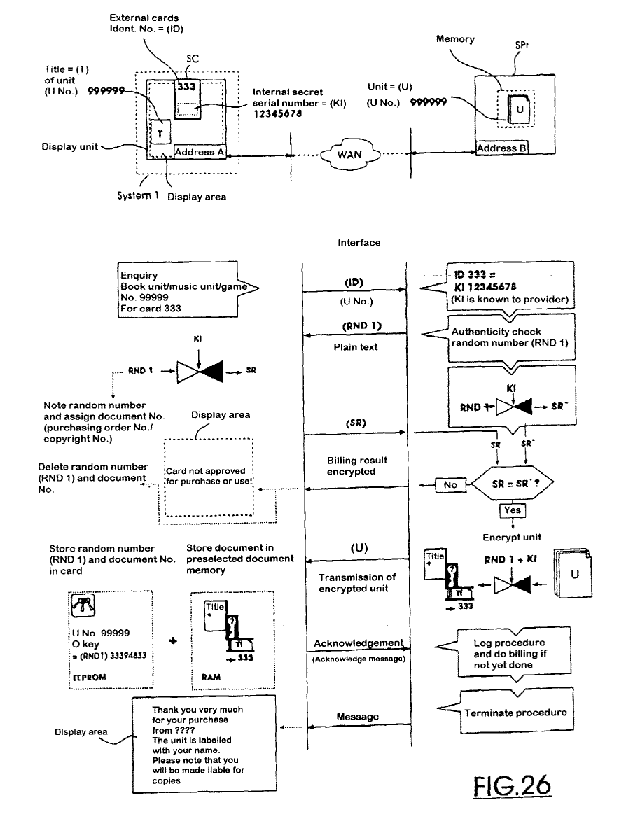

FIG. 26 shows a schematic view of an example of the time sequence of the exchange of data between the client part and server part,

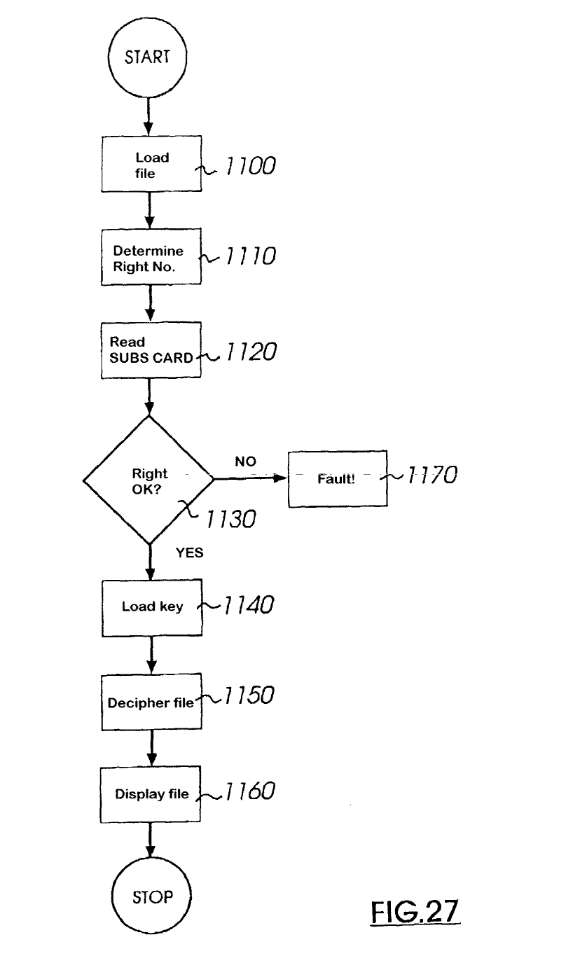

FIG. 27 shows a schematic view of a flowchart of a first method for billing for the acquisition of files representing software, texts or multimedia units, from a server part,

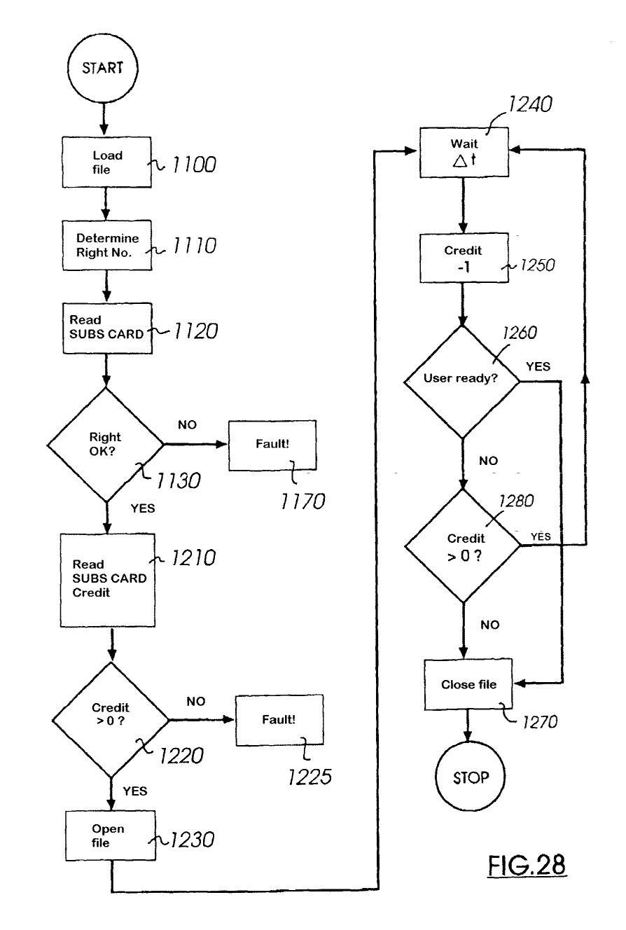

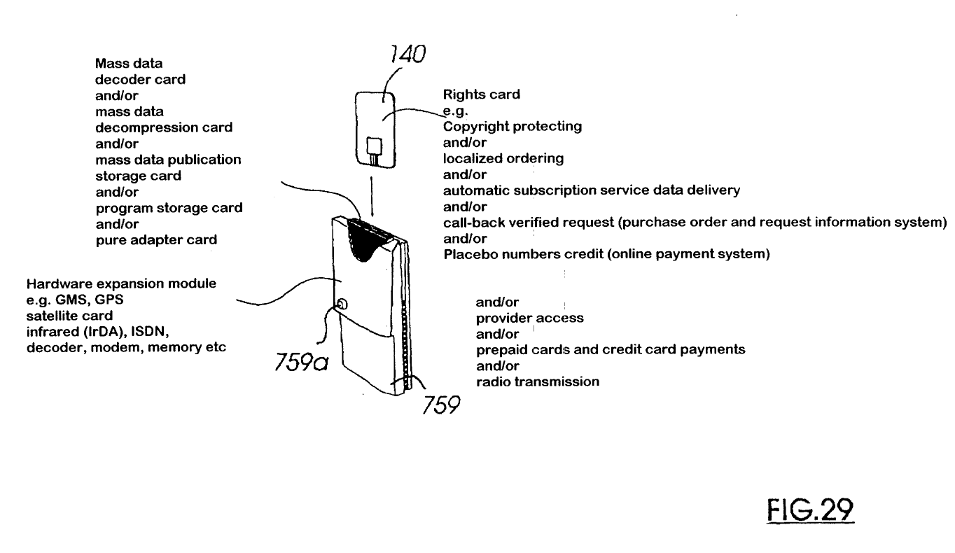

FIG. 28 shows a schematic view of a flowchart of a second method for billing for the acquisition of files representing software, texts or multimedia units, from a server part,

FIG. 29 shows a perspective view of a hardware expansion module with a chip card as card module,

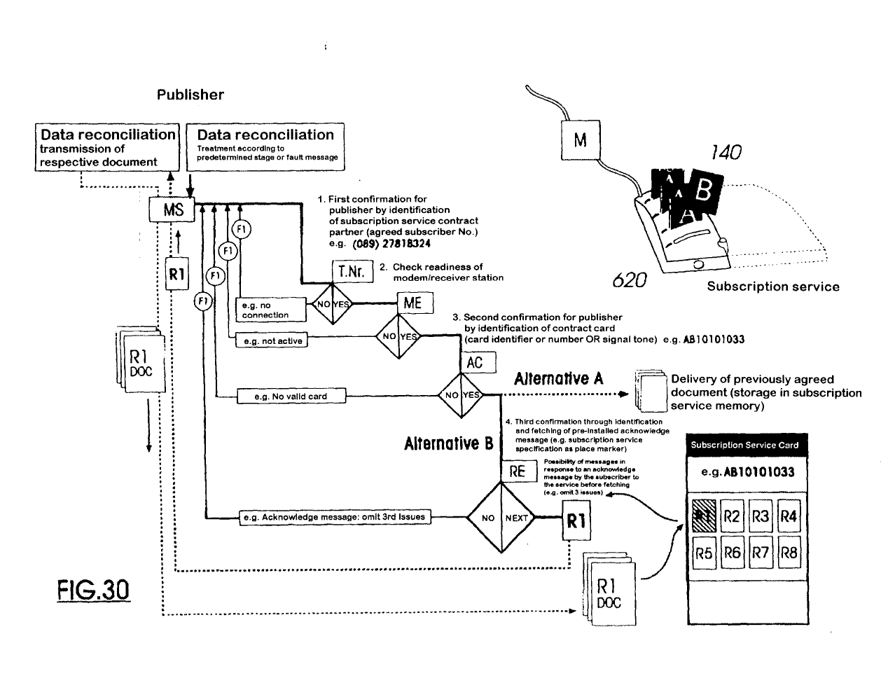

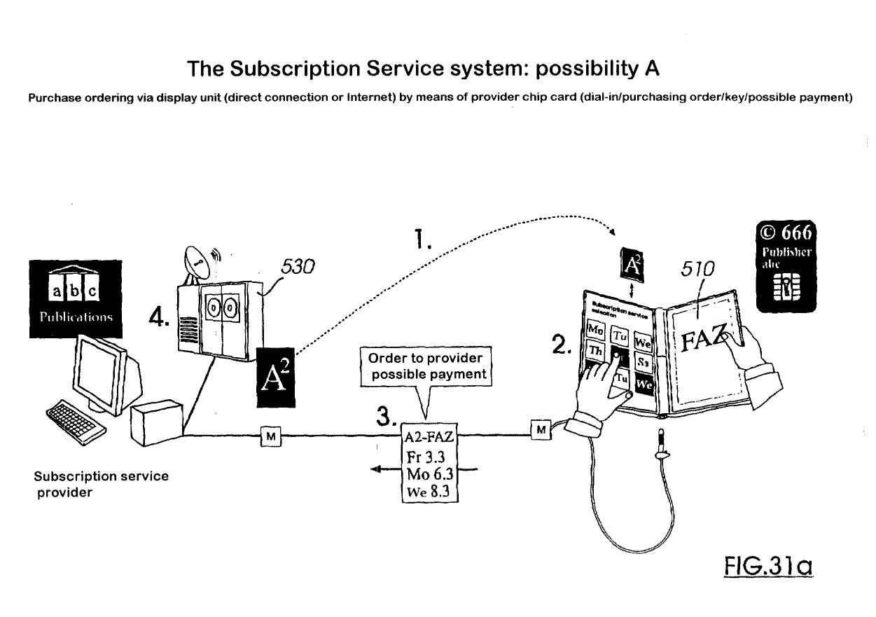

FIG. 30 shows a schematic flowchart of an exemplary subscription service ordering process,

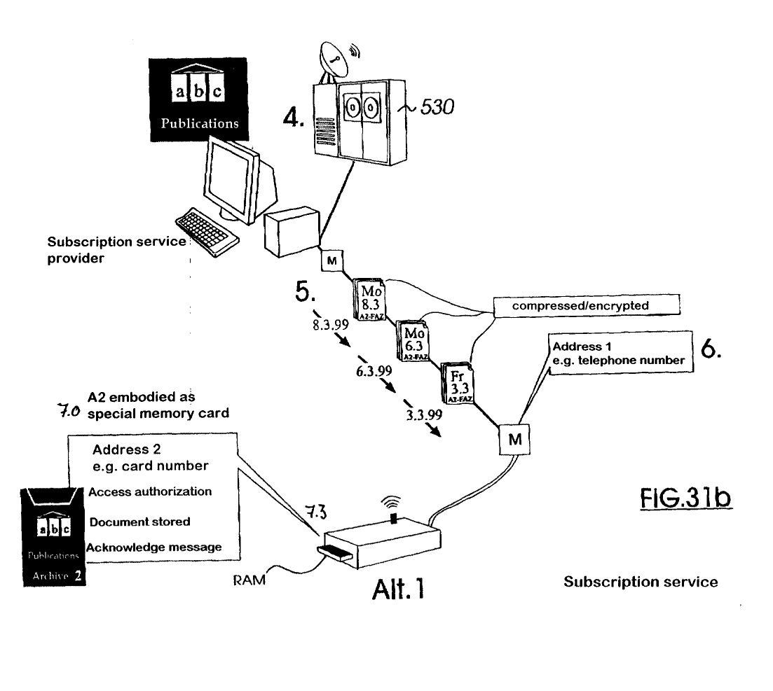

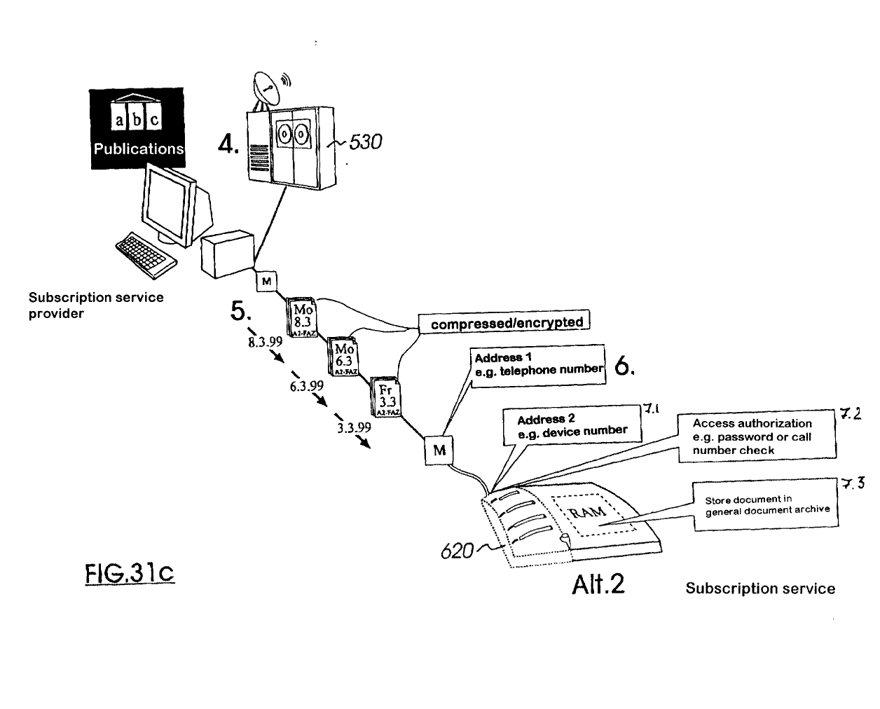

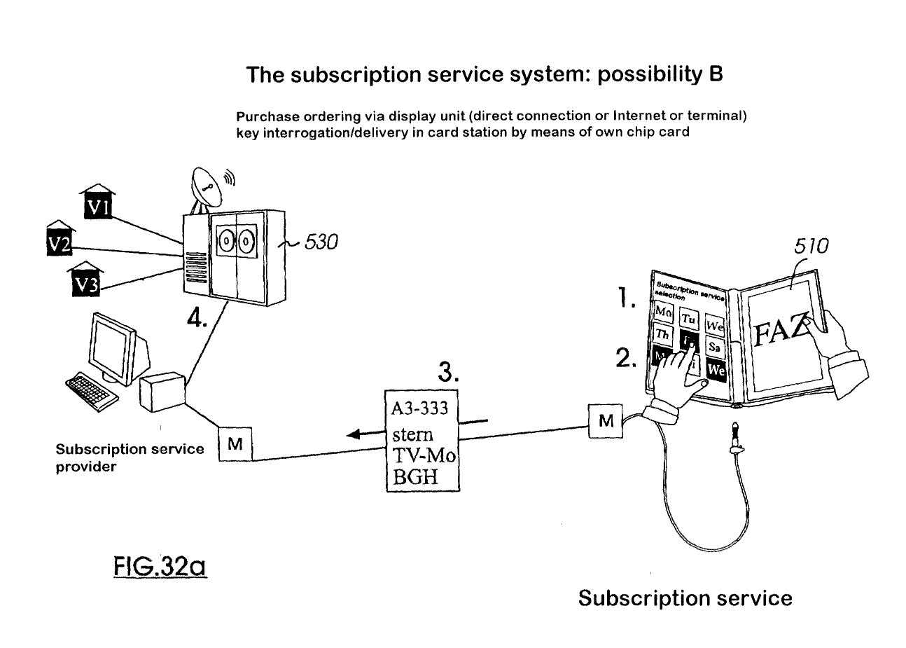

FIG. 31 shows a schematic flowchart of a first variant of a subscription service processing system by means of the solution according to the invention,

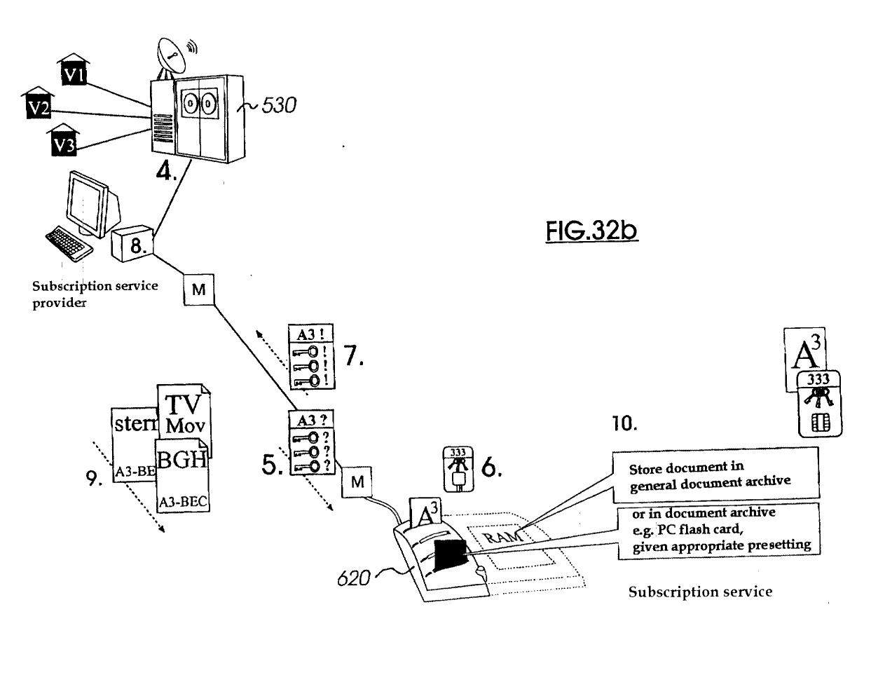

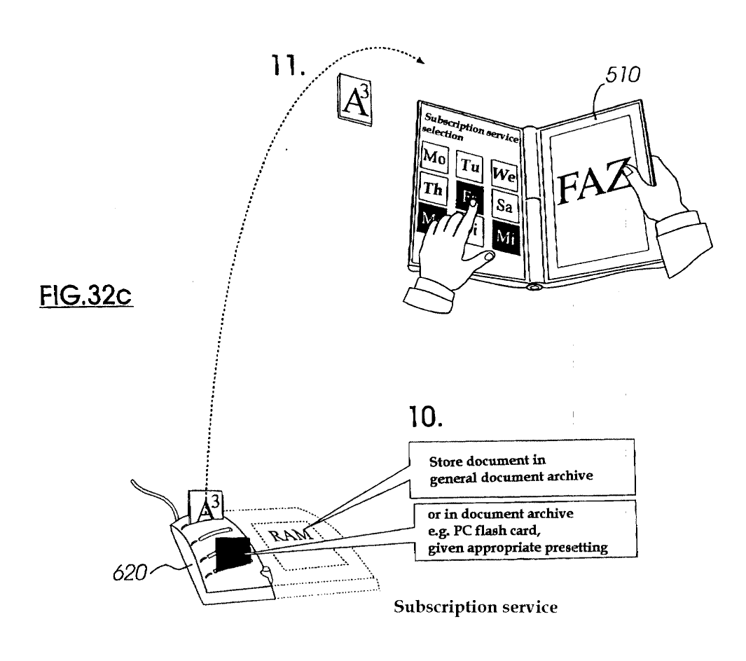

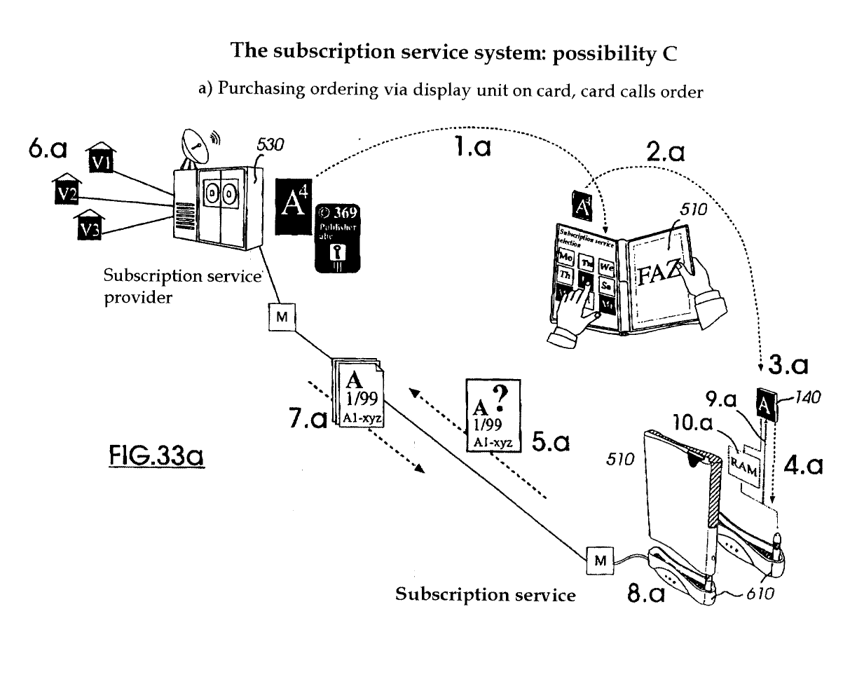

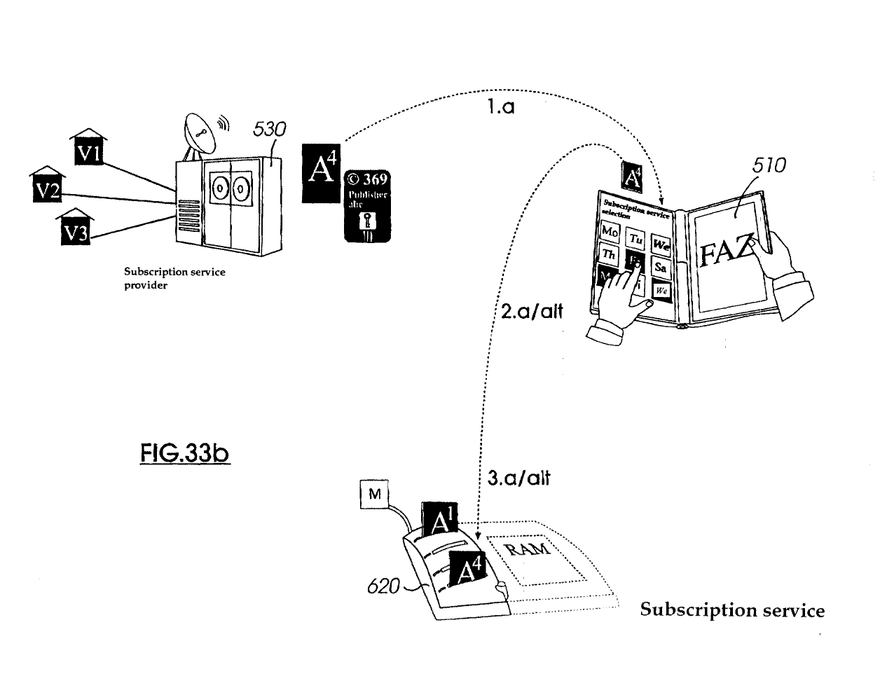

FIG. 32 shows a schematic flowchart of a second variant of a subscription service processing system by means of the solution according to the invention,

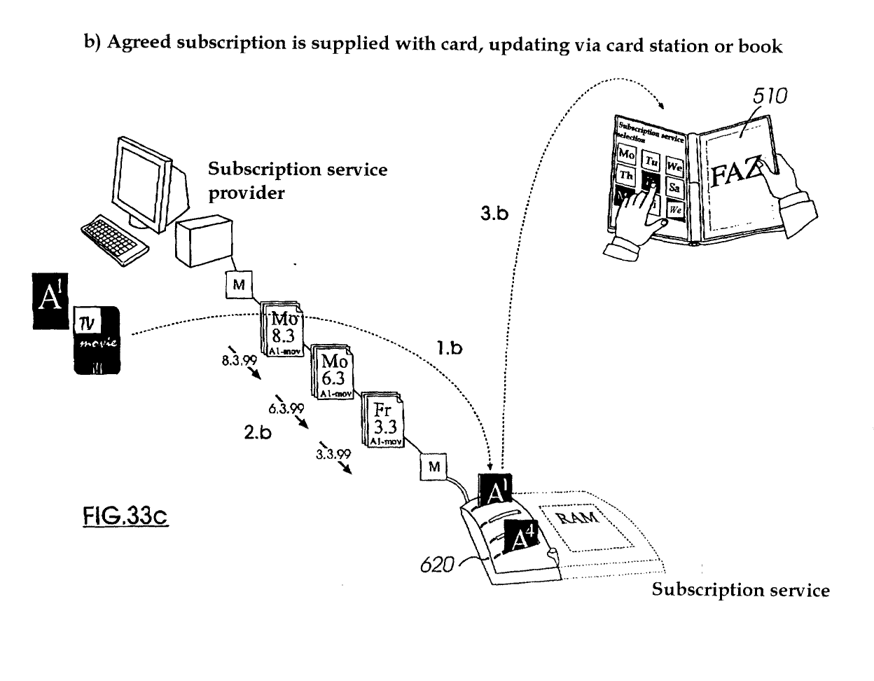

FIG. 33 shows a schematic flowchart of a third variant of a subscription service processing system by means of the solution according to the invention,

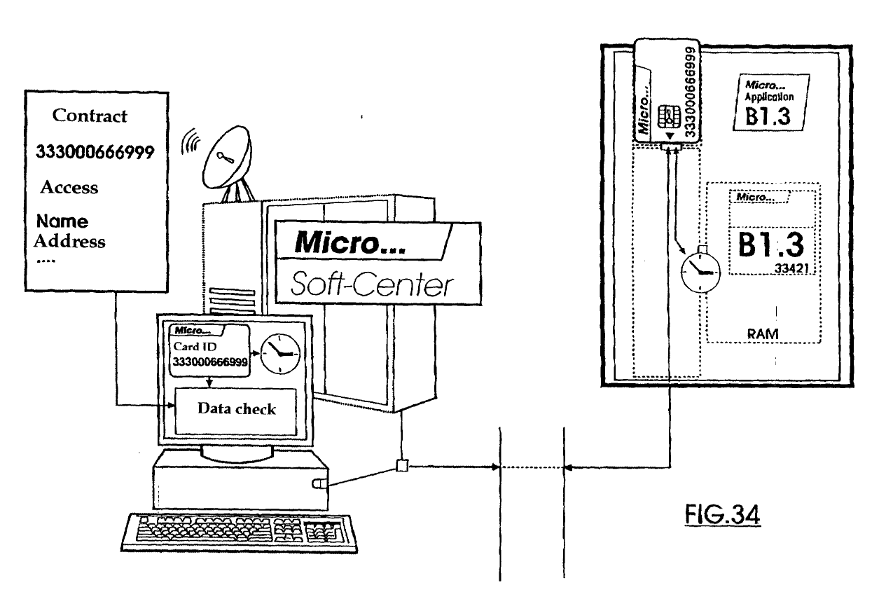

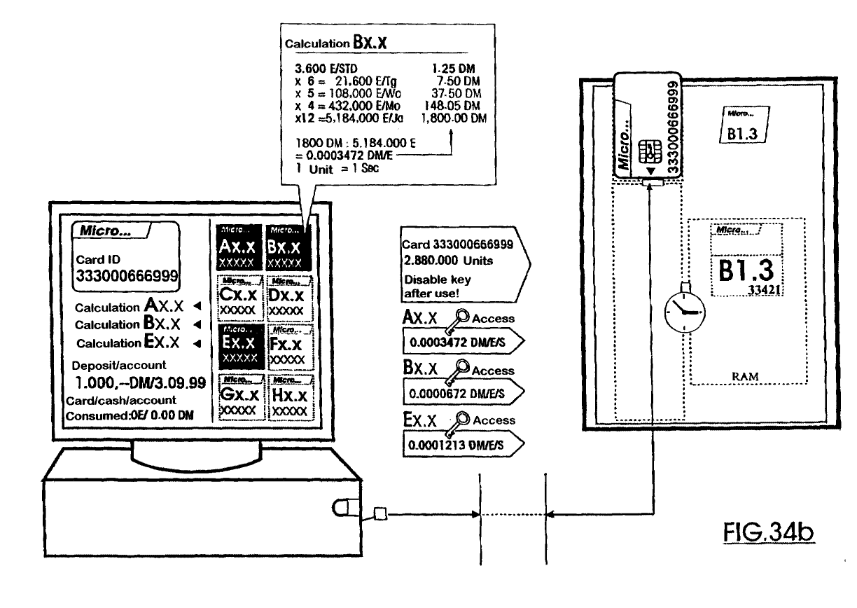

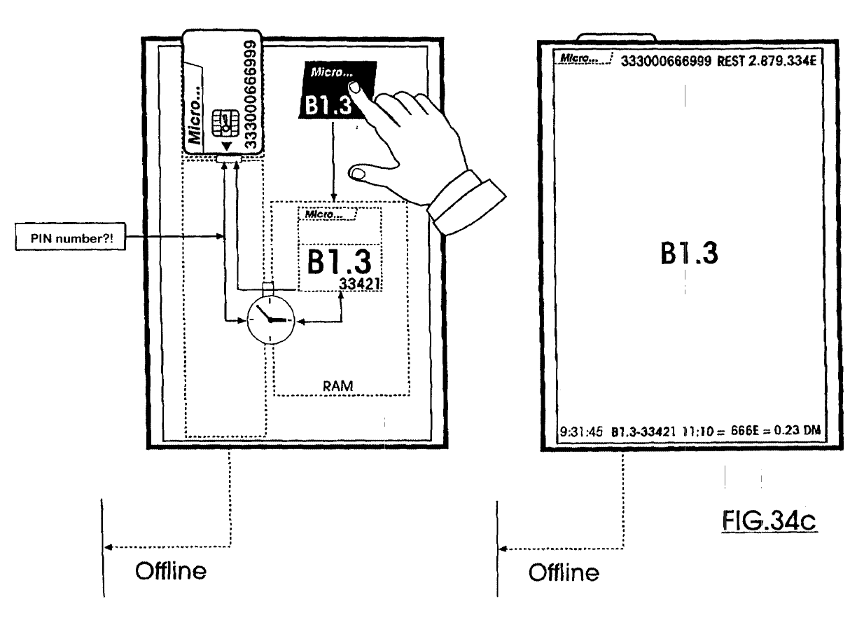

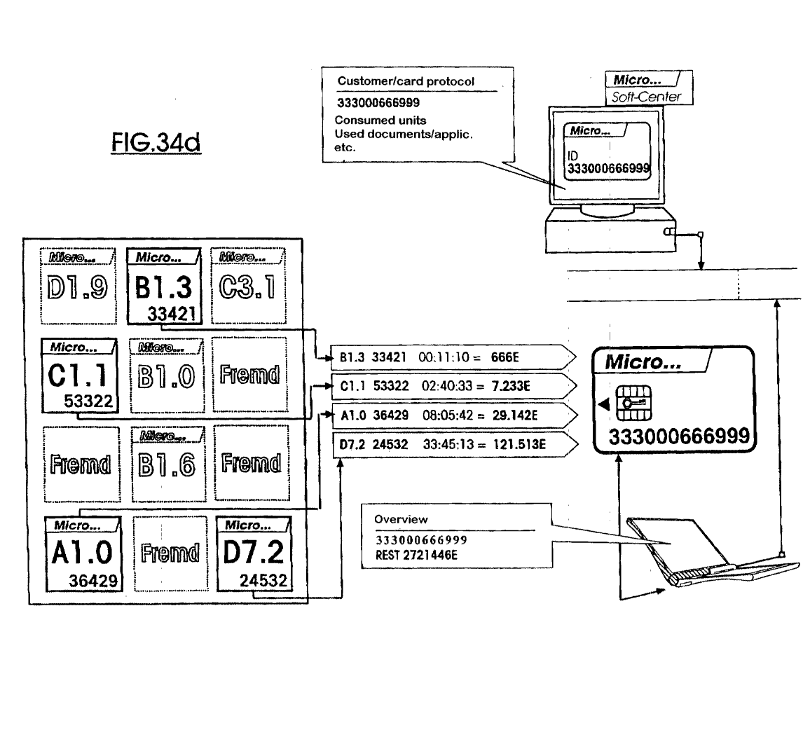

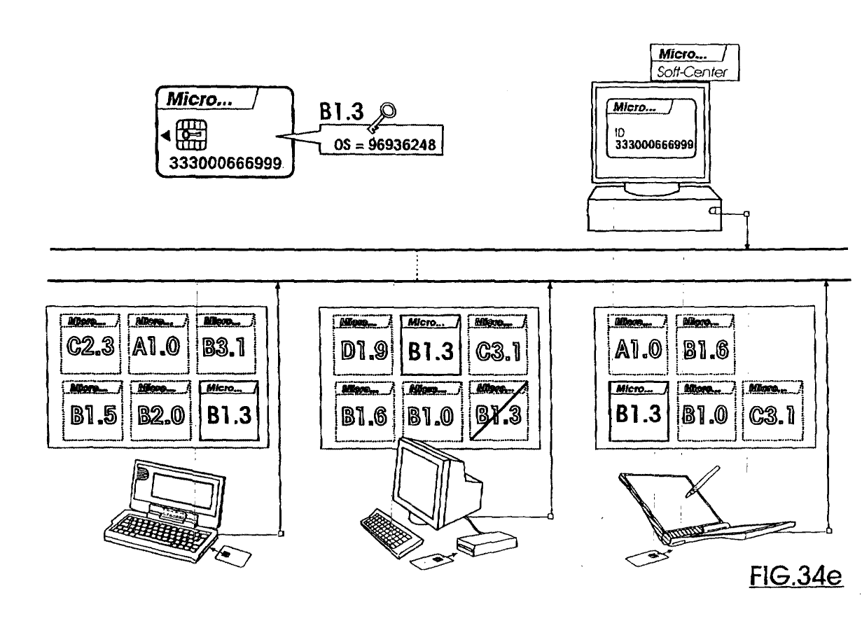

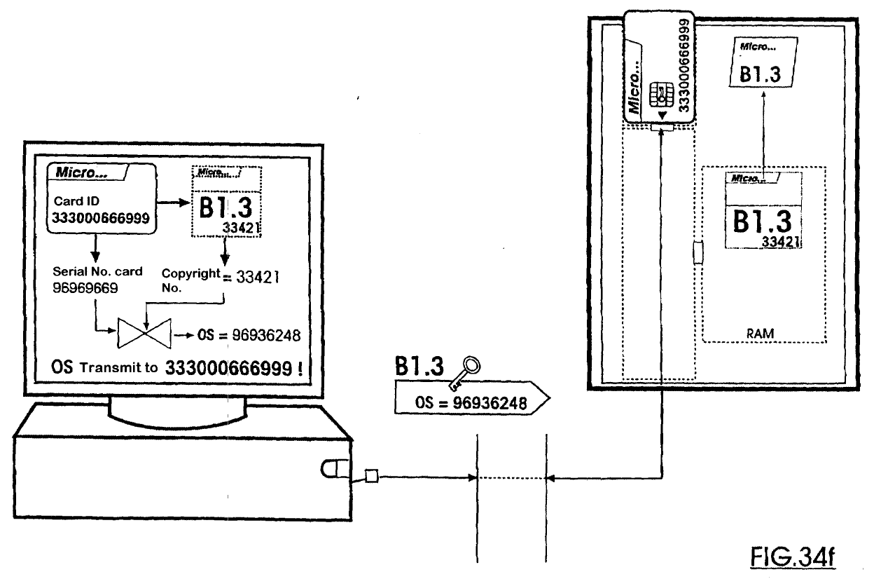

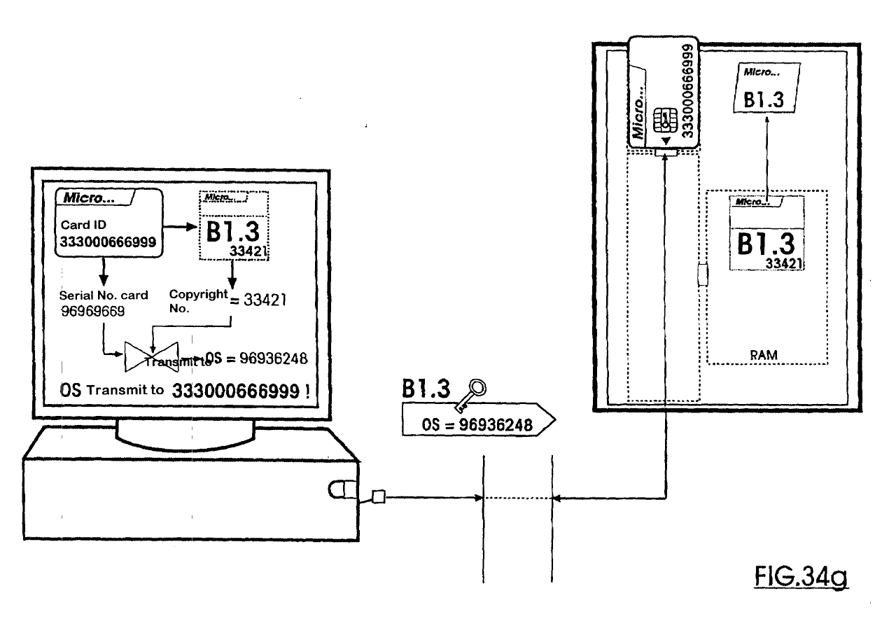

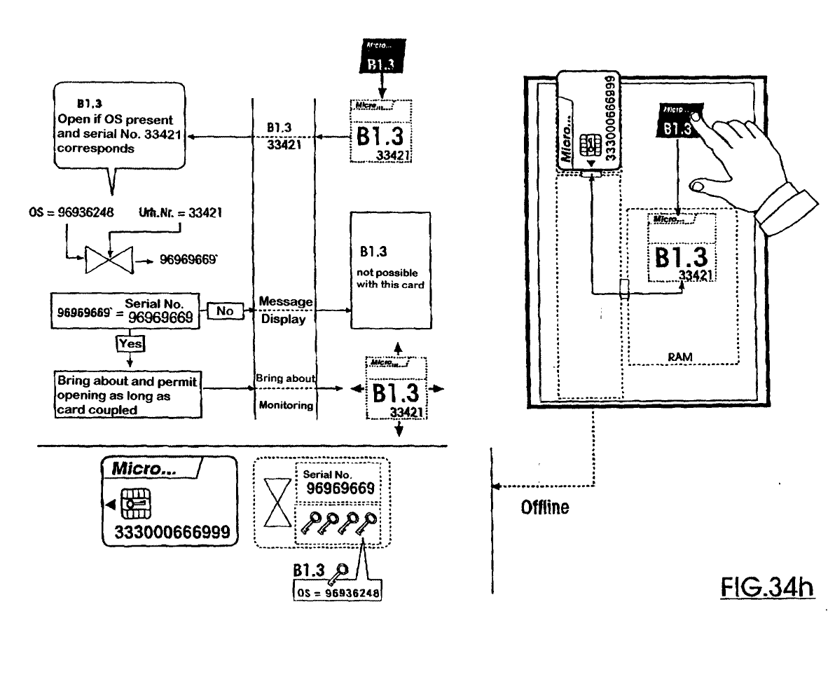

FIG. 34 shows, in the partial FIGS. 34a to 34h, schematic views of sequences in conjunction with the billing of supplied files in the context of the solution according to the invention,

FIG. 35 shows, in the partial FIGS. 35a to 35c, a data processing device according to the invention with a wearable computer,

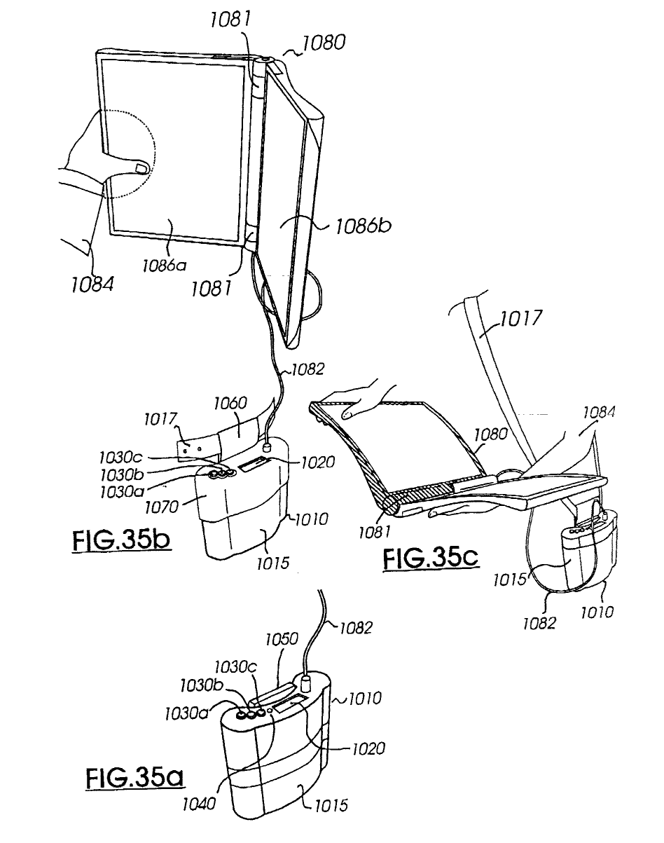

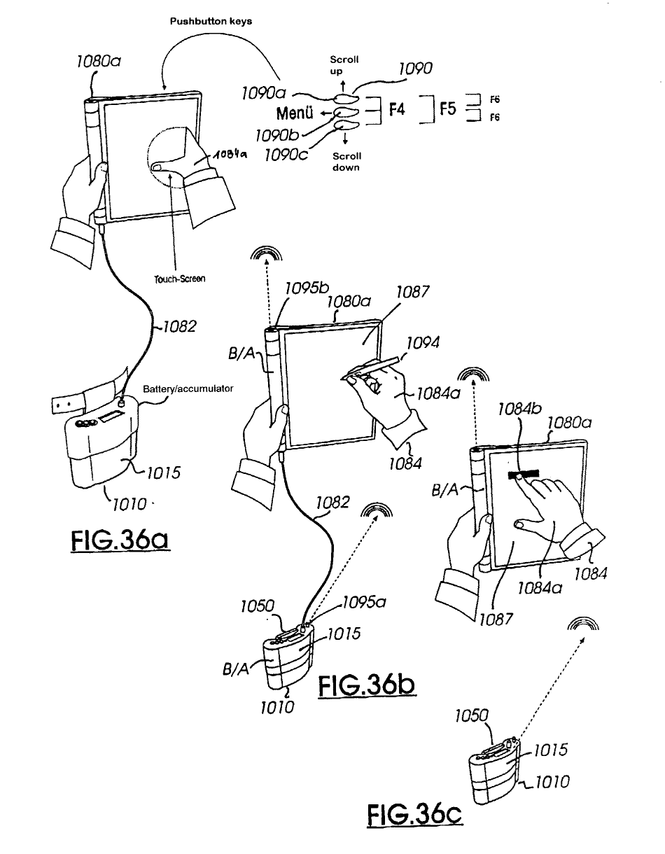

FIG. 36 shows, in the partial FIGS. 36a to 36c, variants of the data processing device illustrated in FIG. 35,

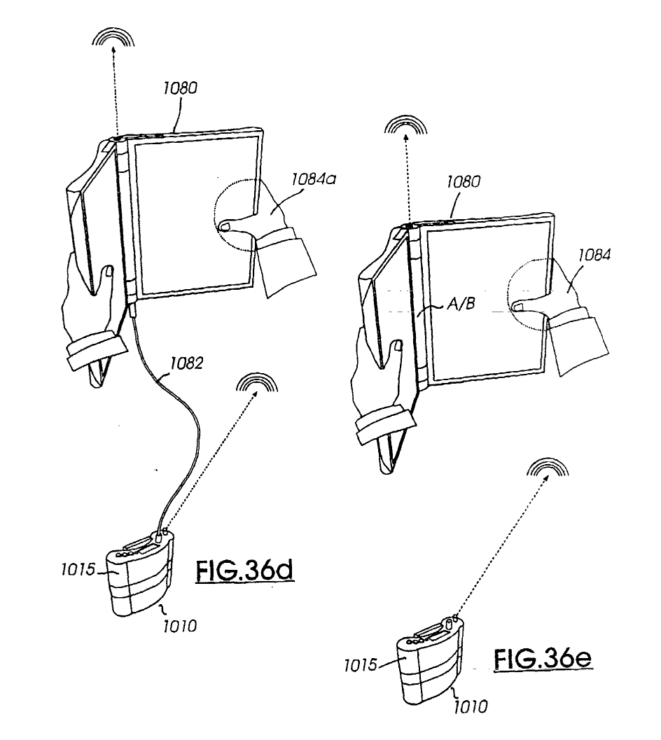

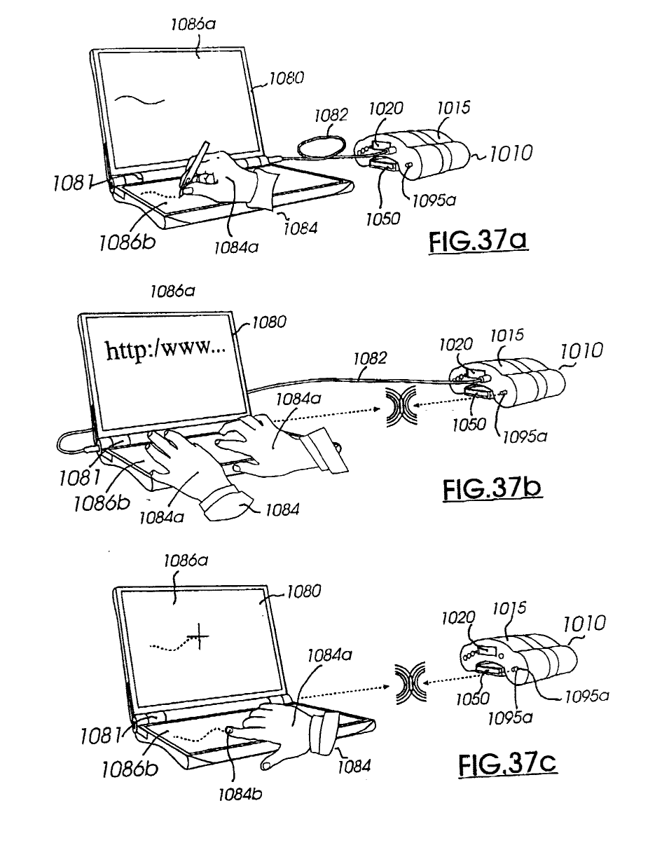

FIG. 37 shows, in the partial FIGS. 37a to 37c, a further variant of a data processing device according to the invention,

FIG. 38 shows a view of a first variant of a data processing system according to the invention with a wearable computer and a hand-held part, which are connected to one another via a cable (FIG. 38a) or in a wire-free fashion (FIG. 38b),

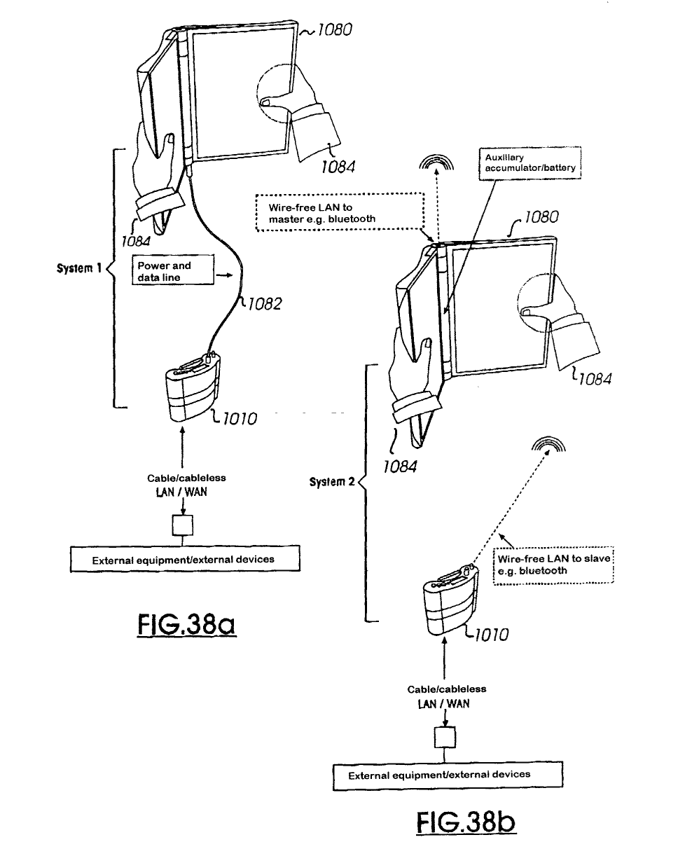

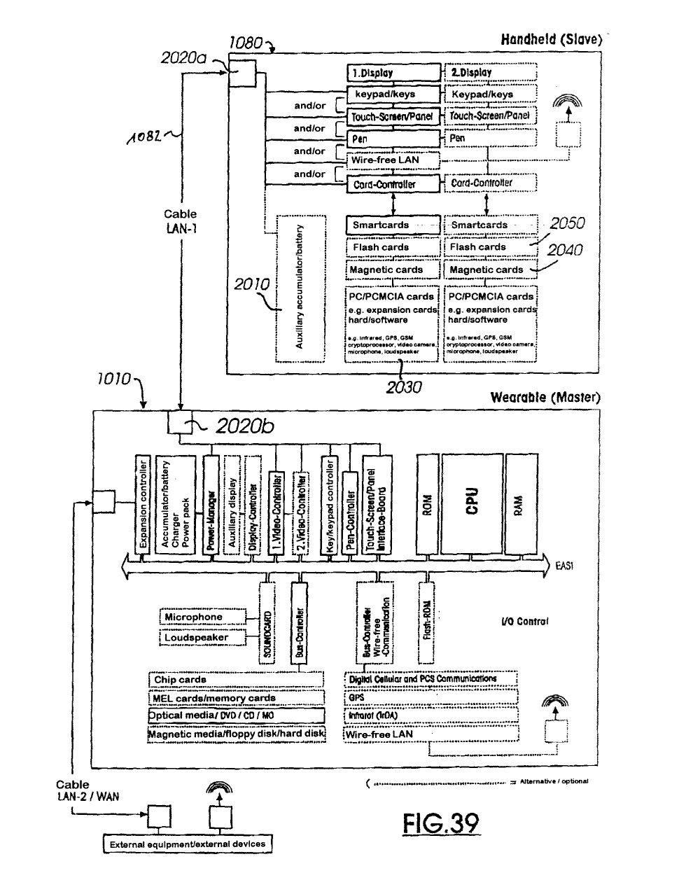

FIG. 39 shows a highly schematic block diagram of the first variant of a data processing system according to the invention illustrated in FIG. 38,

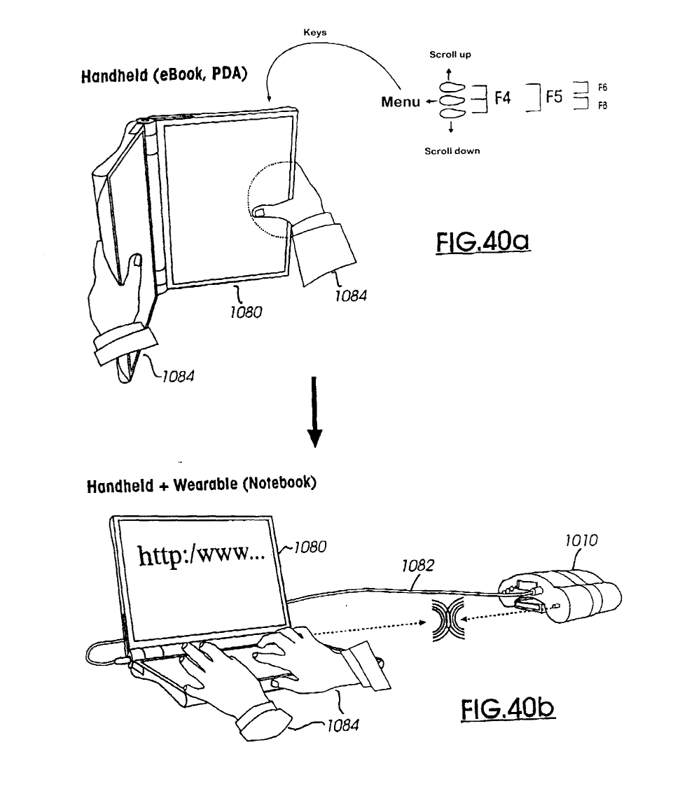

FIG. 40 shows a view of a second variant of a data processing system according to the invention with a wearable computer and a hand-held part, in which case the hand-held part can also be used independently (FIG. 40a) or can be connected to a wearable computer in a wire-free fashion and/or using a cable (FIG. 40b),

FIG. 41 shows a highly schematic block diagram of the second variant of a data processing system according to the invention illustrated in FIG. 39,

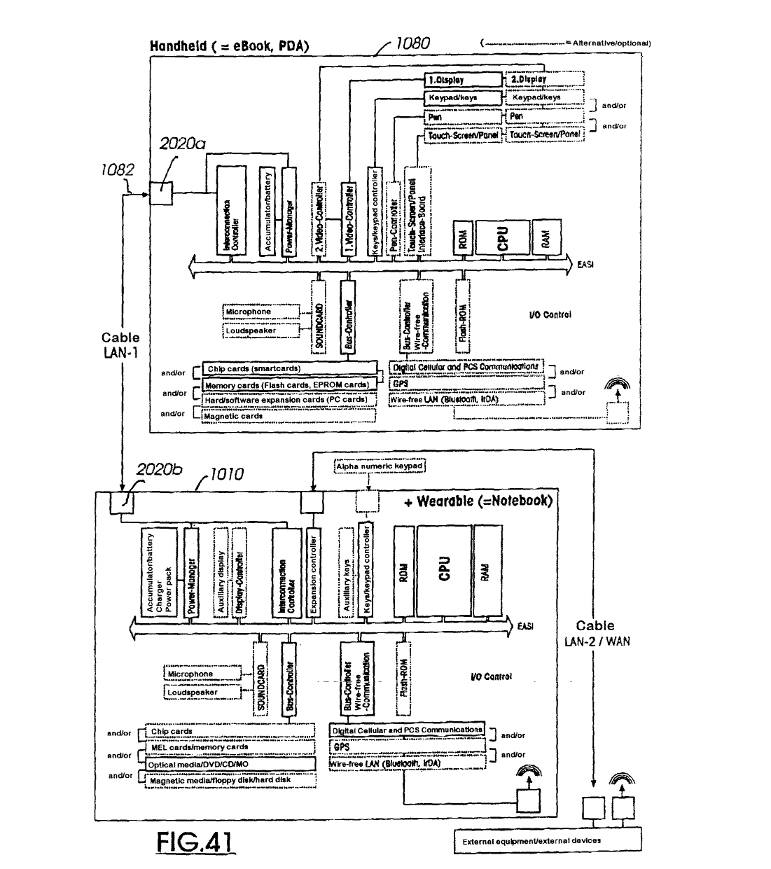

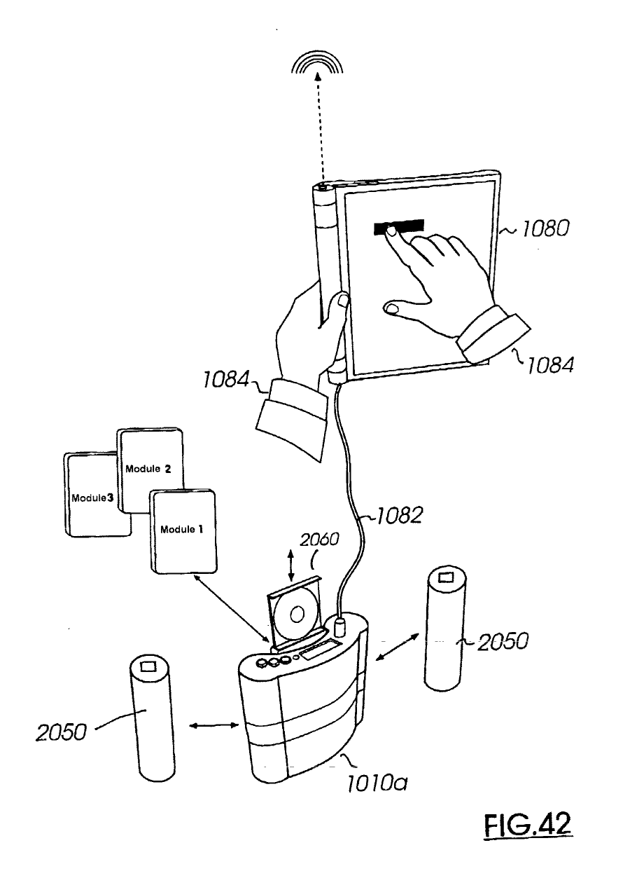

FIG. 42 shows a view of a third variant of the data processing system according to the invention with a wearable expansion unit and a hand-held part, in which case the hand-held part can also be used independently,

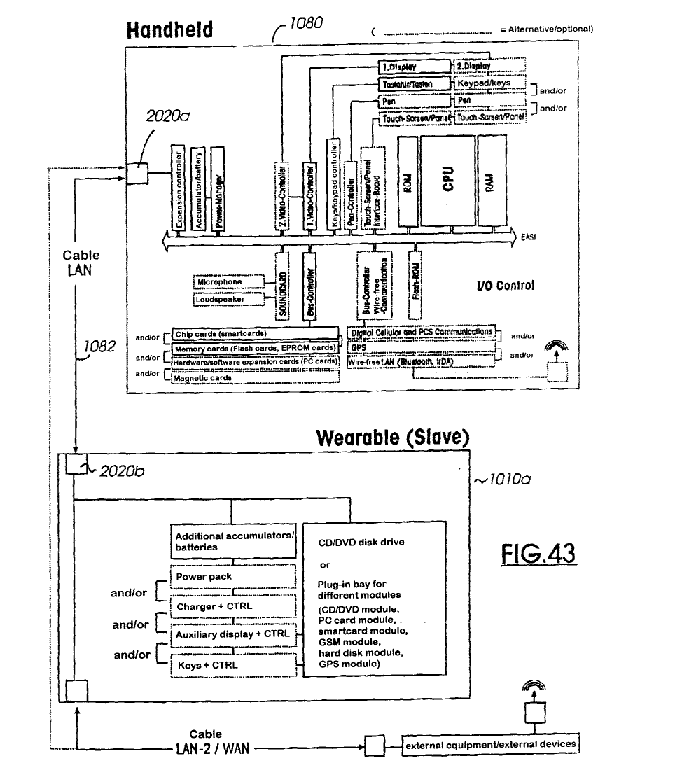

FIG. 43 shows a highly schematic block diagram of the third variant of a data processing system according to the invention illustrated in FIG. 42,

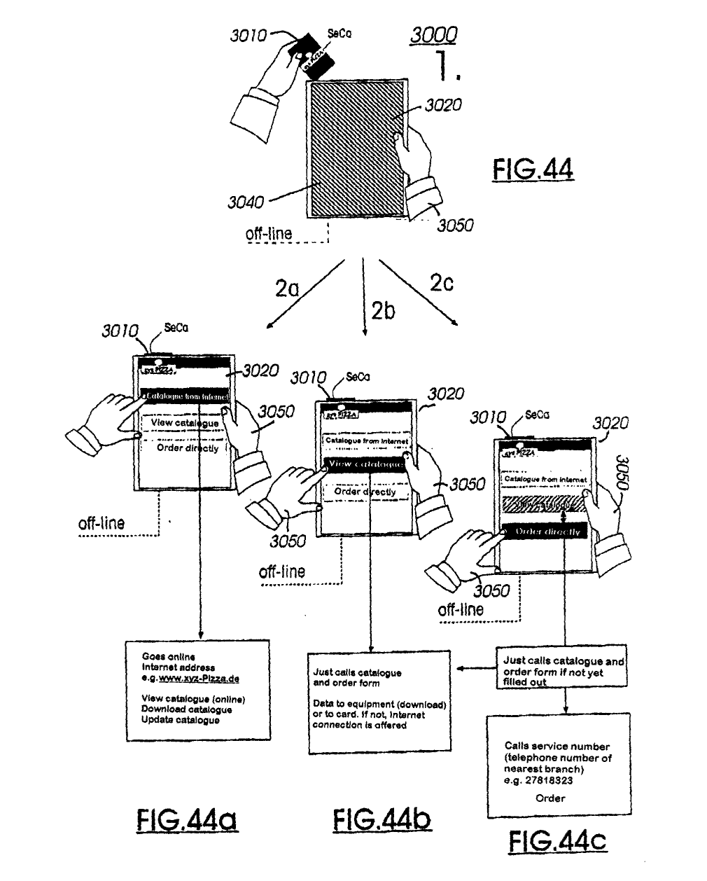

FIG. 44 shows a schematic view of a data processing device according to the invention for selecting and ordering material goods,

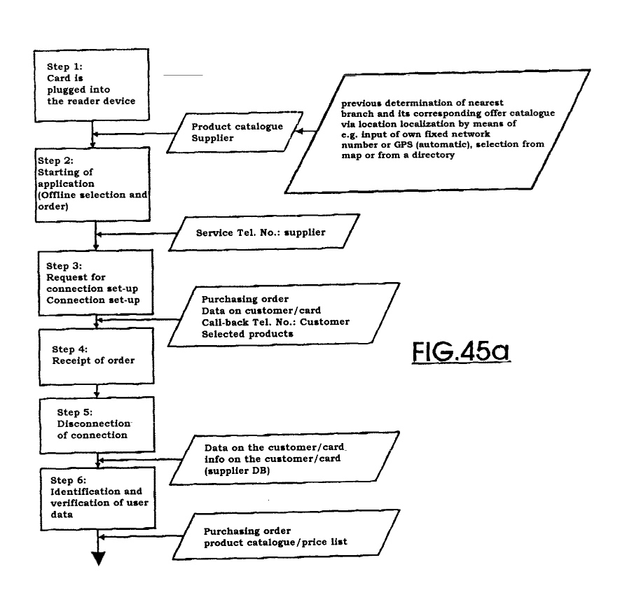

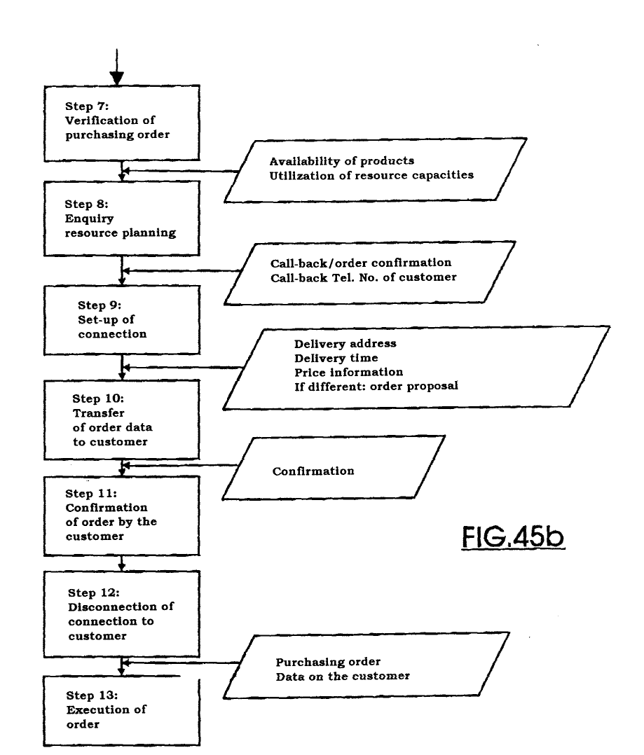

FIG. 45 shows a schematic view of a flowchart of a selection and ordering procedure with the data processing device illustrated in FIG. 44,

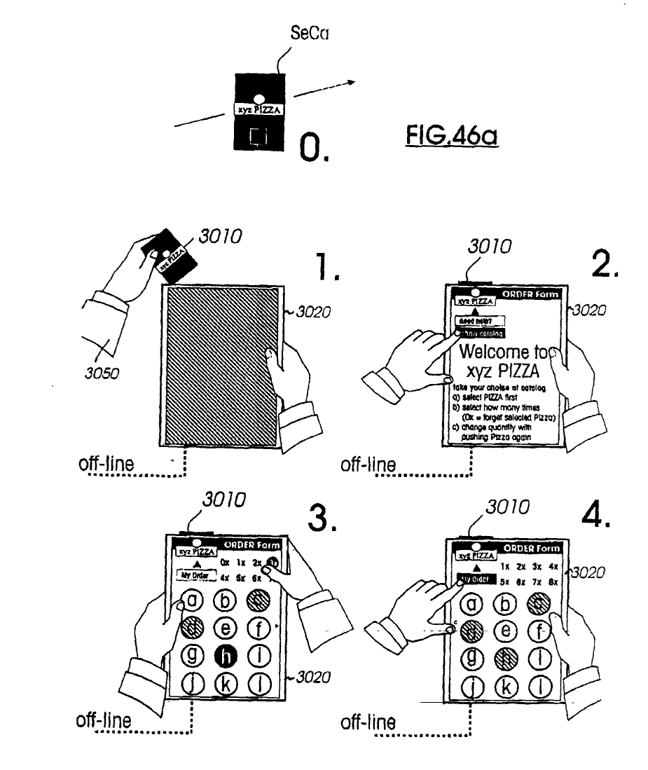

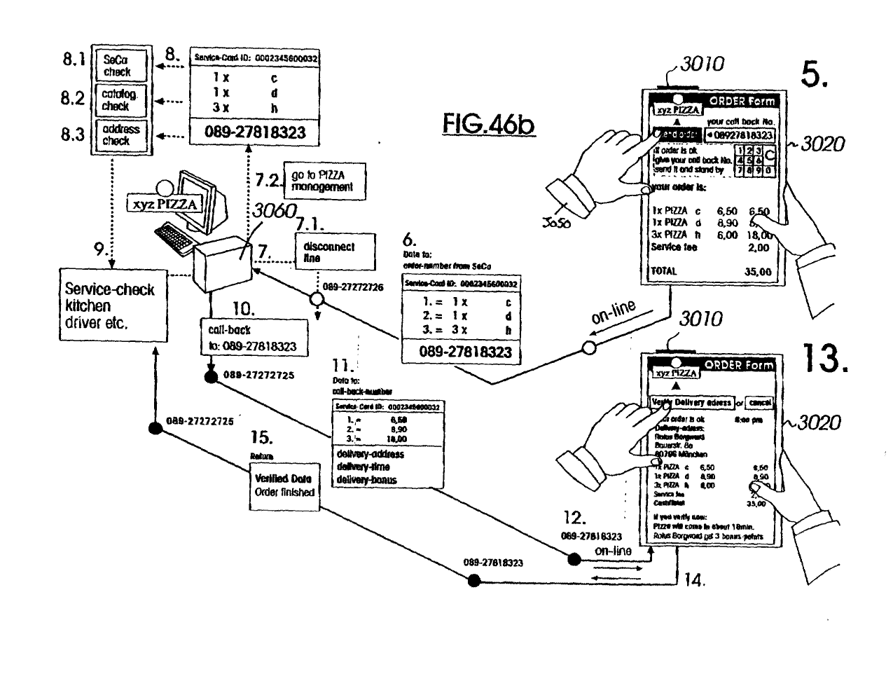

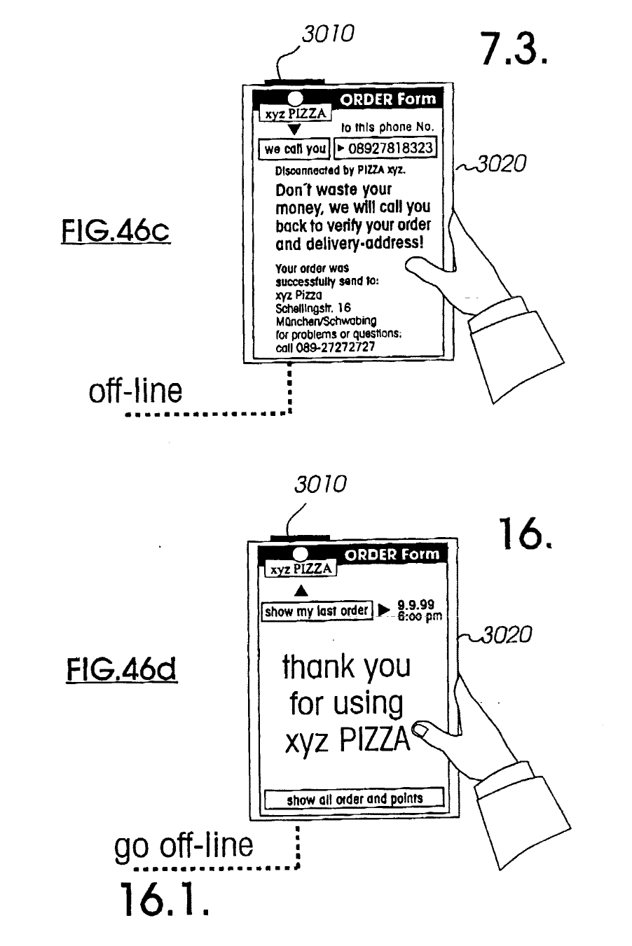

FIG. 46 shows a schematic view of a sequence in accordance with the flowchart from FIG. 45,

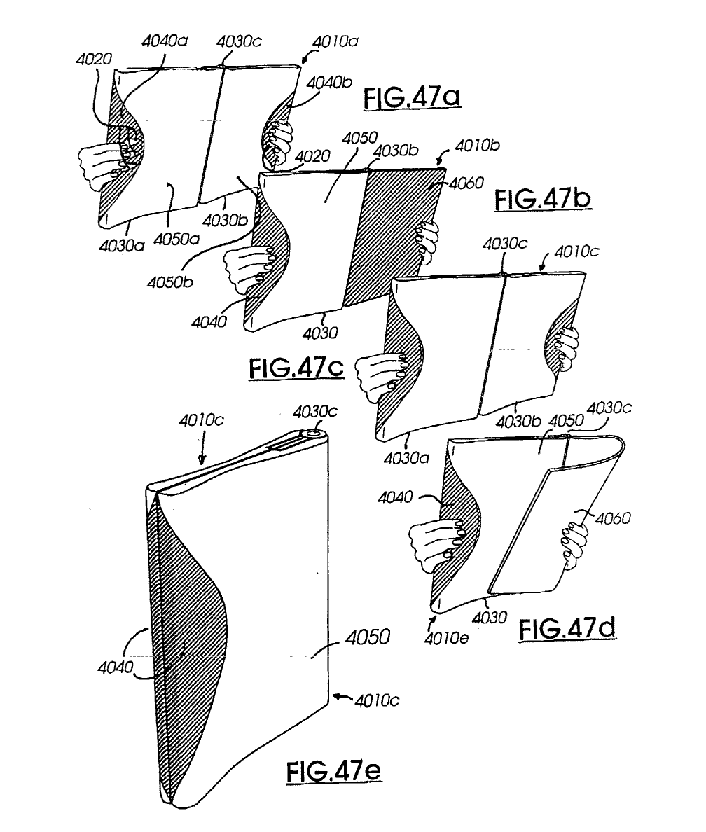

FIG. 47 shows, in the partial FIGS. 47a to 47e, the rear and/or external view of the housing of various variants of digital hand-held parts according to the invention,

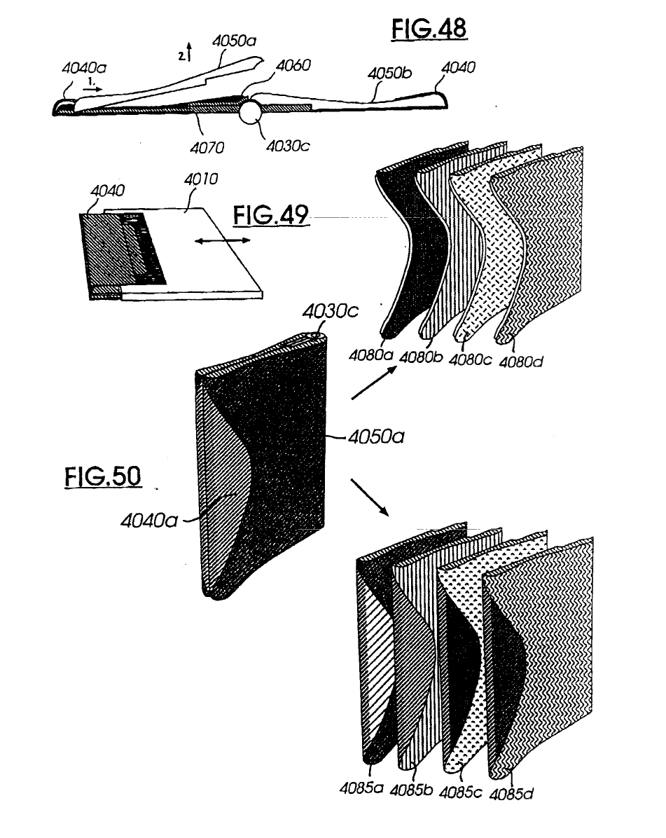

FIG. 48 shows a schematic cross-sectional view through a housing from FIG. 47c,

FIG. 49 shows a schematic view of a rear part of a housing,

FIG. 50 shows a schematic view of interchangeable components of a modular rear part of a housing,

FIG. 51 shows, in the partial FIGS. 51a to 51c, rear views of further variants of housings of digital hand-held parts according to the invention,

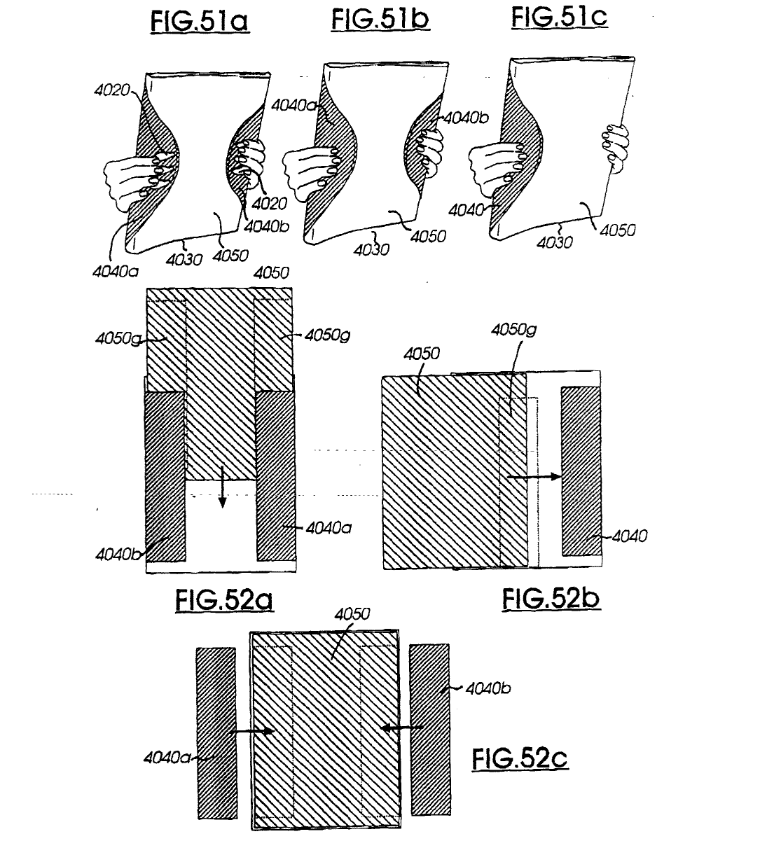

FIG. 52 shows a schematic view of the procedure of changing specific rear parts in the case of modular housing rears,

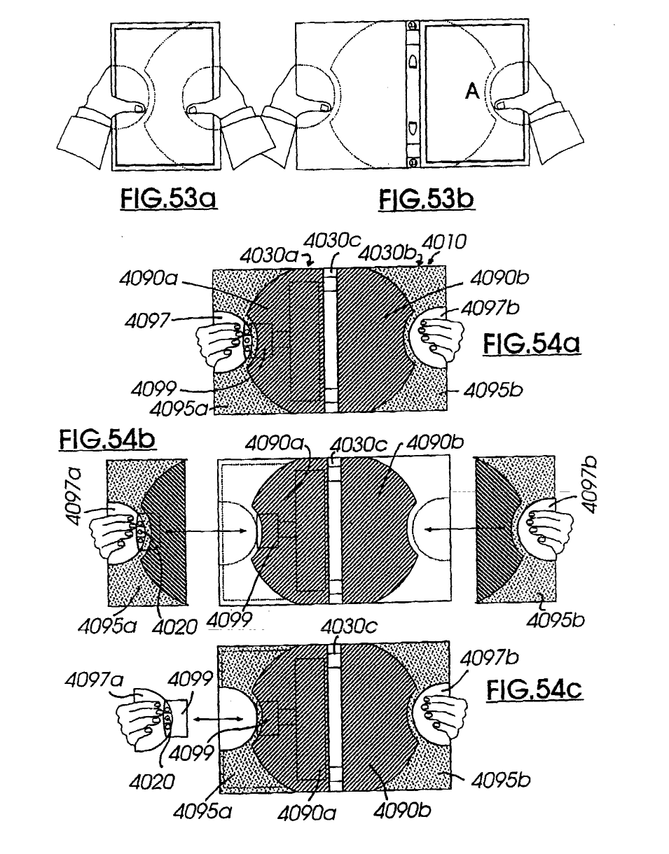

FIG. 53 shows, in the partial FIGS. 53a and 53b, schematic views of different function zones in the case of a modular housing of a single-wing or two-wing digital hand-held part according to the invention,

FIG. 54 shows, in the partial FIGS. 54a to 54c, various aspects of a modular housing of a digital hand-held part according to the invention.

FIG. 1 shows a schematic view of a networked data processing device according to the invention with a server part 110 and a client part 120. The server part 110 and the client part 120 are connected to one another via a telecommunications network 130, designated as a WAN (Wide Area Network), for example via the analogue telephone network, via the ISDN network, via the Internet or via a satellite link for the exchange of data. Typically, for the purpose of exchanging data via the WAN 130, the server part 110 and the client part 120 are each assigned a uniquely defined address or identifier 112, 122, for example a telephone number, an Internet address or the like. If the client part 120 wishes to set up a connection to the server part 110 via the WAN 130, it requires information on its address 112. Conversely, the server part 110 requires information on the address 122 of the client part 120.

The client part 120 is designed to accommodate a mobile card module 140. The card module 140 comprises at least one memory device for the non-volatile storage of data (not illustrated) and can exchange data with the client part 120 via a data communication device (not illustrated). The card module may be configured in particular as a chip card; however, other easily transportable designs are also possible. The basic properties of chip cards are disclosed, inter alia, in Wolfgang Rankl and Wolfgang Effing: “Handbuch der Chipkarten” [Chip Card Manual], Munich: Carl Hanser Verlag [Publishing House], 2nd Edition, 1996. The contents disclosed in this publication are included by reference in the present description.

The server part 120 is a computer which is typically assigned to a commercial supplier of goods and/or services. The server part 120 can be, for example, a computer which is coupled to the telephone network via modem or ISDN and which can be dialled up by the client part 120 via a dial line connection for the purpose of data communication. In another embodiment, the server part 120 is a “World Wide Web” Server (WWW server) which is connected to the Internet and which can communicate with the client part 120 by means of the “Hypertext Transport Protocol” (HTTP Protocol). In a further embodiment, the server part is embodied, for example, as a computer which is connected to the Internet and which can exchange electronic mail (e-mail) with the client part 120 by means of the “Simple Mail Transport Protocol” (SMTP) and by means of the “Post Office Protocol” (POP). The invention is not restricted to specific types of telecommunications networks or to specific protocols; the above information serves in this regard exclusively for the purposes of illustration.

FIG. 2 shows a schematic view of various aspects of the commercial use of a data processing device according to the invention. The interaction, according to the invention, between the card module 140 and the client part 120 permits the end user (not illustrated) who accesses the server part 110 via the client part 120 to process transactions in an advantageous fashion.
Aspect (1): Firstly, the card module 140 permits, by interaction with the client part 120, a system-independent set-up of the communications relationship with the server part 112, for example by means of a system-independent dialling-in procedure. For this purpose, access data, access configurations or access procedures are stored in the memory of the card module 140. This avoids the need for the end user to carry out a complex configuration of the access data, for example to an Internet access provider, to a server for electronic mail or to a server for processing electronic subscription service arrangements. In a preferred variant, the client part 120 may be configured with the card module 140 in such a way that the end user only has to plug the card module 140 into the client part 120 in order to initiate the set-up of a telecommunications connection to a server part 110. At the location where it is indicated, the initiation of the set-up of a telecommunications connection to the server part 110 can be made additionally dependent on the activation of an operator control element, in particular on the client part 120 and/or on the inputting of an item of security information, for example a PIN.
Aspect (2): The card module 140 permits, by interacting with the client part 120, the end user to be differentiated and/or identified with respect to the server part 110. Three cases are to be differentiated here: firstly, there may be cases in which it is not necessary or not desirable or legally not permitted to identify the end user by name, address etc., but nevertheless it is to be possible to differentiate various end users which each have separate card modules 140. This can be done, on the one hand, by means of a pure serialization of the card module 140, for example by means of a uniquely defined serial number which is written into a non-writable memory area of the card module 140 and which is never repeated, and if the end user successively uses various card modules 140 with different serial numbers it is not possible to deduce the identity of the end user without additional linking information. A third variant includes a pseudonymous identification of the end user over a number of card modules 140, which does not however permit the identity of the end user to be deduced without additional information. In the case of prepaid card modules 140, it is frequently possible to dispense with identification of the end user. If payment processing is provided by means of the submission of invoices, credit card, direct debiting etc., data are generally required for the complete identification of the end user. A pseudonym is always appropriate if the intended exchange of services and performances is to be processed without knowledge of the identity of the end user but taking into account the knowledge of which various card modules 140 are to be assigned to the same end user (see also in particular Aspect 7).
Aspect (3): The card module 140 also permits, by interacting with the client part 120, its authentication with respect to the server part 110, i.e. specific real-time properties of a card module 140 can be checked from the server part. Preferably known cryptographic methods can be used to do this. For example it is possible to store a secret cryptographic key, assigned to a specific end user, in a tamper-proof, non-volatile area of the memory (not illustrated) of the card module 140. The cryptographic key does not, however, need to be assigned to an end user in all cases; it is also possible to use the same techniques to differentiate card modules 140 which are put into circulation legitimately by an authorized manufacturer from card modules which have been simulated by non-authorized third parties.
Aspect (4): In addition, the card module 140 permits, by interacting with the client part 120, transactions which recur over time to be controlled with respect to the server part 110, in particular subscriptions for specific services.
Aspect (5): In addition, the card module 140 permits, by interacting with the client part 120, files, which are supplied by the service part 110 and which can represent, for example, software, texts and/or multimedia units, to be decrypted in a way which is associated with the card module. As a result, an effective technical protection of copyrights can be achieved.
Aspect (6): The card module 140 also permits, by interacting with the client part 120, files which are supplied by the server part 110 and which can represent, for example, multimedia units to be used in a way which is metered in accordance with the clock. As a result, technical infrastructure for calculating copyright payments as a function of the use time can be realized (see also in particular Aspect 7).
Aspect (7): The card module 140 also permits, by interacting with the client part 120, payment procedures relating to the server part 110 to be processed, for example by transmitting credit card numbers or digital units of value (“digital cash”). Here, various alternatives are to be differentiated: firstly, a card module 140 which is put into circulation can incorporate a predetermined, prepaid amount of credit which is represented by a corresponding predetermined data element which is stored in the memory (not illustrated) of the card module. On the other hand, the payment can be carried out on a person-related basis by submission of an invoice, credit card or direct debiting, the necessary information on the identity and the payment transaction data (account number, credit card number, billing address etc.), being stored in the memory (not illustrated) of the card module 140. In both cases it is advantageous to protect the authenticity of the card module 140 and of the data elements stored in its memory with a digital signature generated by the authorized issuing party. Independently of the above differentiation between prepaid credit and periodic billing, there is an alternative between acquisition of files in accordance with the principle of purchase, i.e. after a single payment of a purchase price there is a possibility of use for an unrestricted time, and billing according to the intensity of use, preferably measured with respect to the time for which the service is used or with respect to the actually used volume of data of a file. Finally, there is a further independent alternative between card modules 140 which are already provided with all the necessary billing-related data elements at the time at which they are put into circulation, and card modules 140 in which the billing-related data elements are not transmitted from the server part 110 to the memory (not illustrated) of the card module 140 until said card modules 140 are sent to the end user. The eight individual cases which arise from the combination of these three alternatives each require a specific technical configuration of the card module and its interaction within the framework of the solution according to the invention.
Aspect (8): If the card module 140 is equipped with sufficient memory capacity, for example in the form of what are referred to as flash memories, files, which represent, for example, programs for data processing systems, texts or multimedia units, can be stored temporarily or permanently in the card module. This improves, in particular, the technical implementation of systems, already mentioned in Aspect (4), for automatically periodically acquiring files which represent software, text and/or multimedia units and are distributed by the server part 110.
Aspect (9): Finally, the card module 140 can be used, by interacting with the client part 120, for telemetrically enabling or disabling specific functionalities by means of the server part 110.

In a data processing device according to the invention, all the aspects do not need to be implemented simultaneously.

The exemplary embodiments described below and their variants make use, to a certain extent, of specific cryptographic techniques such as asymmetrical cryptography and digital signatures, for example. An introduction to applied cryptography can be found, for example, in: Bruce Schneier: “Applied Cryptography”, New York: John Wiley & Sons., Inc., 1994. The contents disclosed in this publication are incorporated by reference into the present description.

FIG. 3 shows a first application of the invention by means of a schematic view of a data processing device according to the invention. As already illustrated in FIG. 1, a client part 120 is connected to a server part 110 via a WAN 130. The client part 120 is provided with a display device 125 which is illustrated only schematically. The card module 140, which is accommodated in the client part, identifies in a personal or pseudonymous way, a specific end user (not illustrated) to which the card module 140 is assigned. In particular an item of identity information 141, which can be transmitted to the server part 110 via the WAN 130, is stored in the card module 140. The identity information 141 can be additionally protected at the client part 120 and in a customary fashion, for example by means of a PIN or by means of biometric identity detection devices (not illustrated). In addition to the card module 140, there may be other card modules 140a, 140b, 140c which are each assigned to the identities SN1, SN2 and SN3, respectively. If the card module 140 which is associated with the identity SN4 141 is replaced with one of the other card modules 140a, 140b, 140c, the respective assigned identity information SN1, SN2 and SN3, respectively, can be transmitted to the server part 110. The first application of the invention illustrated in FIG. 3 is significant especially if it is to be possible to at least to distinguish a trading subject, for example in terms of its property as a party to a contract with respect to the server part 110, or else to be able to identify said trading subject directly or by means of a pseudonym.

FIG. 4 shows a second application of the invention by means of a schematic view of a data processing device according to the invention. As already illustrated in FIG. 1, a client part 120 is connected via a WAN 130 to a server part 110. The client part 120 is provided with a display device 125 which is illustrated only schematically. The card module 140, which is accommodated in the client part, can identify, in particular by means of a predetermined data element, a specific contractual relationship Subsc 141, which in the present example includes the regular supply (subscription) of a digital multimedia product. In addition to the card module 140, there may be other card modules 140a, 140b, 140c which are each assigned to the contractual relationships SubA, SubB and SubC (141a, 141b, 141c), respectively. If the card module 140 which is associated with the contractual relationship 141 is replaced with one of the other card modules 140a, 140b, 140c, the respectively assigned contractual relationship information 141a, 141b, 141c can be transmitted to the server part 110. The respective contractual relationship information 141, 141a, 141b, 141c is a characteristic variable which controls an automatic selection procedure with respect to the file (not illustrated) which is to be transmitted to the client part 120 by the server part 110 and which represents a multimedia display, as well as being controlled in terms of the transmission time.

FIG. 5 shows a fourth application of the invention by means of a schematic view of a data processing device according to the invention. As already illustrated in FIG. 1, a client part 120 is connected via a WAN 130 to a server part 110. The client part 120 is provided with a display device 125 which is illustrated only schematically. The card module 140, which is accommodated in a client part, identifies, in particular, a specific server part 110 which can be assigned, for example, to an associated, specific service provider SPr4. In addition to the card module 140, there may be other card modules 140a, 140b, 140c which are each assigned to the service providers SPr1, SPr2 and SPr3 (141a, 141b, 141c), respectively. If the card module 140 which is associated with the service provider 141 is replaced with one of the other card modules 140a, 140b, 140c, the respective assigned service provider information 141a, 141b and 141c, respectively, can be transmitted to the server part 110. The respective service provider information 141, 141a, 141b, 141c is a characteristic variable which brings about, in particular, an automatic selection procedure with respect to the data transmission parameters of the client part 120 so that automatic initiation of an exchange of data between the client part 120 and the server part 110 is made possible.

FIG. 6 shows a first variant of an embodiment of the solution according to the invention as illustrated in FIG. 1. As already illustrated in FIG. 1, a client part 120 which is designed to accommodate a card module 140 is connected via a WAN 130 to a server part 110. The client part 120 is provided with a display device 125 which is illustrated only schematically. FIG. 6 thus shows a solution in which the client part 120, which is designed to accommodate a card module 140, and the display device 125 form a unit which is mechanically embodied as an essentially one-piece unit.

FIG. 7 shows a second variant of an embodiment of the solution according to the invention illustrated in FIG. 1. As already illustrated in FIG. 1, a client part 120 which is designed to accommodate a card module 140 is provided. The client part 120 is coupled via a data communication device 123 to a display device 125 (illustrated only schematically) which is connected via a WAN 130 to a server part 110. FIG. 7 thus shows a solution in which, on the one hand, the client part 120 which is designed to accommodate a card module 140 and, on the other hand, the display device 125 which is connected to the WAN 130 each form in themselves a unit which is embodied mechanically as an essentially one-piece unit, the exchange of data between the client part 120 and the display part 125 being carried out by means of the data communications device 123. Possible ways of technically implementing the data communications device comprise wire-free and wire-bound devices and methods, in particular via data transmission cables (not illustrated), by radio (not illustrated) or by infrared, for example IRDA (not illustrated).

FIG. 8 shows a third variant of an embodiment of the solution according to the invention illustrated in FIG. 1. As already illustrated in FIG. 1, a client part 120 which is designed to accommodate a card module 140 and which is connected via a WAN 130 to a server part 110 is provided. The client part 120 is coupled via a data communications device 123 to a display device 125 which is indicated only schematically. FIG. 8 thus shows a solution in which, on the one hand, the client part 120 which is designed to accommodate a card module 140 and is connected to the WAN 130, and the display device 125, on the other hand, each form in themselves a unit which is embodied mechanically as an essentially one-piece unit, the exchange of data between the client part 120 and the display part 125 being carried out by means of the data communications device 123. Possible ways of technically implementing the data communications device are wire-free and wire-bound devices and methods, in particular via data transmission cables (not illustrated), by radio (not illustrated) or by infrared, for example IRDA (not illustrated).

FIG. 9 shows a fourth variant of an embodiment of the solution according to the invention illustrated in FIG. 1. As already illustrated in FIG. 1, a client part 120 which is designed to accommodate at least one card module 140 and which is connected via a WAN 130 to a server part 110 is provided. Apart from the client part 120, there is an only schematically illustrated display device 125 which is also designed to accommodate at least one card module 140. FIG. 9 thus shows a solution in which, on the one hand, the client part 120 which is designed to accommodate a card module 140 and is connected to the WAN 130, and, on the other hand, the display device 125 each form in themselves a unit which can be embodied mechanically as an essentially one-piece unit, the exchange of data being carried out between the client part 120 and the display part 125 by reconfiguring the plug connections of the card module 140. For example, the card module 140 can be accommodated in the client part 120 in order to store data supplied by the server part 110. After the respective data has been stored in the card module 140, this data can be made visible by reconfiguring the plug connections of the card module into the display device. Conversely, it is also possible to store, for example data relating to purchase order procedures, in the card module 140 if it has been accommodated in the display device 125. After the reconfiguration of the plug connections of the card module 140 into the client part 120, this purchase order data can be fed to the server part 110 via the WAN 130.

FIG. 10 shows a fifth variant of an embodiment of the solution according to the invention illustrated in FIG. 1. As already illustrated in FIG. 1, a client part 120 which is designed to accommodate a card module 140 is provided. The client part 120 is coupled via a data communications device 123 to a display device 125 which is illustrated only schematically and which is connected via a WAN 130 to a server part 110. FIG. 10 thus shows a solution in which, on the one hand, the client part 120 which is designed to accommodate a card module 140, and, on the other hand, the display device 125 which is connected to the WAN 130 each form in themselves a unit which is embodied mechanically as an essentially one-piece unit, the exchange of data between the client part 120 and the display part 125 being carried out by means of the data communications device 123. Possible ways of technically implementing the data communications device are wire-free and wire-bound devices and methods, in particular via data transmission cables (not illustrated), by radio (not illustrated) or by infrared, for example IRDA (not illustrated).

The client part 120 illustrated in FIG. 10 is designed to accommodate a multiplicity of card modules 140a-140e, which can each independently initiate and control communications procedures with the server part 110 by means of the card module data (not illustrated) stored on them, and which can be addressed independently of one another from the point of view of the server part 110 during communications procedures initiated by the server part 110. For example, at least one of the card modules 140a-140e can act as a component of a system illustrated in FIG. 4, i.e. a card module or a plurality of card modules serve as a memory for digital multimedia products which are supplied digitally by the server part 110 via the WAN 130 on a regular basis, but asynchronously with respect to operator control actions of the user.

The particular feature of the arrangement illustrated in FIG. 10 with respect to the arrangement illustrated in FIG. 7 is in particular the fact that a master card module 140 is provided with which the display device 125 can identify and authenticate itself in a particular way with respect to the client part 120 or the other card modules 140a-140e which are inserted therein. For example, the master card module 140 can be inserted into a digital book which is used as a display device 125. By means of the master card module 140, the digital book is then set up in such a way that specific privileged operator control procedures can be performed by the user with respect to the client part or the further card modules 140a-140e inserted therein, via the data communications device 123, said privileged operator control procedures being, for example, the enabling or disabling of the client part 120 for deliveries by the server part 110 or the performance of purchase order procedures with respect to the server part 110. For this purpose, data communication via the data communications device 123 is preferably protected against tapping and manipulation by suitable techniques, in particular cryptographic techniques.

FIG. 11 shows a sixth variant of an embodiment of the solution according to the invention illustrated in FIG. 1. As already illustrated in FIG. 1, a client part 120 which is designed to accommodate a card module 140 and which is connected via a WAN 130 to a server part 110 is provided. The client part 120 is coupled via a data communications device 123 to a display device 125 which is illustrated only schematically. FIG. 11 thus also shows a solution in which, on the one hand, the client part 120 which is designed to accommodate at least one card module 140, and, on the other hand, the display device 125 which is connected to the WAN 130 each form in themselves a unit which is embodied mechanically as an essentially one-piece unit, the exchange of data between the client part 120 and the display part 125 being carried out by means of the data communications device 123. The particular feature of the arrangement illustrated in FIG. 11 in comparison with the arrangement illustrated in FIG. 7 consists, in particular, in the fact that the client part 120 is designed, as also in the case illustrated in FIG. 11, to accommodate a multiplicity of card modules 140a-140e, which can each independently initiate and control communications procedures with the server part 110 by means of the card module data (not illustrated) stored on them and which can be independently addressed from the point of the view of the server part 110 during communications procedures initiated by the server part 110. For example, at least one of the card modules 140a-140e can act as a component of a system illustrated in FIG. 4, i.e. a card module or a plurality of card modules serve as a memory for digital multimedia products which are supplied digitally by the server part 110 via the WAN 130 on a regular basis but asynchronously with respect to operator control actions of the user.

In the variant illustrated in FIG. 11, it proves particularly advantageous to implement the client part 120 as a stationary card module station which is essentially continuously connected to the WAN 130 and can thus always initiate data communications procedures with respect to the server part 110, and moreover can receive, asynchronously with respect to operator control actions of the user, data communications procedures which are initiated by the server part 110, reception being possible even if the display device 125 is embodied as a mobile unit which the user carries on him even when he is absent from his station.

Both with respect to the variant illustrated in FIG. 10 and with respect to the variant illustrated in FIG. 11 it may prove advantageous to design the display device 125 to accommodate at least one card module 140 so that by reconfiguration of the plug connections of a card module the mode of use illustrated in FIG. 9 can be employed.

Whereas the client part 120 is designed to accommodate at least one card module 140 in the variant illustrated in FIGS. 6 to 11, FIGS. 12 and 13 each show a variant in which a client part 120 without its own card module is used. FIG. 13 shows a client part 120 which is designed to accommodate a complete display device 125, the display device 125 being again designed to accommodate at least one card module 140. Data communication between the server part 110 and the card module 140 is processed in such a way that the exchanged data is passed through the display device 125 by means of suitable electronic provisions. Of course, it is not absolutely necessary for the client part 120 to be designed to accommodate a complete display device 125. The exchange of data between the client part 120, on the one hand, and, on the other hand, the display device 125 which is set up to accommodate at least one card module 140 can also be implemented, for example, by means of a data communications device 123 as illustrated in FIG. 13. Possible ways of technically implementing the data communications device are wire-free and wire-bound devices and methods, in particular via data transmission cables (not illustrated), by radio (not illustrated) or by infrared, for example IRDA (not illustrated).

FIGS. 14 and 15 show further variants of an embodiment of the solution according to the invention illustrated in FIG. 1. As already illustrated in FIG. 1, a client part 120 which is designed to accommodate a card module 140 and which is connected via a WAN 130 to a server part 110 is also provided in FIG. 14. A display device 125 is also connected to the WAN 130a. The WAN 130 can be identical to the WAN 130a. An interaction with the server part 110 which is triggered by means of the display device 125 and is transmitted via the WAN 130a, leads to multimedia data being transmitted from the server 110 to the client part 120 via the WAN 130. As a result, the user (not illustrated) can call up data, for example when travelling, from the server part 110, which data is transmitted via the WAN 130 to the client part 120 which is installed, for example, at home.

FIG. 15 shows a variant in which the client part 120 is provided with a display device 125. The data (not illustrated) called at the server part 110 is transmitted via the WAN 130 to a secondary client part 120a.

Each of the application modes of the invention illustrated in FIGS. 3 to 5 can basically be implemented with any of the variants illustrated in FIGS. 6 to 15.

FIG. 16 shows a schematic view of a first embodiment of the solution according to the invention. A digital book 510 is provided with a holding device (not illustrated) for a card module 140. A digital book of the type illustrated is disclosed, for example, in WO-A1-99/15982 and reference is expressly made to the content disclosed in this publication. By plugging in the card module 140, the digital book 510 is controlled by means of data stored on the card module 140.

In the case illustrated in FIG. 16, after the card module 140 has been plugged into the digital book 510, a catalogue which is stored, for example, in the card module 140 or is supplied by the server part 530 on the basis of linking information stored in the card module 140 requires various possible ways of displaying and of having print media or digital multimedia products sent to it regularly from a service provider 520. The user (not illustrated) then has the possibility of selecting an alternative, for example by actuating the touch screen of the digital book 510, and expressing his desire to be supplied in future on a regular basis in a predetermined fashion. Here, the user specifies all the necessary data relating to the intended transaction such as the type, scope, delivery path and payment modality.

The data describing the intended transaction is then transmitted via the WAN 130 to a server 530 of the service provider 520. For this purpose, the digital book 510 may be provided, for example, with an internal modem (not illustrated) which is connected via a connecting cable 540 to the public telephone network which functions as a WAN 130, the data being routed directly via telephone lines to the server 530. Alternatively, it may be advantageous to provide, via the connecting cable 540, a connection to the Internet, for example via an intermediately connected Access Provider (not illustrated), the server 530 then also having to have a connection to the Internet. Other data communications paths are also suitable; for example, the digital book 510 can be coupled to a mobile telephone, via the connecting cable 540 or via an IRDA connection, instead of the telephone fixed network.

After the data describing the intended transaction has been transmitted via the WAN 130 to the server 530 of the service provider 520, an acknowledgement with confirmation data from the server 530 may be provided on the same path or on another path. This exchange of data can be repeated as a function of the technical and legal conditions until the completed exchange of data represents a completed conclusion of a transaction.

After the conclusion of this transaction conclusion phase, the connection between the digital book 510 and the server 530 can be disconnected.

Of course, the transaction conclusion phase described above can also be used to arrange for the regular delivery of physical printed products and/or sound and video carriers 550 to a postal address by a supplier 560, which does not need to be identical to the service provider.

Because the contents of print media and of sound and video carriers can always be digitized, it is therefore considered advantageous to supply the subject-matters of the transaction conclusion, for example, in the form of files representing software, texts or multimedia units etc., by data transmission.

Because the units are generally copyright-protected and are usually transmitted in the form of digital data, which can thus be copied without loss, it may be advantageous to encrypt the data corresponding to the data processing programs, texts or multimedia units etc. to be transmitted so that an unlawful copying procedure cannot as such initially produce a usable unlawful copied item in order to permit the user to access the decryption key, necessary for decryption, in a way that ensures the user is impeded, by technical and/or legal framework conditions, from producing undesired copied items, and if appropriate also impeded from disseminating them. The decryption procedure which is accessible only by the lawful user is performed after the multimedia data 580 which represents the unit to be supplied has been transmitted via a WAN 130a (which can be, but does not need to be, identical to the WAN 130 used for the purchase order procedure).

A technical aspect of the agreed regular delivery (“subscription service”) of data processing programs, texts or multimedia data is that the initiative for the transmission of a specific file which is to be provided for distribution at a given time should not necessarily be the user's (“Pull”) in all cases, but should at least optionally also be the server's 530 (“Push”).

In a “Pull” solution, the user is prompted frequently to make contact, on his own initiative, with the server 530 in order to check whether new multimedia data is present for calling within the framework of the subscription service, and experience has shown this to lead to a multiplicity of futile interrogations, which are, on the one hand, extremely burdensome for the user and, on the other hand, give rise to telecommunications costs. This could be avoided if the release times of the due multimedia data which are to be supplied on a regular basis were predetermined extremely precisely in advance. However, this would considerably restrict the flexibility on the part of the service provider 520 and would moreover be virtually impracticable because, in practice, unavoidable operational faults on the part of the service provider 520 could give rise to delays, which would in turn inevitably entail a large number of unsuccessful interrogation attempts. An effective improvement would be possible if the technical system structure of the [lacuna] for supplying the due multimedia data were suitable for a completely asynchronous delivery of the data, i.e. the user does not know the precise delivery time, and does not need to know it either.

It is to be noted that the “channels” which are referred to as the “Push” concept for delivery of data via the Internet also have a “Pull” component because although contents are not assembled by the user, the latter must still himself actively ensure, by switching on the PC and starting suitable channel client program (for example suitable browsers), that the multimedia data is delivered.

In the solution according to the invention, a complete “Push” delivery of the multimedia data due for delivery is possible. For this purpose, there is provision for the user to keep a data processing system or part of a data processing system always connected to a suitable WAN 130, for example the telephone network, in order to be able to receive and store deliveries of multimedia data which are initiated by the server 530 essentially at any time. The multimedia data which is stored in this way can then be consumed, for example, by means of the digital book 510.

In addition to the explained “Push” mode, further variants are possible. For example, in applications it may also be appropriate to provide possible ways of enabling the user to influence the calling process itself. Firstly, the user can then set up a connection to the server 530 via the WAN 130, activate a suitable operator control element (not illustrated) and as a result cause the server 530 to deliver the desired file (“on-demand delivery”) via the existing communications channel which has been set up from the client part 120. A variant of the “on-demand delivery” is then for the user firstly, as is customary, to set up a connection to the server 530, transfer a data element displaying a delivery request by activating an operator control element and then to abort the connection to the server 530. The transmission of the desired file is then carried out at a later time by means of a communications channel which is set up from the server 530. Finally, a “broadcast” variant is possible in which the server attempts to transmit a file to a multiplicity of client parts 120. This can be implemented easily in particular in radio-based systems. It is then up to each individual client part 120 actually to store, or else ignore, a file transmitted to all the client parts 120, as a function of the effective presettings, in particular as a function of the data stored in the card module 140.

From the point of view of the user, a delivery of a desired file can be initiated by the push method or in the broadcast mode, for example by plugging a correspondingly preset card module 140 into the client part 120. The system then waits until the transmission by individual addressing, i.e. Push, or to all the addresses, i.e. broadcast, by the server 530 has been terminated. In the case of on-demand calling with or without call-back by the server 530 it is necessary for the user firstly to communicate his delivery request to the server 530 via the client part 120 and then to allow for the transmission of the desired file directly or at a later time. In this alternative, the call can also be associated with the input of a PIN or the like in order to protect the authorization.

In the exemplary embodiment illustrated in FIG. 16, the following alternatives relating to the delivery of the file 580 representing a data processing program, a text or a multimedia unit are represented:
a) the multimedia data which is supplied by the server 530 can be fed to a book station 610.
b) The multimedia data which is supplied by the server 530 can be fed to a card station 620 and stored in individual card modules 140 which are plugged into it.
c) The multimedia data which is supplied by the server 530 can be fed to a card station 620 and stored in a memory (not illustrated) which is permanently installed in the card station 620 itself.
d) The multimedia data which is supplied by the server 530 can be fed to the digital book 510 and stored in individual card modules 140 which are plugged into it.
e) The multimedia data which is supplied by the server 530 can be fed to the digital book 510 and stored in a memory (not illustrated) which is permanently installed therein.
f) The multimedia data which is supplied by the server 530 can be fed to a wearable computer 630 and stored in individual card modules 140 plugged therein.
g) The multimedia data which is supplied by the server 530 can be fed to a wearable computer 630 and stored in a memory (not illustrated) which is permanently installed therein.

Above and beyond the alternatives illustrated, further variants are also possible, for example transmission of the file 580 to a conventional PC, to a notebook or to a palmtop (none of these are illustrated).

FIG. 17 shows a schematic view of details of a variant of the first embodiment of the solution according to the invention from FIG. 16 with the card station 620. After the multimedia data (not illustrated) due for delivery by the service provider 520 has been transmitted from the server 530 to the card station 620 via the WAN 130, it is necessary to provide technical means in order to be able to permit the multimedia units corresponding to this data to be consumed by the user (not illustrated). For this purpose, a plurality of corresponding variants are illustrated by way of example in FIG. 17:
a) the multimedia data which is transmitted by the server 530 via the WAN 130 is stored in a predetermined card module 140a which is plugged into the card station 620. After the transmission procedure has been terminated, the user removes the card module 140a from the card station 620 at any desired time and inserts it into the digital book 510a where the multimedia data from the card module can be displayed or played back.
b) The multimedia data transmitted by the server 530 via the WAN 130 is stored in a memory (not illustrated) which is permanently installed in the card station 620 or in a predetermined card module 140a which is plugged into the card station 620. After the transmission procedure has been terminated, the stored multimedia data is transmitted to the digital book 510b via a wire-free data communications connection (radio, IRDA or the like) 540c at any desired time at the initiative of the user and stored in said digital book 510b where the multimedia data from the card module can be displayed or played back.
c) The multimedia data which is transmitted by the server 530 via the WAN 130 is stored in a memory (not illustrated) which is permanently installed in the card station 620 or in a predetermined card module 140a which is plugged into the card station 620. After the transmission procedure has been terminated, the stored multimedia data is transmitted to the digital book 510b via a wire-bound data communications connection (LAN) 540b at any desired time at the initiative of the user and stored in said digital book 510b where the multimedia data from the card module can be displayed or played back.
d) The multimedia data which is transmitted by the server 530 via the WAN 130 is stored in a memory (not illustrated) which is permanently installed in the card station 620 or in a predetermined card module 140a which is plugged into the card station 620. After the transmission procedure has been terminated, the stored multimedia data is transmitted to the digital book 510b via a WAN 130a which is identical to the WAN 130, or else can be different, at any desired time at the initiative of the user and stored in said digital book 510b where the multimedia data from the card module can be displayed or played back. The purpose for this arrangement is to permit the user to use the data stored in the card station at any time, even when travelling.

FIG. 18 shows schematic views of details of a further variant of the first embodiment of the solution according to the invention from FIG. 16 with the book station 610. In order to greatly reduce the technical expenditure on a card station 620, it is possible to provide a book station 610 instead of the card station 620. The digital book 510 is inserted into the book station 610. The book station 610 is coupled to the digital book 510 via a data communications device (not illustrated), it being possible to access the card module 140 inserted into the digital book 510 by means of the data signals from the book station 610 through the digital book 510. In order to control the data traffic, at least either the book station 610 or the digital book has a control device (not illustrated); in a preferred variant, each contains a control device. In addition, the book station 610 has a connection to the WAN 130. In a particularly preferred embodiment variant, the digital book 510 is also supplied with current by the book station when it is in the inserted state.

If the predetermined card module 140 is inserted into the digital book 510 and also the digital book 510 is installed in the book station 610 together with the card module 140, the server 530 can access the card module 140 via the WAN 130, via the book station 610 and via the digital book 510, and store multimedia data (not illustrated) in said card module 140.

The variant illustrated in FIG. 18 can be used appropriately especially if the additional expenditure on a card station 620 is to be avoided and if the digital book 510 is not being used for other purposes by the user during sufficiently dimensioned periods of time, so that it can be positioned in the book station 610 and connected to the WAN 130 via it. For example, there could be an agreement with the service provider 520 to perform data transmission procedures initiated by the server 530 only at night so that the user can use the digital book 510 for other purposes during the day and at night said digital book 510 regularly keeps said digital book 510 in the book station in order to receive multimedia data transmitted by the server 530. The card module 140 authenticates the service provider by means of predetermined data elements stored therein. If neutral card modules 140 are issued to the user without these predetermined data elements, then a provision can be made for the data elements to be subsequently installed by the user by means of an electronic book or a notebook etc., for example by specifying individual service providers with which commercial relations are to be possible.

FIG. 19 shows a schematic view of details of a further variant of the first embodiment of the solution according to the invention from FIG. 16 with the wearable computer 630. Although mobile computers such as notebooks or palmtops are easily transportable and have overcome a large number of restrictions associated with the operation of stationary computers, there is a need for computers which can be used in an uncomplicated way and are mobile. The term “wearable” computer is understood to refer to units which can be integrated, for example, into clothing or attached thereto so that there is no need for an installation surface on a table or the like. Conventional concepts for inputting and outputting data on the basis of a keypad and conventional display technology can generally not be used in this category of equipment.

FIG. 19 shows by way of example a wearable computer 630 which can be worn for example on a clothing belt. The wearable computer 630 does not have its own display which would be suitable for displaying a relatively large coherent region of a document; instead, a cable 635 is provided via which an external display (not illustrated) can be connected. In order to facilitate control by an operator, the wearable computer 630 can be provided with (a small number of) operator control elements 640 and a small auxiliary display 645. In particular, the wearable computer 630 may be designed to accommodate a card module 140.

After the multimedia data (not illustrated) which is due for delivery by the service provider 520 has been transmitted from the server 530 to the wearable computer 630 via the WAN 130, it is necessary to provide technical means to permit the user (not illustrated) to consume the multimedia units corresponding to this data:
a) the multimedia data which is transmitted by the server 530 via the WAN 130 is stored in a predetermined card module 140a which is plugged into the wearable computer 630. After the transmission procedure has been terminated, the user removes the card module 140a from the wearable computer 630 at any desired time and inserts it into the digital book (not illustrated) where the multimedia data from the card module can be displayed or played back.
b) The multimedia data which is transmitted by the server 530 via the WAN 130 is stored in a memory (not illustrated) which is permanently installed in the wearable computer 630 or in a card module 140 which is plugged into the wearable computer 630. After the transmission procedure has been terminated, the stored multimedia data is transmitted to the digital book 510a or 510b via a wire-bound data communications device 635 or via a wire-free data communications device (radio, IRDA or the like) 639 at any desired time at the initiative of the user, and stored in said digital book 510a or 510b where the multimedia data from the card module can be displayed or played back.
c) The multimedia data which is transmitted by the server 530 via the WAN 130 is stored in a memory (not illustrated) which is permanently installed in the wearable computer 630 or in a card module 140 which is plugged into the wearable computer 630. After the transmission procedure has been terminated, the stored multimedia data is transmitted to the digital book 510a via a WAN 130a, which can be identical to the WAN 130, or different, at any desired time at the initiative of the user, and stored in said digital book 510a where the multimedia data from the card module 140 can be displayed or played back. This arrangement has the purpose of allowing the user to use the data stored in the wearable computer 630 at any time, even on journeys.

FIG. 20 shows a schematic view of a second embodiment of the solution according to the invention. Here, an action terminal 810 which is installed in the public space within a building or on the outside is provided, said action terminal 810 typically having at eye level a display device 820 which is embodied as a touch-sensitive display.

The actual terminal 810 may be configured in such a way that a catalogue of multimedia units which can be acquired directly is illustrated on the display device 820. If the action terminal is provided with a card module magazine (not illustrated), after the purchase request has been input, for example by means of the touch-sensitive screen and after payment has been made, for example by chip card (not illustrated) a card module 140 can be removed from the card magazine, provided with the file representing the requested multimedia unit and output via an output slot 830.

Another variant of this embodiment provides for the card module 140 to be provided with a specific suitable cryptographic key, instead of a file representing a data processing program, a text unit or multimedia unit, with which key the file which is otherwise transmitted in encrypted form can be decrypted again. This procedure has the advantage that card modules 140 with relatively little storage capacity, for example conventional chip cards, can be used.

In so far as the available memory space of the card module 140 permits, a plurality of cryptographic keys can also be stored in the memory of the card module 140.

On the other hand, a card-module reading station 830, into which a card module 140 which is already in the user's possession, is plugged in, can also be provided. After the file representing the desired data processing program, text unit or multimedia unit, or else only a specific suitable cryptographic key with which the file which is otherwise transmitted in encrypted form can be decrypted again has been copied, the card module 830 is removed again.

The multimedia unit can then be consumed by the user by plugging the card module 140 into the digital book 510a.

The purchase ordering and delivery procedure can also be performed by means of a digital book 510b connected to the action terminal 810 via a cable 840.

The action terminal 810 can have a local mass storage means, for example a hard disk (not illustrated) on which the multimedia units which are offered for sale are kept available in the form of digital data. When the action terminal 810 is connected to a telecommunications network, further forms of delivery can be implemented.

The purchase ordering data can be transferred, in particular via the WAN 130a, to the server 530 of the service provider 520 from where the transmission of the files representing the multimedia units is controlled.

The decryption procedure which is available only to the lawful user is performed after the transmission of the multimedia data 580 representing the unit to be delivered, via a WAN 130a (which can be, but does not need to be, identical to the WAN 130 used for the purchasing-ordering procedure).

If the action terminal 810 has a local mass storage means (not illustrated) and a WAN connection 130c, the delivery procedure for the file 580 can also be carried out directly from the action terminal.

The transmission of files from the server 530 to the action terminal 810 can also be made possible via a WAN 130b.

The WAN 130a, the WAN 130b and the WAN 130c can be identical or different.

In the exemplary embodiment illustrated in FIG. 20, the following alternatives relating to the “Push” delivery of the file 580 are illustrated:
a) the multimedia data which is supplied by the server 530 can be fed to a book station 610.
b) The multimedia data which is supplied by the server 530 can be fed to a card station 620 and stored in individual card modules 140 which are plugged into it.
c) The multimedia data which is supplied by the server 530 can be fed to a card station 620 and stored in a memory (not illustrated) which is permanently installed in the card station 620 itself.
f) The multimedia data which is supplied by the server 530 can be fed to a wearable computer 630 and stored in individual card modules 140 which are plugged into it.
g) The multimedia data which is supplied by the server 530 can be fed to a wearable computer 630 and stored in a memory (not illustrated) which is permanently installed therein.

Further variants, for example with a conventional PC, a notebook or a palmtop, are possible.

FIG. 21 shows a further variant of the solution according to the invention. In particular, FIGS. 21a to 21f show an arrangement according to the invention in various phases during the processing of electronic mail, also referred to as e-mail, which has been selected as an example. Of course, the procedure shown can also be applied correspondingly when calling computer programs, texts or multimedia units from a service provider.

FIG. 21a shows a client part 120 and a card module 140 which is embodied in the form of a chip card. The client part 120 is provided with a plugged-in adapter part 121 which has a line 122 which is connected to a WAN 130, for example the telephone network.

FIG. 21b shows the arrangement from FIG. 21a after the card module 140 has been plugged into the client part 120. The plugging-in procedure automatically switches on and activates the client part 120 if the adapter part 121 is plugged in, which is indicated by a first indicator element 123a, for example an LED, i.e. the arrangement is ready to establish a connection via the line 122.

FIG. 21c shows the arrangement from FIG. 21b during the downloading of e-mail messages (not illustrated) stored on the server part 110 via the WAN 130 and the client part 120 to the card module 140. To do this, the data (not illustrated) stored in the data memory (not illustrated) of the card module 140 controls the dialling-in procedure to an e-mail server part 110 of an e-mail service provider via the WAN 130. The dialling-in procedure is preferably not started until the user (not illustrated) releases this procedure by activating an operator control element 124, for example an activation pushbutton key, provided for that purpose. The duration of the downloading is indicated for example by a flashing signal of a second indicator element 123b, for example an LED. The card module 140 is provided for this purpose with a sufficiently large data memory (not illustrated) which can be embodied, for example, as a flash memory.

FIG. 21d shows the arrangement from FIG. 21c during the downloading of e-mail messages which had been previously stored in the card module 140. The duration of the procedure of the downloading of e-mail messages is indicated for example by a flashing signal of the first indicator element 123a.

FIG. 21e shows the arrangement from FIG. 21d after the release of the data connection via the WAN 130 to the server part 110. The lighting-up of the first display element 123a indicates that the client part 120 is still switched on because both the card module 140 and the adapter part 121 are still plugged in.

FIG. 21f shows the arrangement from FIG. 21e after the adapter part 121 has been drawn out of the client part 120. The client part 120 is then switched off and the first display element 123a goes out, i.e. the client part 120 can also be conveniently transported in the switched-off state, even with the card module 140 inserted, if the adapter part 121 is pulled out because the adapter part 121 switches the power supply of the client part 120 on and off via a suitable switch device (not illustrated).

A modified variant of the solution according to the invention can be obtained by uploading e-mail messages to the server 110 by SMTP during the phase shown in FIG. 21c and downloading e-mail messages from the server 110 by POP3 during the phase shown in FIG. 21d, i.e. the sequence shown is interchanged.

FIG. 22 shows a further variant of the solution according to the invention which corresponds in its basic outline to the variant shown in FIG. 21. In particular, FIG. 22a to 22f show an arrangement according to the invention in exemplary form in various phases during the processing of electronic mail. In contrast to FIG. 21, the client part 120 is provided in the variant illustrated in FIG. 22 with a numerical keypad 124a and with a text display 123c.

As illustrated in FIG. 22b, it is thus possible, in particular, to make the set-up of a data connection from the client part 120 to the server part 110 dependent on the enabling of the user and access data stored in the card module 140 by inputting a PIN. As a result, the risk of misuse and of unauthorized downloading or uploading of e-mail messages can be significantly reduced. The display device 123c can display short texts which inform the user of the procedures which are currently under way.

The technical processing of the uploading and downloading of e-mail messages can be carried out on the basis of proven technical standards, for example SMTP for the uploading (mailing) of electronic messages and POP3 for the downloading (delivery) of electronic messages.

A modified variant of the solution according to the invention can be obtained in that e-mail messages are uploaded to the server 110 by SMTP during the phase shown in FIG. 22c, and e-mail messages are downloaded from the server 110 by POP3 during the phase shown in FIG. 22d, i.e. the sequence shown is interchanged.

Messages which are to be transmitted to the server part 110 in the way illustrated in FIGS. 21 and 22 or downloaded from it must firstly be written into the data memory of the card module 140 before the uploading, and read out of the data memory of the card module 140 after the downloading.

FIG. 23 shows two variants for reading out e-mail messages which have been downloaded from the server 110. For this purpose, the client part 120 which is provided with the card module 140 can be embodied in such a way that it can be introduced in its entirety into a display device 125a which is correspondingly configured, both the client part 120 and the display device 125a being able to exchange data via a suitable data communications device (not illustrated). Another variant provides for the user (not illustrated) to remove the card module 140 from the client part 120 and insert it into a display device 125b.

Both the display device 125a and the display device 125b have suitable software for reading out and indicating the e-mail messages stored in the card module 140. The display device 125b can be, in particular, a notebook (not illustrated) which is provided with a card module accommodating device, or a digital book (not illustrated) which is provided with a display program for e-mail messages.

FIG. 24 shows a schematic view of devices for encryption and decryption of files representing copyright-protected (multimedia) units, using the card module 140. Files (not illustrated) representing multimedia units are stored on the server parts 110a and 110b.

A card module 140 can be provided with a manipulation-proof physical random number generator (not illustrated) for generating random numbers which are used for the basis for calculating a pair of keys with a public key and a private key, in the card module. The calculated keys are stored in the memory device (not illustrated) of the card module 140. However, it is also possible to store externally generated keys in the card module 140. If the available memory space permits, a plurality of pairs of keys can be stored in the memory of the card module 140.

Alternatively, it is also possible to provide for the pairs of keys to be generated in a secure environment outside the card module 140 before being issued to the end user, and then to be loaded into the memory of the card module.

When a file is called from one of the server parts 110a and 110b, a public key 710, 711, 712 assigned to this file can firstly be read out of the card module 140 and transferred to the server part 110a, 110b. The respective file is encrypted on the respective server part 110a, 110b using the specific public key 710, 711 or 712 assigned to the file. The enciphered text can then be distributed without risk over a WAN; copied elements which may have been produced by third parties without authorization cannot be used without possession of the associated private key. Because this associated private key is stored in the memory of the card module 140, the possession of the card module 140 with the keys stored in it ultimately provides authorization for the decryption and thus use of the file (not illustrated) which has been downloaded from the server part 110a or 110b and which represents a text unit or a multimedia unit.

The decryption of the encrypted file 720 with the associated private key can be carried out directly with the processor provided in the card module 140. This has the great advantage that to do this the corresponding private key does not need to be made available outside the card module 140 so that no security risks occur in terms of the unauthorized copying of the private key. However, it is disadvantageous that when a chip card is used with a 8-bit chip card processor as card module 140, the processing capacity is low and the decryption process can last for a long time.

For this reason it may be expedient to embody the card module 140 in two parts, one chip card being used merely for storing the key pairs, to which end the encryption procedure is performed by a more powerful cryptography processor 750 provided in a cryptography processor component 740. For example it is possible to provide a standardized slide-in card for PCMCIA slots with a powerful cryptoprocessor for the encryption and decryption of mass data, it being possible to configure this PCMCIA slide-in card in such a way that the chip card which bears the cryptographic keys is configured in such a way that it can be plugged into it. With such a solution, it is, however, advantageous to take suitable technical provisions to ensure that the private key which is transmitted into the cryptography processor component 740 by the chip card cannot be monitored without authorization. This can be done, for example, by virtue of the fact that the cryptography processor component 740 contains, in a memory which is particularly protected against unauthorized reading out, a pair of keys whose public key is transmitted to the chip card immediately after it is plugged in. The chip card can then use the public key of the cryptography processor component 740 to decrypt the private key provided for the encryption of a file. The cryptography processor component 740 then decrypts the enciphered text of the private key provided for decryption of a file, and thus recovers this private key.

In order to protect the authenticity of card modules in general and of corresponding chip cards as well as the cryptography processor component 740, it is possible to provide for digital authenticity features, which cannot be changed at the manufacturer end, to be introduced into the corresponding memory devices, said authenticity features being authenticated by means of cryptographic digital signatures and corresponding key certificates which respectively express the relationship between an authorized manufacturer or issuer and a public signature key.

The archive 760 for storing encrypted files 720 representing programs, and textual or multimedia units can be embodied as a separate archive memory unit 770, and preferably comprise a non-volatile memory (buffered RAM, EEPROM, Flash Memory, Hard Disk store etc.).

In specific physical embodiments, the functionalities of the storage of cryptographic keys (cf. 140), of the cryptographic encryption and decryption (cf. 740, 750) and of the storage of encrypted files (cf. 770) can each be assigned to individual separate units or combined function units.

The reference symbol 780a designates a combined function unit which comprises the generation of keys, the secure storage of keys and the administration of keys together with the encryption and decryption of mass data.

Reference symbol 780b designates another combined function unit which comprises the encryption and decryption of mass data, together with the storage of the encrypted files 720 to 725.

The reference symbol 780c designates a further combined function unit which comprises the generation of keys, secure storage of keys and administration of keys together with the encryption and decryption of mass data as well as the storage of the encrypted files 720 to 725.

Various embodiments of cryptographic devices from FIG. 24 can be found in FIGS. 25a to 25f.

FIG. 25a shows a card module 140 which is provided with a cryptography processor 750. The data to be decrypted is stored in memory devices 755a, 755b, 755c outside the card module 140, whereas the cryptographic keys 757 are stored in the memory of the chip card 140.

FIG. 25b shows a variant in which the chip card 140 can be plugged into a hardware expansion module 759. The hardware expansion module 759 can be embodied, for example, in the form of a PCMCIA card in which the cryptography processor 750 and a memory 755 for data to be decrypted are installed; the data to be decrypted can, however, also be fed in from the outside from a memory 755a. The cryptographic keys 757 are stored on the chip card 140.

The variant shown in FIG. 25c differs from the arrangement shown in FIG. 25b in that the memory 755 for the data to be decrypted is arranged, for example, as a flash memory on the chip card 140.

The variant shown in FIG. 25d differs from the arrangement shown in FIG. 25c in that the memory 755 for the data to be decrypted can be plugged, for example as a flash memory, into a card module 140.

The variant shown in FIG. 25e differs from the arrangement shown in FIG. 25a in that the memory 755 for the data to be decrypted is provided, for example, as a flash memory on the card module 140.

The variant shown in FIG. 25f differs from the arrangement shown in FIG. 25d in that the key memory 757 is provided on the hardware expansion module 759.

The keys can also be fed in directly to the cryptography processor 750 via suitable data connection paths 758.

The cryptography processor 750 can also be used for encryption. The memories 755 then contain data to be encrypted.

FIG. 26 shows in schematic and exemplary form a sequence of the transmission and decryption of an encrypted file representing a unit.

The solution according to the invention which is outlined by way of example in FIG. 1 can be used for billing for the use of services by third parties in accordance with the amount of use.

FIG. 27 shows in schematic form a flowchart of a first method for billing for the acquisition of files representing software, texts or multimedia units, from a server part 110. Here, it is assumed, with reference to FIG. 24, that the server part 110a or 110b makes available a file 720, representing software, texts or multimedia units, in encrypted form, which file 720 is useless to the user without previous decryption. As illustrated in FIG. 27, in the first method in step 1100 the file 720 is downloaded from the server part 110. In the process, it is assumed that the file contains, on the one hand, the encrypted unit and, on the other hand, a non-encrypted identifier which uniquely identifies the unit. This identifier, for example in the form of a data element representing a rights number, is extracted from the file in step 1110. After the card module 140 has been plugged into the client part, in step 1120 a table which is stored in the memory (not illustrated) of the card module 140 and has individual identifiers, for which the respective card module 140 embodies a right of use, is read. In step 1130, it is then checked whether the table of individual identifiers which is stored in the memory (not illustrated) of the card module 140 contains the identifier determined in step 1110. If the result of the check is positive, in step 1140 the associated private key is loaded and the deciphering of the file 720 is completed in step 1150. In step 1160, the deciphered plain text of the file 720 can then be displayed or used in some other way. If the checking of rights in step 1130 fails, a fault message is issued in step 1170. In this case, the end user does not have any right to use the unit corresponding to the file 720.

FIG. 28 shows a schematic view of a flowchart of a second method for billing for the acquisition of files representing software, text or multimedia units, from a server part 110. Here, it is assumed, with reference to FIG. 24, that the server part 110a or 110b makes available, in encrypted form, a file 720 which represents software, texts or multimedia units and is useless to the user without previous decryption. As represented in FIG. 27, as in the first method in step 1100, the file 720 is downloaded from the server part 110. It is assumed here that the file contains, on the one hand, the encrypted unit and, on the other hand, a non-encrypted identifier which uniquely identifies the unit. This identifier, for example in the form of a data element representing a rights number, is extracted from the file in step 1110. After the card module 140 has been plugged into the client part, in step 1120 a table which is stored in the memory (not illustrated) of the card module 140 and has individual identifiers for which the respective card module 140 embodies a right of use is read. In step 1130 it is then checked whether the table which is stored in the memory (not illustrated) of the card module 140 and has individual identifiers contains the identifier determined in step 1110. If the rights check in step 1130 fails, a fault message is issued in step 1170. In this case, the end user does not have the right to use the unit corresponding to the file 720. In step 1210 a credit value which is specific to the global identifier or to the respective identifier is determined from the table which is stored in the memory (not illustrated) of the card module 140 and has individual identifiers for which the respective card module 140 embodies a right of use. In the case of a credit value equal to zero, a fault message is issued in step 1125. In the case of a credit value greater than zero, in step 1230 the associated private key is loaded and the deciphering of the file 720 is completed. The deciphered plain text of the file 720 can then be displayed or used in some other way. In step 1240, use during a predetermined time period is made possible. Then, in step 1250, the credit is reduced by one unit. If the user has in the meantime set the use, this is specified in step 1260, and in step 1270 the decrypted file is erased or made unavailable in some other way. Here, the file 720 is maintained in encrypted form. If the user wishes to continue the use, in step 1280 a check is carried out to determine whether a credit value greater than zero is present, and in a positive case the system continues in step 1240.

FIG. 29 shows a perspective view of a hardware expansion module 759 from FIG. 25 with a chip card 140 as a card module.

An operator control element 759a, for example a pushbutton key, may be provided on the hardware expansion module 759.

FIG. 30 shows a schematic flowchart of an exemplary subscription-service purchase ordering procedure.

FIG. 31 shows a schematic flowchart of a first variant of a subscription-service processing operation by means of the solution according to the invention.

FIG. 32 shows a schematic flowchart of a second variant of a subscription-service processing operation by means of the solution according to the invention.

FIG. 33 shows a schematic flowchart of a third variant of a subscription-service processing operation by means of the solution according to the invention.

FIG. 34 shows, in the partial FIGS. 34a to 34h, schematic diagrams of sequences relating to the billing of supplied files in the context of the solution according to the invention. Here, FIGS. 34a to 34c show a variant in which the use of units is billed in accordance with the time for which they are used. FIG. 34c shows the view of the display part 125 with a display of the card number and of the remaining credit units in an upper display line 125a, and a display of the time, the copyright number and the period of use and payments for use so far accrued for this unit. The level of the payments for use can be unit-dependent both with the time-dependent and the volume-dependent billing methods.

FIG. 35 shows, in the partial FIGS. 35a to 35c, a data processing device according to the invention with a wearable computer 1010.

The wearable computer 1010 has a wearable computer housing 1015 which is flat with rounded corners and is slightly concavely curved so that it can easily be carried on the body, for example with a belt 1017. Other shapes of the housing 1015 are also possible provided that the computer can easily be carried on the body. In particular, forms which permit the wearable computer 1010 to be sewn or plugged into items of clothing are possible.

The wearable computer 1010 which is shown by way of example has a display 1020 and operator control elements 1030a, 1030b and 1030c, embodied for example as pushbutton keys. An LED 1040 may also be provided as a status display.

At a suitable point, the wearable computer 1010 which is illustrated by way of example has a device (not illustrated) for accommodating a card module 1050.

FIG. 35b shows the mounting of the wearable computer 1010 on a belt 1017 by means of a securing loop attached in a suitable way to the housing 1015. FIG. 35b also shows protection against dirt and sprayed water by means of a protective cap 1070 which is plugged onto the housing 1015 of the wearable computer 1010 from above. Furthermore, FIG. 35b shows a two-wing hand-held part 1080 in the manner of a digital book, which can be folded open and closed in the manner of a book by means of a hinge device 1081 and is connected to the wearable computer 1010 by means of a cable 1082, and which is held by the user 1084 in his hand. The two-wing hand-held part 1080 can be provided, in one preferred embodiment, with two displays 1086a, 1086b which each form essentially the insides of the two wings. By virtue of the fact that essential parts of the electronics have been relocated in the wearable computer 1010 worn on the body, the hand-held part 1080 can be embodied in a particularly simple, thin and lightweight fashion.

FIG. 35c shows a user 1084 who wears the wearable computer 1010 on a shoulder belt 1017 and at the same time holds the hand-held part 1080 in his hand in a way which is suitable for operating and reading it, the right hand activating operator control elements arranged at the rear.

FIG. 36 shows, in the partial FIGS. 36a to 36c, variants of the data processing device, illustrated in FIG. 35, as a single-piece embodiment, it being possible to embody the hand-held parts from FIGS. 36a and 36b either with or without their own power supply (for example accumulator or dry battery).

FIG. 36a to 36c show a wearable computer 1010 which interacts with a single-wing hand-held part 1080a, different and combinable operator control possibilities being indicated.

FIG. 36a shows, in symbol form, operator control elements 1090 which are arranged at the rear of the hand-held part 1080a and can be embodied, for example, in the form of three pushbutton keys 1090a, 1090b and 1090c. Here, the pushbutton keys 1090a, 1090b, 1090c are arranged within the reach of a hand 1084a of a user 1084. In a particularly preferred embodiment, the pushbutton keys can be operated individually, for example in order to trigger a function “scroll up” by means of key 1090a, in order to trigger a function “scroll down” by means of key 1090c and in order to trigger a menu-forming function by means of key 1090b. In the particularly preferred embodiment, the pushbutton keys 1090a, 1090b and 1090c can also be operated together or in combination with other input means such as a touch-sensitive screen (not illustrated) or a voice input device with microphone in order, for example, to trigger further functions by simultaneously operating two or three keys. The embodiment which is shown by way of example also shows a cable connection which supplies the hand-held part with power and which permits bi-directional data communication. It is optional whether the hand-held part has its own accumulator or dry battery or the like. In such a case, it is possible, if appropriate, for the power source to be charged indirectly via the wearable computer.

FIG. 36b shows a variant which permits, in addition to the cable 1082, a wire-free data connection between the wearable computer 1010 and the hand-held part 1080a. This wire-free data connection can be made, in particular, by means of a high-frequency radio link, for example in accordance with the “bluetooth” standard or by means of an infrared link, for example in accordance with the IRDA standard. For this purpose, the wearable computer 1010 has a transmitter/receiver device 1095a at a suitable point. The hand-held part 1080a also has, at a suitable point, a transmitter/receiver device 1095b which is selected so as to be compatible with the transmitter/receiver device 1095a of the wearable computer 1010. It is also possible for the data communication of the hand-held part and/or of the wearable computer with remote and/or external devices or for facilities such as the Internet, other personal computers, printers etc., to be implemented by means of a cableless LAN (Local Area Network) or WAN (Wide Area Network) while the communication between the hand-held part and wearable computer is implemented by means of cables 1082.

FIG. 36b shows the operation of the hand-held part 1080a by means of a pen 1094 which is guided by a hand 1084a of a user 1084 on a pressure-sensitive surface 1087.

FIG. 36c shows a refinement of the data precessing device illustrated in FIGS. 36a and/or 36b in which the cable 1082 has been dispensed with. Whereas it is possible in the embodiments in FIGS. 35 and 36a to 36b provided with a cable to supply the hand-held part 1080 or 1080a with power from a power source (not illustrated) which is arranged in the wearable computer 1010, for example an accumulator or a dry battery, the embodiment or method of use illustrated in FIG. 36c requires a separate power supply of the hand-held part 1080a, for example by means of an accumulator arranged in the hand-held part 1080a, which is preferably provided in the grip for reasons of gravity and loading.

FIG. 36c shows the operation of the hand-held part 1080a by means of a finger 1084b of a hand 1084a of a user 1084 on a pressure-sensitive surface 1087.

FIGS. 36d and 36e show further variants of the embodiments illustrated in FIGS. 36a to 36c, but with a two-wing hand-held part 1080, the accumulator or dry battery in FIG. 36e being preferably provided in the area of the joint (hinge) for reasons of gravity and loading.

FIG. 37 shows, in the partial FIGS. 37a to 37c, a further variant of a data processing device according to the invention. Unless stated otherwise, the reference symbols given here correspond to the reference symbols used in FIGS. 35 and 36.

In particular, FIG. 37 shows an application of the data processing device in which the hand-held part 1080 is set up in the manner of a notebook, i.e. a first wing part 1086b lies on a planar surface, for example a table surface, whereas a second wing part 1086b is positioned perpendicularly. The individual exemplary embodiments can be combined in any desired fashion with respect to the operation and the corresponding embodiment in a further form (not illustrated).

In FIG. 37a, the inwardly pointing surface of the first wing part 1086b is pressure-sensitive and the user 1084 guides a pen 1094 over it with his hand and in this way inputs data.

In FIG. 37b, the inwardly pointing surface of the first wing part 1086b is equipped with the functionality of an input keypad, and the user 1084 makes a data entry with his hand 1084a. The embodiment of the keypad as a virtual keypad, which is operated by means of a sensitive input surface, or as a real keypad with keys which are to be activated mechanically, is optional.

In FIG. 37c, the inwardly pointing surface of the first wing part 1086b is equipped with the functionality of a touch pad, and the user 1084 makes a data entry with one finger 1084b of his hand 1084a. In the example, a cursor which is illustrated on the display surface is illustrated which indicates the relative position of the finger movement on the second wing part (page of the book) which is embodied as a touch pad.

FIG. 38 shows a view of a first variant of a data processing system according to the invention with a wearable computer 1010 and a hand-held part 1080 which are connected to one another by means of a cable 1082 (FIG. 38a) or in a wire-free fashion (FIG. 38b). The first variant constitutes a particularly cost-effective solution in which the hand-held part 1080 can be used only by interacting with the wearable computer 1010. In the variant shown in FIG. 38a, the cable 1082 not only permits data to be exchanged between the hand-held part 1080 and the wearable computer 1010, but also the hand-held part 1080 can be supplied with power via the cable 1082 from a power source, for example an accumulator, arranged in the wearable computer 1010. As a result, the hand-held part 1080 can be constructed to be particularly low in weight. On the other hand, in the case of the wearable computer 1010 which is carried on the body, the weight of the power source which is required does not necessarily lead to a loss in operating comfort. If the cable 1082 is avoided, it is necessary, as shown in FIG. 38b, to provide a wire-free data connection between the hand-held part 1080 and the wearable computer 1010. It is also necessary to provide a power source (not illustrated) in the hand-held part 1080.

FIG. 39 shows a highly schematic block diagram of the first variant of a data processing system according to the invention illustrated in FIG. 38. In particular the central bus system (EASI), the central processing unit (CPU) and the memory (ROM/RAM) are arranged in the wearable computer 1010. The hand-held part 1080 has, in particular, at least one display in a two-wing design, preferably also two or more displays and input means, for example pushbutton keys or pressure-sensitive or touch-sensitive surfaces (touch screen, slide pad etc.). In the case of the variant illustrated in FIG. 38b, a power source 2010 is optionally provided in the hand-held part 1080. The electronic devices of the hand-held part 1080 and of the wearable computer 1010 are each provided with a coupling interface 2020a and 2020b, respectively, which are suitably constructed and connected to the other circuit components in such a way that the wearable computer 1010 can be operated by means of the devices provided in the hand-held part 1080. This includes, in particular, also the ability to display data under the control of the central processing unit (CPU) of the wearable computer 1010 on one or more displays of the hand-held part 1080. Specific embodiments of the hand-held part 1080 and of the wearable computer 1010 may contain further assemblies, in particular
a) at least one interface device 2030 for card modules, for example in accordance with the PCMCIA standard;
b) at least one interface device 2040 for magnetic cards;
c) at least one interface device for flash ROM modules;
d) at least one interface device for wire-free data communication, for example in accordance with the BLUETOOTH standard (radio) or in accordance with the IRdA standard (infrared data transmission);
e) at least one interface device for a microphone and loudspeaker (sound card)
f) at least one interface card for removable storage media such as CD-ROMs, diskettes etc., or
g) at least one hard disk drive.

The labels given in the assemblies illustrated in schematic form in FIG. 39 give indications of their type and/or purpose. One hand-held part or, in specific embodiments even a plurality of identical or different hand-held parts, can be coupled to the wearable computer.

FIG. 40 shows a view of a second variant of a data processing system according to the invention with a wearable computer 1010 and a hand-held part 1080, it being possible for the hand-held part 1080 to be used independently (FIG. 40a) or for it to be connected in a wire-free fashion and/or with a cable 1082 to a wearable computer 1010 (FIG. 40b). In contrast to the first variant illustrated in FIG. 38, in the variant illustrated in FIG. 40 the hand-held part 1080 and the wearable computer 1010 can in principle be used independently of one another because they are both implemented as fully-equipped computers. FIG. 40a shows in a schematic view a use of the hand-held part 1080 as an autonomous digital book. FIG. 40b shows a coupled system comprising a hand-held part 1080 and a wearable computer 1010. By virtue of the additional data processing capacity of the wearable computer 1010 it is then possible to convert the hand-held part 1080 into a powerful notebook computer without it being necessary to provide the required computer capacity in the hand-held part 1080 from the outset. It is therefore possible to provide a hand-held part 1080 which can be used autonomously, but is nevertheless cost-effective, such as an “eBook” for reading book information, periodical information, newspaper information and document information and/or an Internet tablet for “surfing” on the Internet and/or a PDA (Personal Digital Assistant) for reading and writing notes, for keeping an appointment diary etc., which can be supplemented, where necessary, by coupling it to the wearable computer 1010 to form a powerful overall system. For example, the hand-held part contains just one browser or another operating system from that in the wearable computer. The operating system can be switched over automatically or in response to an input by means of or after coupling and/or it supplements or expands the active operating system located on the hand-held part.

FIG. 41 shows a highly schematic block diagram of the second variant, illustrated in FIG. 39, of a data processing system according to the invention. In principle, reference is made to the statements above relating to FIG. 39. However, in FIG. 41, it is shown, in contrast, that both the hand-held part 1080 and the wearable computer 1010 can each have a separate central processing unit (CPU) in addition to a memory (RAM/ROM) and system bus (EASI).

The labels given in the assemblies illustrated in schematic form in FIG. 41 give indications of their type and/or purpose.

FIG. 42 shows a view of a third variant of the data processing system according to the invention with a wearable expansion device 1010a and a hand-held part 1080, the hand-held part 1080 also being capable of being used independently. In contrast to the system illustrated in FIG. 40, the wearable expansion device 1010a is not an independent computer with respect to the wearable computer 1010 there but merely contains additional peripherals and/or power sources 2050. The peripherals provided in the wearable expansion device may include in particular the following:
a) disk drives/adapters 2060 for removable media such as CD-ROMs, diskettes, card modules;
b) devices for wire-free data transmission, in particular GSM and/or Bluetooth subsystems.

The peripheral components which can be used in the wearable expansion device may each be permanently installed therein or else upgraded or retrofitted in a modular fashion in the manner of components.

FIG. 43 shows a highly schematic block diagram of the third variant illustrated in FIG. 42 of a data processing system according to the invention. In principle, reference is made to the above statements relating to FIGS. 39 and 41. However, in FIG. 43 it is, in contrast, shown that only the hand-held part 1080, but not the wearable expansion device 1010a, has its own central processing unit (CPU) together with memory (RAM/ROM) and system bus (EASI).

The labels given in the assemblies illustrated in schematic form in FIG. 43 give indications of their type and/or purpose.

FIG. 44 shows in schematic form a data processing device 3000 according to the invention for selecting and ordering goods or services which cannot be provided directly over data lines, for example the delivery of physical goods or the provision of services such as for example a taxi journey or the ordering and/or reservation of, for example, cinema or theatre tickets or table reservations in a restaurant or the ordering of purchases from retailers and/or large-scale sales outlets such as wholesale chains or department stores. The data processing device 3000 comprises, in particular, a hand-held part 3020 which is operated by an operator 3030, and a card module 3010 which has at least one non-volatile data storage device (not illustrated) and can typically be issued by the supplier or provider of a service. However, it is also possible for the card module to be issued by third parties.

The hand-held part may be configured, for example, as a digital book or palmtop or PDA or notebook or mobile phone, and includes a computer together with a display 3040 and suitable input means, for example a touch screen. The hand-held part serves as a universal information, purchasing ordering and reservation means and is advantageously equipped with a suitable remote data communication means with or without cable. A low-cost possibility is data communication via the fixed network. In this case, it is preferably possible to provide a device which simultaneously permits both telephone calls and/or data communication. If appropriate, a suitable transmission protocol is provided which permits such simultaneous transmission.

FIG. 44a shows in schematic form the hand-held part 3020 after the plugging in or coupling of the card module 3010 into or onto a coupling device (not illustrated) provided for that purpose.

The data processing device together with the software running on it can be designed, for example, in such a way that a connection to a server computer (not illustrated) of the provider is set up via a suitable telecommunications device (not illustrated) as a result of the plugging-in or coupling procedure. Then, a catalogue of orderable goods and/or services can be downloaded automatically from the server computer (not illustrated) into the memory of the card module (not illustrated) and/or into a computer (not illustrated) of the hand-held part 3020 and can be expediently displayed on the display 3040. Directly after the end of the download procedure, the connection to the server computer can be automatically interrupted in order to save telecommunications costs. In practice, the data processing system can be embodied, for example in such a way that it dials directly into the server computer, for example via a telephone line by means of a modem (not illustrated) or ISDN adapter (not illustrated) or even in a wire-free fashion via a GSM mobile phone module (not illustrated) and uses a suitable protocol to perform data communication with the server computer. However, it is also possible to set up the telecommunications link initially to an Internet access provider, and then start data communication with the server computer by giving an Internet address, for example in the form of a URL (Uniform Resource Locator), if said server computer is connected to the Internet. In all cases the essential feature is that information stored in the non-volatile memory (not illustrated) of the card module 3010, for example in the form of at least one telephone number and/or Internet address, permits completely automatic set-up of the data communication with the server computer and the downloading of the catalogue as soon as the card module 3010 is plugged into the hand-held part 3020 or coupled to it. The user 3050 is thus relieved of the need to remember telephone numbers, Internet addresses and telecommunications operating and navigating sequences.

In an alternative variant it is also possible to store in advance at the production end the entire catalogue of the orderable goods and services in the non-volatile memory of the card module and thus avoid the step of downloading the catalogue. It is optionally also possible to provide for a telecommunications link for downloading and/or reading the catalogue to be set up as above, if it is detected that there is no catalogue data, or at any rate no current catalogue data, present.

FIG. 44b shows an operator control procedure in which the user 3050 changes into a mode in which he can view the catalogue on the display 3040 by touching the display 3040 which is embodied as a touch screen.

FIG. 44c shows a following operator control step in which the user selects, or has selected, individual orderable goods and/or services from the catalogue and makes an order. Here, the data processing device 3000 again fully automatically sets up a telecommunications link to the server computer (not illustrated)—as already in the case of the catalogue download—and transfers the purchasing order data. In a preferred embodiment, the server computer sends back an order confirmation to the data processing device 3000.

FIG. 45 shows in schematic form a flowchart of a selection and purchasing order procedure with the data processing device illustrated in FIG. 44. Here, the successive steps are given in their order determined by the sequence through texts which are surrounded by rectangles. The individual steps require input values which are specified by the texts in the lozenges.

FIG. 46 shows in schematic form a sequence in accordance with the flowchart from FIG. 45, in which:
1 means the plugging-in or coupling of the card module 3010 with the hand-held part 3020;
1.1 means the (optional) localization of potential providers in a region around the geographical location of the person making the order;
2 means the display of the catalogue if the catalogue is present on the card or in a memory of the hand-held part and can be called; otherwise, if appropriate, alternatively it means causing the catalogue data to be downloaded (Internet, online connection);
3 means the selection of orderable articles or services and, if appropriate, their quantity or specific quality by the user 3050;
4 means the starting of the purchasing ordering procedure;
5 means the inputting or selection of the call-back number (for example in the fixed network) of the person 3050 making the order (if one has not already been given for a localization operation), setting up of a telecommunications link to the server computer 3060 of the provider and transfer of the purchasing order data and the telephone number of the person making the order, said link being predetermined by means of data stored in advance in the card module 3010;
6 means transmission of the purchasing order data from the hand-held part 3020 to the server computer;
7 means reception of the purchasing order data by the server computer 3060;
7.1 means triggering of the connection abort;
7.2 means activating all the goods disposition and control systems and/or information of the respective commercial deployment centre of the provider;
7.3 means displaying an indication that a call-back is made by the server computer 3060; at the time the hand-held part is in a state in which it can receive calls (i.e. when a telephone line is used there is a corresponding line for connection to the telephone network);
8 means checking operations:
   is the card module 3010 valid? (approximate period of validity expired or disabled due to misuse)
   is the catalogue data on which the purchasing order is based still valid?
   can the identity of the ordering party 3050 be determined and/or authenticated sufficiently on the basis of the call-back telephone number given by said party? Can the delivery address be determined and/or verified from the call-back number? For this purpose, it is possible to refer to digital telephone subscriber directories if they permit back referencing for telephone numbers. This back referencing can be carried out, for example, offline using a telephone subscriber directory stored on a CD-ROM. Another solution is to obtain an assignment of an owner of a line to the given call-back telephone number via an online connection (not illustrated) to a telephone directory service.
9 means company-internal goods and/or dispositional checking to determine whether the purchase order can be carried out at all or has to be rejected due to lack of supplies or capacity;
10 means initiation of the call-back by the server computer 3060;
11 means transmission of the final order confirmation by the server 3060 to the hand-held part 3020;
12 means receipt of the call-back data by the hand-held part 3020 or by telephone, if appropriate, for verbal clarification, on the telephone, of irregularities (if appropriate the telephone device can optionally be provided in the hand-held part);
13 means display of the call-back data by the hand-held part 3020; ultimate declaration of acceptance by the user;
14 means transmission of the verified order data with the data referring to the declaration of acceptance to the server computer 3060;
15 means termination of the order acceptance procedure; provider carries out the purchase order; call-back terminated;
16 means, when there is successful acceptance of the call-back by the hand-held part, final confirmation of the order; possibly with specification of an anticipated time for the delivery and/or for the provision of the ordered service.

The solution according to the invention has in particular the following advantages:
a) The user 3020 does not need to be concerned with the details of the telecommunications processes;

the data stored in the card module 3010 permit a fully automatic sequence.
b) The user 3020 merely needs to bear part of the communication costs for transmitting the purchasing order; the costs for the call-back are borne by the provider.
c) The provider is capable of verifying the information on the identity of the ordering party and the location of said party and can in this way correct or reject purchasing orders which are specified incorrectly either intentionally or through negligence.
d) Scrolling in the catalogue is carried out offline and is thus not associated with time-dependent telecommunications costs.
e) The identification and/or authentication of the ordering party by means of telephone subscriber record data dispenses with the need in many cases to conclude framework contracts before the electronic purchasing order services are initially made use of. The card module can be personalized when it is first used and disabled in the case of misuse. The personalizing operation can be made possible when there is an initial order via a data communications link (telephone) or via a catalogue call on the Internet.
f) The numerous provider-end checking procedures after the receipt of the purchase order data likewise take place offline with respect to the hand-held part of the ordering party. As a result, on the one hand, telecommunications costs are avoided and, on the other hand, further purchasing orders can be received at the same time.
g) Integration in accounting and goods business systems is possible without problems by transferring the purchasing order data which is input by the customer. Bonus points, discounts or special offers can be allocated on a card-module-specific basis, for example on a turnover-specific basis in the case of frequent use and, if appropriate, also stored on the card module.
h) No computer knowledge is necessary at the ordering-party end. The ordering party does not require a PC for the purchasing order procedure.

The information in the card module, such as catalogue data, can alternatively also be updated by means of the subscription service system described above.
i) The solution according to the invention is particularly flexible because
   it is transportable,
   it can be used anywhere, and
   the use of card modules from different providers with the same hand-held unit and/or with the same card module (cf. corresponding statements on the subscription service system) is possible.

FIG. 47 shows, in the partial FIGS. 47a to 47e the rear view or external view of the housing of different variants of digital hand-held parts 4010a to 4010d according to the invention.

The digital hand-held parts 4010a to 4010d illustrated comprise at least one planar display unit (not illustrated) for displaying digital information and are intended to be held by the user with one hand or with both hands. In specific embodiments, digital hand-held parts also have input means, for example input pushbutton keys 4020. When necessary, digital hand-held parts can also be implemented as completely equipped computers including power source, central processing unit, memory and further peripherals. An Internet tablet, a mobile phone, a PDA or a notebook computer as well as any other known or feasible mobile display units may also be regarded as a digital hand-held part according to the invention for displaying digital information, provided that said units are intended for hand-held operation in some form or other, for example when used as a reading device for an “e-book”. Numerous desirable applications of digital communication in general and of digital hand-held parts of the type described above in particular are possible only if a digital hand-held part can be held and operated by the user, even over a long time, without the user experiencing fatigue. In this context, in particular a low weight and comfortable haptics as well as ergonomic holding are of considerable significance. It therefore proves expedient to design the housings of digital hand-held parts—in particular display parts—in a particular way, especially in the grip region.

FIG. 47a shows a rear view of a two-wing digital hand-held part 4010a with its first wing 4030a and a second wing 4030b which can be folded open and closed with respect to the user in the manner of a book by means of a hinge part 4030c. The left-hand and right-hand grip regions which are shown by hatching are implemented on the rear of the housing by means of a first rear surface region 4040a, 4040b of the housing which is embodied in a lip shape, whereas the remaining rear surface of the housing is illustrated without hatching and forms a second rear surface region 4050a, 4050b of the housing. Operator control keys 4020 are arranged on the first rear region of the housing. It proves expedient to configure the first rear surface region 4040a, 4040b of the housing differently in terms of material used than the second rear surface region 4050a, 4050b of the housing. Below, rear surface regions of the housing are designated, in accordance with the first rear surface region 4040a, 4040b of the housing as “grip region”, whereas rear surface regions of the housing corresponding to the second rear surface region 4050a, 4050b of the housing are designated as “cover region”. Embodiments which deviate from the lip shape are also possible; the lip shape shown is, however, considered a preferred embodiment.

FIG. 47b shows a first variant of the rear of the housing illustrated in FIG. 47a in which a single-wing digital hand-held part 4010b is provided with a wing 4030. This wing 4030 can be protected against dirt and damage by a flexible book cover 4060 which can be folded closed. The wing 4030 also has a grip region 4040 and a cover region 4050. In contrast to FIG. 47a, FIG. 47b does not show any operator control keys at the rear.

FIG. 47c shows a second variant of the rear of the housing illustrated in FIG. 47a, in which variant a two-wing digital hand-held part 4010c is provided with two wings 4030a, 4030b, but without input keys 4020.

FIG. 47d shows a third variant of the rear of the housing illustrated in FIG. 47a, in which variant a single-wing digital hand-held part 4010b is provided with a wing 4030. This wing 4030 can be protected against dirt and damage by a book cover-like covering mask 4060 which can be folded closed. In FIG. 47d, the cover mask 4060 is folded over to the rear in a flexible fashion. The wing 4030 also has a grip region 4040 and a cover region 4050.

FIG. 47e shows the digital hand-held part from FIG. 47c in the folded-closed state.

An essential aspect in the selection of the material for the grip region and the cover region is the durability and resistance to wear. For example, it may be desired, from the point of view of design, to cover the surface of the cover part with natural leather. However, constructing the surface in the grip region with natural leather would have the disadvantage that the surface would relatively rapidly take on a tatty and used appearance. The differentiation between the grip region and cover region permits different materials to be selected so that, for example, the grip region can be embodied as a metal part which is resistant to ageing and wear if the cover part is embodied in natural leather. A grip region which is in this way of particularly durable construction protects the cover region against premature wearing.

A further important aspect is the compressibility of the material used. If, for the sake of haptics, the cover region is made compressible by, for example, processing polyurethane foam, compressibility which is inexpedient owing to the presence of pushbutton keys in the grip region, for example, can be avoided by using a material which is less compressible or virtually non-compressible. Irrespective of the presence of pushbutton keys, it proves advantageous if the group region is less resilient and does not become pressed in the course of time.

In addition, the different mechanical flexibility of a material may be a relevant factor. If, for example, the digital hand-held part uses a flexible display, for example on a polymer basis, it may be desirable to make its housing flexible as a whole. In order to control and limit the flexibility of the overall housing, in order, for example, to define a predetermined bending line, it may be advantageous to implement the grip region and the cover region with materials with different flexibility (rigidity). One possibility would be, for example, to manufacture the cover region from a material with low rigidity which can be bent relatively easily, while the grip region is constructed from a less flexible material with a high degree of rigidity.

A further important criterion in the embodiment of the housing of the digital hand-held part according to the invention comprises determining whether the grip region and/or the cover region are embodied as parts which can be replaced separately. For example, a replaceable cover region may be advantageous if, for instance for reasons of fashion, the user is to be permitted to change the surface design. The wear of the cover region which is produced from more sensitive materials, said wear occurring despite the above-mentioned protection by the grip region, may justify a replaceable solution.

FIG. 48 shows a schematic plan view of the lower edge or upper edge of a further development of a housing from FIG. 47c which provides for a replaceable compressible cover region 4050a, 4050b. Here, the grip region 4040a, 4040b is essentially embodied in one piece with the front part of the housing, whereas the cover region 4050a, 4050b is embodied in the form of separate, removable cover shells. These cover shells 4050a, 4050b are secured under the grip region 4040a, 4040b by clamping and can easily be removed and replaced by the user by means of a sideways movement (1) and subsequent upward movement (2). The cover shells 4050a, 4050b are preferably provided on their upper side and lower side with a projecting spring which engages in a corresponding groove in the housing and forms a protection against the penetration of dust and against moisture. The electronics 4060 are protected, for example, by a sealing compound or by some other protective coating (not illustrated) to such an extent that they are not damaged even if the cover shell is replaced incorrectly.

FIG. 49 shows a schematic view of the rear part 4010 of the housing with a removable grip region 4040. The grip region 4040 is formed by an essentially U-shaped part which can be fitted onto the edge region (in the direction of the arrow) and also pulled down again.

FIG. 50 shows a schematic view of replaceable components of a modular rear part of a housing. In the upper part of the figure, cover shells 4080a to 4080d are shown which can be replaced separately. In the lower part of the figure, alternatively combination parts 4085a to 4085d, which can be replaced and which embody both the grip region and the cover region, are illustrated.

FIG. 51 shows, in the partial FIGS. 51a to 51c, rear views of further variants of housings of digital hand-held parts according to the invention, specifically housings which have just one wing. FIG. 51a shows a housing rear part with two grip regions 4040a, 4040b and a cover region 4050, as well as with operator control elements 4020. FIG. 51b shows another rear part of a housing with two grip regions 4040a, 4040b and a cover region 4050, but without operator control elements. FIG. 51c shows a further rear part of a housing with a grip region 4040 and a cover region 4050 without operator control elements.

FIG. 52 shows schematically the procedure of changing specific rear parts with modular housing backs. FIG. 52a shows the pushing in of a cover shell 4050 in a downward direction into the base housing to which the grip regions 4040a, 4040b are permanently connected. In a further development, the cover shell 4050 can have flat recesses 4050g which permit the grip regions 4040a, 4040b to latch in. This procedure is suitable in particular for hand-held parts of the type illustrated in FIG. 51b. FIG. 52b shows alternatively the pushing in of a cover shell 4050 in the sideways direction into the base housing to which an individual grip region 4040 is permanently connected. In one development, the cover shell 4050 can have a flat recess 4050g which permits the grip region 4040 to latch in. This procedure is suitable in particular for hand-held parts of the type illustrated in FIG. 51c. FIG. 52c shows alternatively a cover shell 4050 which is permanently connected to the base unit and onto which two grip region parts 4040a, 4040b forming a grip region can be suitably fitted, for example by bonding, latching connections, screw connections etc. This procedure is suitable in particular for hand-held parts of the type illustrated in FIGS. 51a, 51b.

FIG. 53 shows, in the partial FIGS. 53a and 53b, schematic views of different function zones given a modular housing of a single-wing or two-wing digital hand-held part according to the invention.

FIG. 54 shows, in the partial FIGS. 54a to 54c, different aspects of a developed modular housing of a digital hand-held part according to the invention.

FIG. 54a shows a plan view of the rear parts of the housing of a completely assembled, two-wing digital hand-held part according to the invention with a first wing part 4030a and a second wing part 4030b. On the side facing the user, each of the wings can have a planar display (not illustrated); in a preferred embodiment, both wings each have a display (not illustrated). The wing parts 4030a, 4030b can be folded open and closed with respect to the user in the manner of a book by means of a hinge device 4030c. A rear part of the housing which is associated with the base housing is designated by the reference numbers 4090a, 4090b. In each case a removable rear part 4095a, 4095b of the book can be plugged in and attached under the rear part 4090a, 4090b of the housing. FIG. 54b shows a state in which both rear parts 4095a, 4095b of the book are pulled out laterally. Each rear part 4095a, 4095b of the book has, in the example illustrated, a grip part 4097a and 4097b, respectively, which can comprise operator control elements 4020. FIG. 54c shows a state in which the grip part 4097a is pulled out laterally from the rear part 4095a of the book. Of course, the electrical connection of operator control elements 4020 is embodied so as to be disconnectable by means of suitable plug-type connector devices 4099.

It is apparent that the degree of modularity of the housing design according to FIGS. 54a to 54c can be varied. If necessary, the separate removability of a rear part of a book can also be dispensed with, as can the separate removability of a grip part. The out [lacuna]

Of course, all the equipment and data processing devices described above can be applied in all their embodiments and application possibilities for all the methods described above.

109. Client part, comprising:
a telecommunications coupler adapted to exchange data with an external data processing system that transmits a plurality of copyright-protected content units in an encrypted way in a broadcast mode to a plurality of said client parts without specified receiver addresses,
a control device,
a display device,
a function module coupling device adapted to communicatively couple with at least one function module having a non-volatile memory in which a data element that represents a positive credit value is stored,
a non-volatile first data memory area, and
a non-volatile second data memory area,
wherein the client part is adapted to receive the plurality of copyright-protected content units from the external data processing system without having to provide a specified address,
wherein the first data memory area includes at least one loading-enabling data element, to which at least one specific file or category of files that can be transmitted by the external data processing system is assigned in accordance with a contractual relationship,
wherein the control device is adapted to control receipt of content data from the external data processing system as a function of control data stored in the first data memory area,
wherein the control device is adapted to permit storage only of content data belonging to a file or to a category of files that is assigned to the loading enabling element in accordance with the contractual relationship so that the content data is stored, or else ignored, as a function of the loading enabling element,
wherein the control device is adapted to store content data transmitted by the external data processing system and for which storage is permitted in the second data memory area as at least one encrypted file,
wherein said content data of the at least one encrypted file has a format readable by a display component to be displayed or played back in a decrypted manner, and
wherein the control device is adapted to display data of the at least one file stored in the second memory area by means of the display device and to reduce the credit value stored in the memory of the function module in accordance with the period of time during which the data is displayed or in accordance with the quantity of data displayed, until the credit value is less than or equal to zero.

110. Client part according to claim 109, wherein the client part is adapted to receive permission from a card module to decrypt the data of the at least one file.

111. Client part according to claim 109, further comprising a local data coupling device in communication with the control device.

112. Client part according to claim 111, wherein the local data coupling device contains an electrical plug-type connector device.

113. Client part according to claim 112, further comprising the display component, wherein the display component is plugged in directly by means of the electrical plug-type connector device.

114. Client part according to claim 113, wherein the display component is connected by means of the electrical plug-type connector device using a cable.

115. Client part according to claim 111, wherein the local data coupling device includes an infrared data transmission device.

116. Client part according to claim 115, wherein the infrared data transmission device includes an IRdA interface.

117. Client part according to claim 111, wherein the local data coupling device includes a radio transmitter device.

118. Client part according to claim 109, further comprising the display component, wherein the display component is a digital book.

119. Client part according to claim 109, further comprising the display component, wherein the display component is a notebook computer.

120. Client part according to claim 109, further comprising the display component, wherein the display component is a palmtop computer.

121. Client part according to claim 109, further comprising the display component, wherein the display component is a television set.

122. Client part according to claim 109, further comprising the display component, wherein the display component is a mobile phone.

123. Client part according to claim 109, further comprising the display component, wherein the display component is an action terminal.

124. Client part according to claim 109, further comprising the display component, wherein the display component has a display device for displaying texts and images.

125. Client part according to claim 109, further comprising the display component, wherein the display component has a display device for displaying video sequences.

126. Client part according to claim 109, further comprising the display component, wherein the display component has a sound transducer device for reproducing sounds.

127. Client part according to claim 109, wherein the control device is adapted to transfer at least one call data element to the external data processing device, to which at least one specific file or category of files that can be transmitted by the external data processing system is assigned in a predetermined second relation, wherein the external data processing device is adapted to transmit the at least one file or category of files that is in accordance with the second relation after the transmission of the call data element.

128. Client part according to claim 127, wherein the control device is adapted to transfer the call data element as a function of the activation of an operator control element.

129. Client part according to claim 127, wherein the control device is adapted to transfer the call data element into a function module coupling device as a function of the coupling of a function module.

130. Client part according to claim 127, wherein the call data element is stored in the first data memory area and is read out from it before transmission.

131. Client part according to claim 127, wherein before the transmission of the call data element, a first data communications channel is set up to the external data processing system via the telecommunications coupler, after the transmission of the call data element the external data processing device transmits, essentially without delay, the at least one file or category of files which is in accordance with the second relation, and in that the call data element and the at least one file or category of files which is in accordance with the second relation are transmitted via the first data communications channel.

132. Client part according to claim 127, wherein before the call data element is transmitted, a first data communications channel is set up via the telecommunications coupler to the external data processing system via which the call data element is transmitted, the first data communications channel is released after the transmission of the call data element, and after the transmission of the call data element, and before the transmission of the at least one file or category of files which is in accordance with the second relation, the external data processing device sets up a second data communications channel to the telecommunications coupler via which the at least one file or category of files which is in accordance with the second relation is transmitted.

133. Client part according to claim 127, wherein at predetermined times before the transmission of the at least one file or category of files that is in accordance with the second relation, the external data processing device is adapted to set up a data communications channel to the telecommunications coupler via which the at least one file or category of files that is in accordance with the second relation is transmitted.

134. Client part according to claim 109, wherein the telecommunications coupler is a connection to a telephone network.

135. Client part according to claim 109, wherein the telecommunications coupler is an Internet access connection.

136. Client part according to claim 109, wherein the telecommunications coupler includes a mobile radio device.

137. Client part according to claim 109, wherein the telecommunications coupler includes a GSM mobile radio device.

138. Client part according to claim 109, wherein the telecommunications coupler includes a satellite radio device.

139. Client part according to claim 138, wherein the satellite radio device is adapted to make available a download channel for downloading at least one file.

140. Client part according to claim 138, wherein the satellite radio device has a backward channel for transmitting data to the satellite.

141. Client part according to claim 109, wherein the client part is adapted to transmit an acknowledgement data element to the external data processing device after the complete transmission of at least one file.

142. Client part according to claim 140, wherein the acknowledgement data element includes a digital signature.

143. Client part according to claim 109, further comprising a cryptographic key that is suitable for decryption, stored in the first data memory area.

144. Client part according to claim 109, further comprising a pager module that is adapted to indicate a completed transmission process of a file.

145. Client part according to claim 109, further comprising a function module coupling device for at least one mobile function module, wherein the function module coupling device is adapted to enable data to be exchanged between the function module and the client part, wherein the control device is adapted to control in particular the exchange of data with the external data processing system as a function of control data that is read in from a function module via the function module coupling device if a function module is coupled via the function module coupling device.

146. Client part according to claim 145, wherein the function module includes the non-volatile first data memory area.

147. Client part according to claim 146, wherein the client part includes the non-volatile second data memory area, wherein the control device is adapted to store data transmitted by the external data processing system in the second data memory area by as at least one file.

148. Client part according to claim 147, wherein the control device is adapted to control transmission of at least one file stored in the second data memory area in the client part into the first data memory area in the function module via the function module coupling device.

149. Client part according to claim 147, wherein the control device is adapted to store data transmitted by the external data processing system in the first data memory area in the function module as at least one file.

150. Client part according to claim 148, wherein the first data memory area includes at least one identification data element that identifies the individual function module.

151. Client part according to claim 150, wherein the first data memory area includes an authentication data element that authenticates the identification data element that uniquely identifies the function module.

152. Client part according to claim 151, wherein the authentication data element is a digital signature.

153. Client part according to claim 152, wherein the first data memory area of the function module includes at least one cryptographic key with which at least one encrypted file which is transmitted by the external data processing system and which represents a computer program, a text or a multimedia unit can be decrypted.

154. Client part according to claim 146, further comprising a telecommunications address data element stored in the first data memory area in the function module, wherein the external data processing device is adapted to set up a telecommunications channel to the telecommunications coupler if the telecommunications address data element is used as addressing means.

155. Client part according to claim 154, wherein the telecommunications address data element is a telephone number.

156. Client part according to claim 154, wherein the telecommunications address data element is an IP Internet protocol address.

157. Client part according to claim 147, further comprising a telecommunications address data element stored in the second data memory area in the client part, wherein the external data processing device is adapted to set up a telecommunications channel to the telecommunications coupler if the telecommunications address data element is used as addressing means.

158. Client part according to claim 157, wherein the telecommunications address data element is a telephone number.

159. Client part according to claim 157, wherein the telecommunications address data element is an IP Internet protocol address.

160. Client part according to claim 145, wherein the function module coupling device can hold more than one function module.

161. Client part according to claim 160, wherein the telecommunications address data element can be selected from the respective telecommunications address data elements stored in the function modules.

162. Client part according to claim 160, wherein the telecommunications address data element can be selected manually from the respective telecommunications address data elements stored in the function modules, by means of an operator control element.

163. Client part according to claim 145, wherein the function module is a chip card.

164. Client part according to claim 145, wherein the function module is essentially in the form of a pen.

165. Client part according to claim 164, wherein the function module is adapted to be inserted into the grip part of a digital book or into the hinge part of a two-piece digital book.

166. Client part according to claim 145, wherein the function module coupling device includes an electrical plug-type connector device.

167. Client part according to claim 166, wherein the function module is plugged in directly by means of the electrical plug-type connector device.

168. Client part according to claim 166, wherein the plug-type connector device includes a chip card contact array.

169. Client part according to claim 166, wherein the function module is connected by means of the electrical plug-type connector device using a cable.

170. Client part according to claim 145, wherein the function module coupling device includes an infrared data transmission device.

171. Client part according to claim 170, wherein the infrared data transmission device includes an IRdA interface.

172. Client part according to claim 145, wherein the function module coupling device includes a radio transmitter device.

173. Client part according to claim 145, further comprising an essentially key-shaped receptacle into which at least one function module can be loosely fitted, the function module coupling device forming a wire-free data transmission channel.

174. Client part according to claim 163, further comprising a coupling element that is embodied essentially as a diskette storage medium and into which the card module can be inserted, wherein the coupling element is disposed at a location that corresponds to a writing/reading arm access area, with an induction device that is electrically coupled to the card module, wherein the card module is adapted to exchange data with a reading/writing head via the induction device if the card module is inserted into the coupling element and the coupling element is inserted into a suitable diskette drive.

175. Client part according to claim 145, wherein the external data processing system is adapted to encrypt the transmitted data before transmission.

176. Client part according to claim 175, wherein the first data memory area in the function module includes a key that is suitable for decrypting the encrypted data.

177. Client part according to claim 176, wherein the function module includes a processor for decrypting the encrypted data.

178. Client part according to claim 177, wherein the function module includes
a first assembly that includes the first data memory area, and
a second assembly that includes the processor for decrypting the encrypted data,
wherein the first assembly is adapted to be plugged into the second assembly and is electrically connected to the second assembly in the plugged-in state.

179. Client part according to claim 178, wherein the first assembly is a chip card.

180. Client part according to claim 178, wherein the first assembly includes the second data memory area for storing the at least one file that is transmitted by the external data processing system.

181. Client part according to claim 178, wherein the second assembly includes the second data memory area for storing the at least one file that is transmitted by the external data processing system.

182. Client part according to claim 145, wherein at least one function module is provided with the control device.

183. Client part according to claim 145, wherein the data elements can be routed from the function module to the external data processing system, as well as from the external data processing system to the function module and transparently through the client part.
